(19) United States
(12) Patent Application Publication
(10) Pub. No.: US 2008/0024942 A1
(43) Pub. Date: Jan. 31, 2008

(54) Ground fault circuit interrupter device

(75) Inventors: Gunter A. Gallas, Woodbury, NY (US); Erik J. Gouhl, Fayetteville, GA (US); Howard S. Leopold, Fayetteville, GA (US); Gregory G. Moreinis, Forest Hills, NY (US)

Correspondence Address: KING & SPALDING LLP, 1180 PEACHTREE STREET, ATLANTA, GA, 30309-3521, US

(73) Assignee: Cooper Technologies Company, Houston, TX (US)

(21) Appl. No.: 11/495,091

(22) Filed: Jul. 28, 2006

(51) Int. Cl. H02H 3/08

(52) U.S. Cl. 361/42

(57) ABSTRACT

A ground fault circuit interrupter device is described.

### CROSS REFERENCE TO RELATED APPLICATIONS

The present application is related to the following co-pending applications: U.S. patent application Ser. No. ______, attorney docket no. 23667.323 (CWD-027836), filed on Jul. 28, 2006; U.S. patent application Ser. No. ______, attorney docket no. 23667.324 (CWD-027837), filed on Jul. 28, 2006; U.S. patent application Ser. No. ______, attorney docket no. 23667.325 (CWD-027838), filed on Jul. 28, 2006; and U.S. patent application Ser. No. ______, attorney docket no. 23667.326 (CWD-027839), filed on Jul. 28, 2006, the disclosures of which are incorporated herein by reference.

### BACKGROUND

The present disclosure relates in general to ground fault circuit interrupter devices such as, for example, ground fault circuit interrupter receptacles.

### BRIEF DESCRIPTION OF THE DRAWINGS

FIG. 1 is a perspective view of an exemplary embodiment of a ground fault circuit interrupter device.

FIG. 2 is another perspective view of the device of FIG. 1.

FIG. 3 is an exploded view of the device of FIG. 1.

FIG. 4A is a perspective view of a middle housing depicted in FIG. 3.

FIG. 4B is another perspective view of the middle housing of FIG. 4A.

FIG. 5 is a perspective view of a mounting strap depicted in FIG. 3.

FIG. 6 is a perspective view of a reset button and shaft depicted in FIG. 3.

FIG. 7 is a perspective view of an actuator depicted in FIG. 3.

FIG. 8 is a perspective view of a torsion spring depicted in FIG. 3.

FIG. 9 is a perspective view of a set of receptacle contacts depicted in FIG. 3.

FIG. 10 is an elevational view of one of the receptacle contacts of FIG. 9.

FIG. 11 is a perspective view of the mounting strap of FIG. 5, the middle housing of FIGS. 4A and 4B, the actuator of FIG. 7, and the receptacle contacts of FIG. 9 in an assembled condition.

FIG. 12 is a partial perspective/partial sectional view of the middle housing of FIGS. 4A and 4B and the torsion spring of FIG. 8 in an assembled condition.

FIG. 13A is a perspective view of a latch assembly depicted in FIG. 3.

FIG. 13B is another perspective view of the latch assembly of FIG. 13A.

FIG. 14 is a perspective view of a cam depicted in FIG. 3.

FIG. 15A is a perspective view a PCB assembly depicted in FIG. 3.

FIG. 15B is another perspective view of the PCB assembly of FIG. 15A.

FIG. 16 is a perspective view of a spring bracket, which is part of the PCB assembly of FIGS. 15A and 15B.

FIG. 17 is a simplified diagrammatic view of an exemplary embodiment of a ground fault circuit interrupter circuit.

FIG. 18 is a simplified diagrammatic view of another exemplary embodiment of a ground fault circuit interrupter circuit.

FIG. 19 is a perspective view of a pair of input line terminals depicted in FIGS. 15A and 15B.

FIG. 20 is a perspective view of a transformer assembly depicted in FIGS. 15A and 15B.

FIG. 21 is a perspective view of a pair of stationary contacts depicted in FIGS. 15A and 15B.

FIG. 22 is a perspective view of a frame depicted in FIGS. 15A and 15B.

FIG. 23 is a perspective view of a pair of movable contacts depicted in FIGS. 15A and 15B.

FIG. 24 is a side elevational view of a solenoid assembly depicted in FIGS. 15A and 15B.

FIG. 25 is a partially exploded/partially unexploded view of the transformer assembly of FIG. 20, the stationary contacts of FIG. 21, and the circuit board depicted in FIGS. 15A and 15B.

FIG. 26 is an unexploded perspective view of the transformer assembly of FIG. 20, the stationary contacts of FIG. 21, and the circuit board depicted in FIGS. 15A and 15B.

FIG. 27 is a partial sectional/partial elevational view of the PCB assembly of FIG. 26 taken along line 27-27.

FIG. 28 is a perspective view of the latch assembly of FIGS. 13A and 13B received by the PCB assembly of FIGS. 15A and 15B.

FIG. 29 is a perspective view of the cam of FIG. 14 and the latch assembly of FIGS. 13A and 14B received by the PCB assembly of FIGS. 15A and 15B.

FIG. 30 is a perspective view of a bottom housing depicted in FIGS. 1 and 3.

FIG. 31 is a perspective view of a test button depicted in FIGS. 1 and 3.

FIG. 32 is a perspective view of a top housing depicted in FIGS. 1 and 3.

FIG. 33 is a partial sectional/partial elevational view of the test button of FIG. 31 engaged with the top housing of FIG. 32.

FIG. 34 is a flow chart illustration of an exemplary embodiment of a method of operating the device of FIG. 1.

FIG. 35 is a flow chart illustration of an exemplary embodiment of a step of the method of FIG. 34.

FIG. 36 is a partial exploded view of the device of FIG. 1, depicting the device 10 undergoing assembly.

FIG. 37 is a simplified partial elevational/partial sectional view of the device 10 with several components removed for the purpose of clarity, depicting the device 10 in its tripped state, upon completion of the assembly of the device 10.

FIG. 38 is a partial diagrammatic/partial perspective view of the device 10, depicting the device 10 installed.

FIGS. 39A, 39B, 39C and 39D are simplified partial elevational/partial sectional views of the device 10 with several components removed for the purpose of clarity, depicting the state of the device 10 being changed from its tripped state to its reset state.

FIG. 40 is a view similar to that of FIG. 37, but depicting the device 10 in its reset state.

FIG. 41 is a perspective view of the receptacle contacts of FIG. 9 when the device 10 is in its reset state, as shown in FIG. 40.

FIG. 42 is a flow chart illustration of an exemplary embodiment of another step of the method of FIG. 34.

FIGS. 43A, 43B, 43C, 43D and 43E are simplified partial elevational/partial sectional views of the device 10 with several components removed for the purpose of clarity, depicting the state of the device 10 being changed from its reset state to its tripped state.

FIG. 44 is a flow chart illustration of an exemplary embodiment of yet another step of the method of FIG. 34.

FIG. 45 is a flow chart illustration of an exemplary embodiment of still yet another step of the method of FIG. 34.

FIGS. 46A and 46B are partial elevational/partial sectional views of a spring depicted in FIG. 3, the actuator of FIG. 7, the latch assembly of FIGS. 13A and 13B, the test button of FIG. 31 and the top housing of FIG. 32, depicting the state of the device 10 being changed from its reset stat to its tripped state.

### DETAILED DESCRIPTION

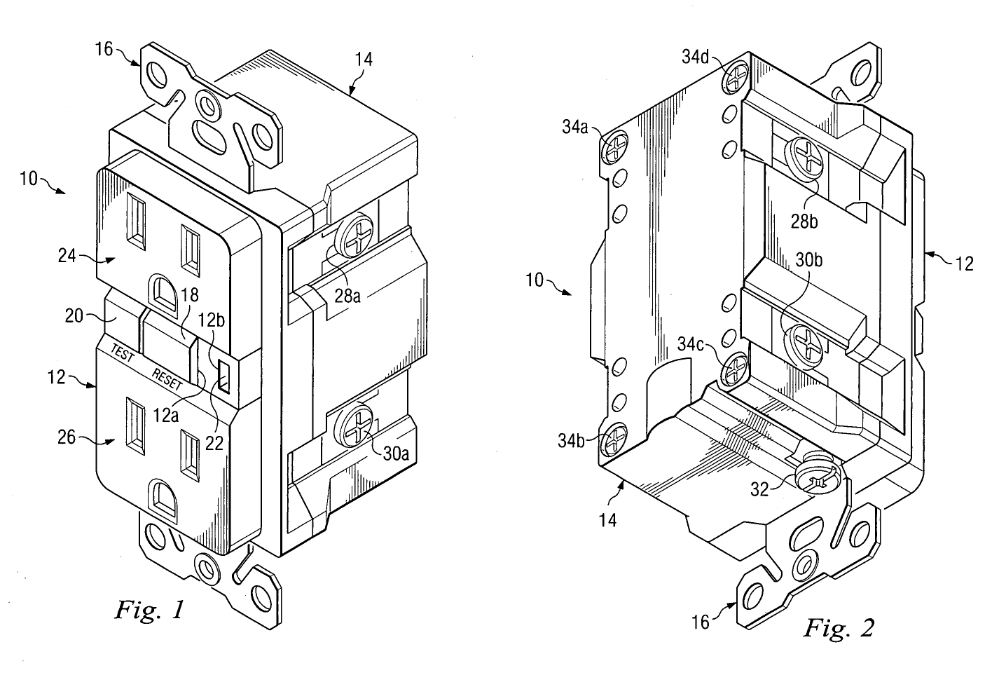

In an exemplary embodiment, as illustrated in FIGS. 1 and 2, a ground fault circuit interrupter (GFCI) device is generally referred to by the reference numeral 10 and includes a top housing 12 and a bottom housing 14 coupled thereto. A mounting strap 16 extends between the top housing 12 and the bottom housing 14. An opening 12a is formed in the top housing 12, and a reset button 18 and a test button 20 extend within the opening 12a. An opening 12b is formed in the top housing 12, and an end of a light pipe 22 is visible through the opening 12b. The top housing 12 further includes sets of receptacle outlets 24 and 26, each of which is adapted to receive a two-prong or three-prong electrical plug.

Load terminal screws 28a and 28b are disposed on opposing sides of the bottom housing 14, and line terminal screws 30a and 30b are also disposed on opposing sides of the bottom housing 14. Each of the terminal screws 28a and 30a is a hot terminal screw, and each of the terminal screws 28b and 30b is a neutral terminal screw. A ground screw 32 is coupled to the mounting strap 16. Fasteners 34a, 34b, 34c and 34d couple the bottom housing 14 to the top housing 12 and clamp the mounting strap 16 therebetween.

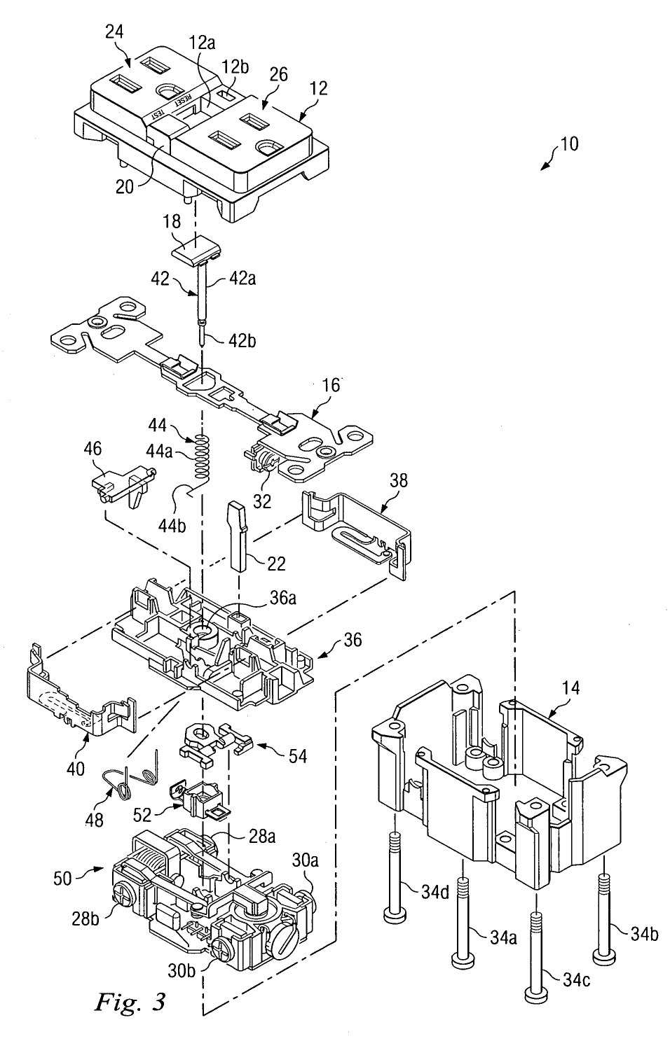

In an exemplary embodiment, as illustrated in FIG. 3, a middle housing 36 is coupled to the bottom housing 14, and receptacle contacts 38 and 40 are received in the middle housing 36. A counterbore 36a extends through the middle housing 36, and a reset shaft 42 extends through the counterbore 36a. The reset shaft 42 is coupled to the reset button 18 and further extends through a spring 44, which includes a helical portion 44a and an L-shaped leg 44b extending therefrom. The light pipe 22 is received by the middle housing 36, and includes a stepped end portion 22a and a protrusion 22b.

An actuator 46 is received by the middle housing 36, and a torsion spring 48 is coupled to the middle housing 36. A printed circuit board (PCB) assembly 50 is received by the bottom housing 14, and a latch assembly 52 is received by the PCB assembly 50. A cam 54 is also received by the PCB assembly 50.

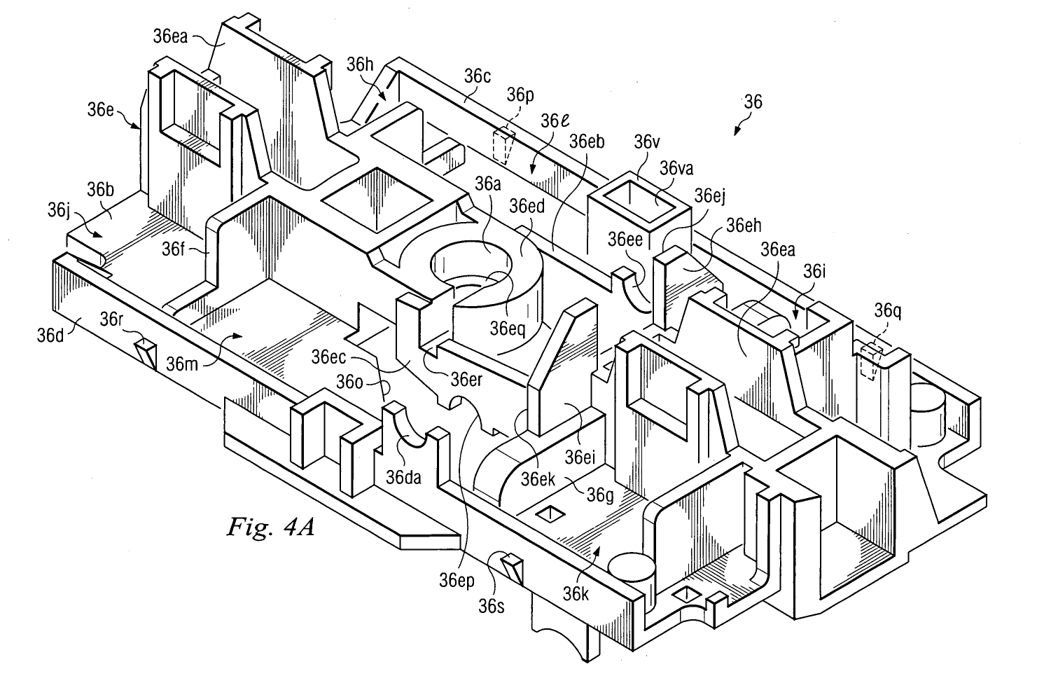

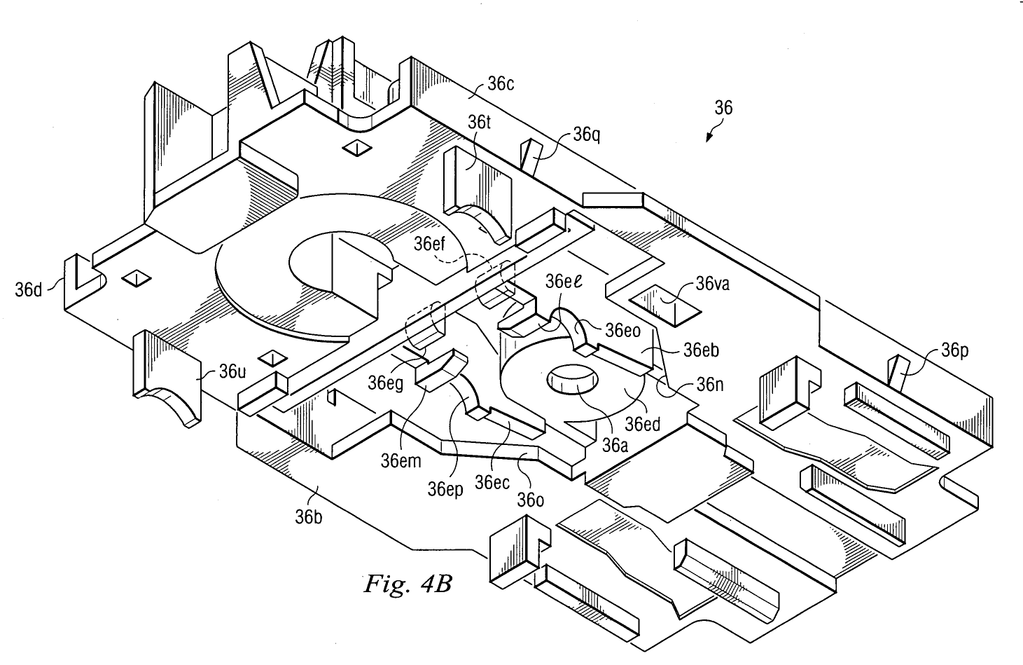

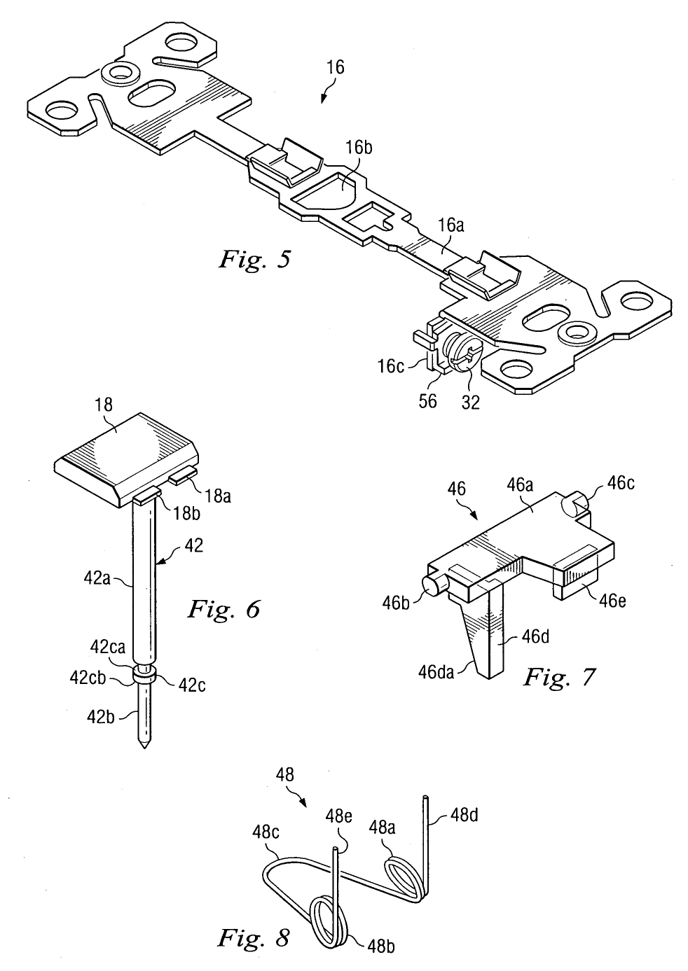

In an exemplary embodiment, as illustrated in FIGS. 4 and 5, the middle housing 36 includes a tray portion 36b from which walls 36c and 36d, and a longitudinally-extending center portion 36e, extend. Generally planar portions 36f and 36g extend from the tray portion 36b and through the center portion 36e, and are generally perpendicular to the center portion 36e.

A region 36h is defined by the tray portion 36b, the wall 36c, the center portion 36e and the planar portion 36f. A region 36i is defined by the tray portion 36b, the wall 36c, the center portion 36e and the planar portion 36g. A region 36j is defined by the tray portion 36b, the wall 36d, the center portion 36e and the planar portion 36f. A region 36k is defined by the tray portion 36b, the wall 36d, the center portion 36e and the planar portion 36g. A region 36l is defined by the wall 36c, the center portion 36e and the planar portions 36f and 36g. A region 36m is defined by the wall 36d, the center portion 36e and the planar portions 36f and 36g. Openings 36n and 360 are formed in the tray portion 36b in the regions 36l and 36m, respectively, and are substantially symmetric about the center portion 36e.

Snap-fit protrusions 36p and 36q extend from the outside surface of the wall 36c, and snap-fit protrusions 36r and 36s extend from the outside surface of the wall 36d. Protrusions 36t and 36u extend from the tray portion 36 in a direction opposing the direction of extension of the walls 36c and 36d. A protrusion 36v defining a passage 36va extends upward from the tray portion 36b and is proximate the wall 36c.

The center portion 36e is substantially symmetric about its longitudinal axis, defines a channel 36ea, and includes a pair of walls 36eb and 36ec spaced in a parallel relation. A cylindrical protrusion 36ed, through which the counterbore 36a extends, at least partially extends between the walls 36eb and 36ec. An arcuate notch 36ee is formed in the wall 36eb. Protrusions 36ef and 36eg extend from the walls 36eb and 36ec, respectively, and towards each other. Protrusions 36eh and 36ei extend from the planar portion 36g and the corresponding ends of the walls 36eb and 36ec, respectively. Surfaces 36ej and 36ek are defined by the protrusions 36eh and 36ei, respectively. Tabs 36el and 36em extend from the walls 36eb and 36ec, respectively, and towards each other. Coaxial arcuate notches 36eo and 36ep are formed in the walls 36eb and 36ec, respectively. The notches 36eo and 36ee are formed in opposing edges of the wall 36eb. An internal shoulder 36 eq is defined by the counterbore 36a, and a channel 36er is formed in the cylindrical protrusion 36ed and the wall 36ec. An arcuate notch 36da is formed in the wall 36d and is coaxial with the arcuate notch 36ee. In an exemplary embodiment, the middle housing 36 is a unitary part composed of molded plastic.

In an exemplary embodiment, as illustrated in FIG. 5, the mounting strap 16 includes a center portion 16a and an opening 16b therethrough. The ground screw 32 is captively threadably engaged with a tab 16c of the mounting strap 16, and extends through a terminal plate 56 so that the terminal plate 56 is disposed between the tab 16c and the head of the ground screw 32.

In an exemplary embodiment, as illustrated in FIG. 6, the shaft 42 includes an enlarged-diameter portion 42a extending from the reset button 18, and a reduced-diameter portion 42b extending from the enlarged-diameter portion 42a. A flange 42c defining surfaces 42ca and 42cb radially extends from the reduced-diameter portion 42b, and is axially spaced from the enlarged-diameter portion 42a. The reset button 18 includes tabs 18a and 18b, and tabs opposing tabs 18a and 18b, which are not shown.

In an exemplary embodiment, as illustrated in FIG. 7, the actuator 46 includes a generally planar portion 46a having generally coplanar tabs 46b and 46c extending therefrom. A protrusion 46d extends downward from the portion 46a and defines a slanted surface 46da. A protrusion 46e also extends downward from the portion 46a.

In an exemplary embodiment, as illustrated in FIG. 7, the torsion spring 48 includes coil portions 48a and 48b and a U-shaped portion 48c extending therebetween. Legs 48d and 48e extend from the coil portions 48a and 48b, respectively.

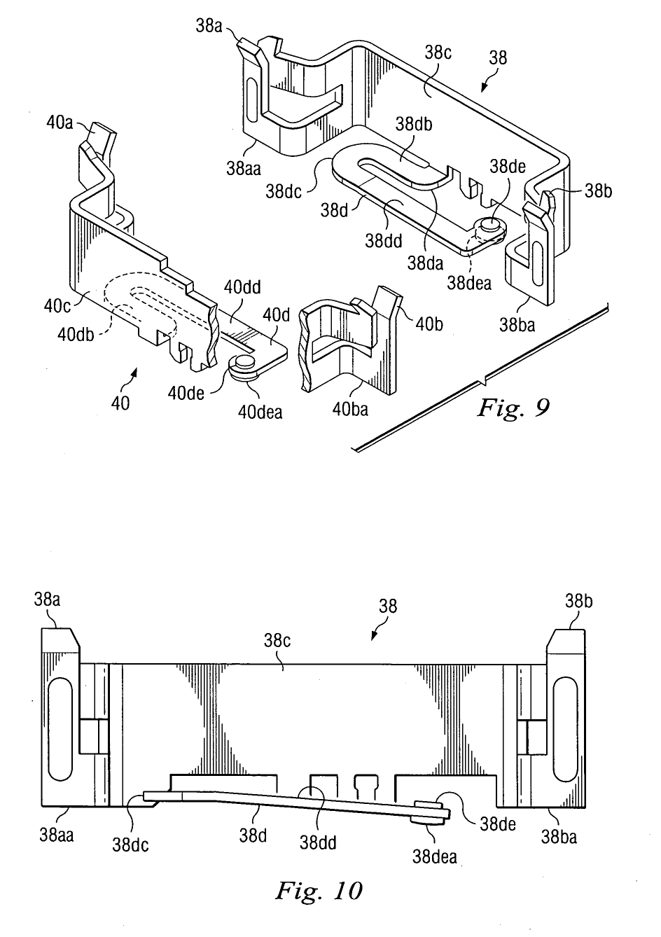

In an exemplary embodiment, as illustrated in FIGS. 9 and 10, the receptacle contact 38 includes pairs of contacts 38a and 38b and a wall 38c extending therebetween. Each of the pairs of contacts 38a and 38b is a hot receptacle contact and is adapted to receive one prong of a two-prong or three-prong electrical plug. Substantially coplanar surfaces 38aa and 38ba are defined by the pairs of contacts 38a and 38b, respectively.

A cantilever arm 38d, which is adapted to move under conditions to be described, extends from the wall 38c and includes a 90-degree-turn portion 38da. A longitudinally-extending portion 38db extends from the turn portion 38da and towards the pair of contacts 38a in a direction that is generally parallel to the direction of extension of the wall 38c. A U-shaped portion 38dc extends from the portion 38db and makes a 180-degree turn. The portions 38da, 38db and 38dc are substantially coplanar, and are either coplanar with, or slightly offset in a parallel relation from, the surfaces 38aa and 38ba, and are further substantially perpendicular to the wall 38c. A slanted, or angularly-extending, portion 38dd angularly extends from the U-shaped portion 38dc and towards the pair of contacts 38b. The longitudinally-extending portion 38b is generally parallel with the longitudinal directional component of the direction of extension of the slanted portion 38dd from the U-shaped portion 38dc. The majority of the longitudinal length of the arm 38d is generally defined by the length of the longitudinal directional component of the direction of extension of the slanted portion 38dd from the U-shaped portion 38dc. A contact 38de defining a contact surface 38dea is coupled to the distal end portion of the slanted portion 38dd so that the contact surface 38dea is offset from, and below, the surfaces 38aa and 38ba.

The receptacle contact 40 is the symmetric equivalent to the receptacle contact 38, about the center portion 36e of the middle housing 36, and therefore the receptacle contact 40 will not be described in detail. Reference numerals used to refer to features of the receptacle contact 40 will correspond to the reference numerals for the receptacle contact 38, except that the numeric prefix for the reference numerals used to describe the receptacle contact 38, that is, 38, will be replaced with the numeric prefix of the receptacle contact 40, that is, 40. Each of the pairs of contacts 40a and 40b is a neutral receptacle contact and is adapted to receive one prong of a two-prong or three-prong electrical plug.

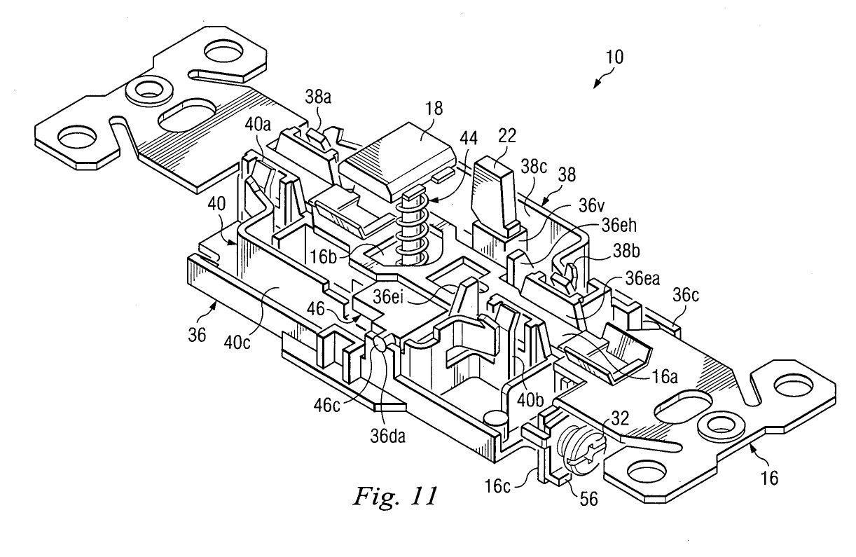

In an exemplary embodiment, when the mounting strap 16, the middle housing 36, the spring 44, the actuator 46 and the receptacle contacts 38 and 40 are in an assembled condition as illustrated in FIG. 11, the receptacle contact 38 is received by the middle housing 36 so that the pair of contacts 38a is disposed in the region 36h, the wall 38c is disposed within the region 36l and extends between the wall 36c and the protrusion 36v, and the pair of contacts 38b is disposed in the region 36i. The surfaces 38aa and 38ba of the pairs of contacts 38a and 38b, respectively, are proximate or contact the tray portion 36b. Moreover, the slanted portion 38dd at least partially extends within the opening 36n, and the contact 38d at least partially extends within the opening 36n. As a result, the receptacle contact 38 is captured within the middle housing 36, at least with respect to movement of the receptacle contact 38 in a plane of motion that is parallel to the tray portion 36b of the middle housing 36.

Similarly, the receptacle contact 40 is received by the middle housing 36 so that the pair of contacts 40a is disposed in the region 36j, the wall 40c is disposed within the region 36m, and the pair of contacts 40b is disposed in the region 36i. The surfaces 40aa and 40ba of the pairs of contacts 40a and 40b, respectively, are proximate or contact the tray portion 40a. Moreover, the slanted portion 40dd at least partially extends within the opening 36o, and the contact 40d at least partially extends within the opening 36o. As a result, the receptacle contact 40 is captured within the middle housing 36, at least with respect to movement of the receptacle contact 40 in a plane of motion that is parallel to the tray portion 36b of the middle housing 36.

As a result of the above-described receipt of the receptacle contacts 38 and 40 by the middle housing 36, the receptacle contacts 38 and 40 are substantially electrically isolated from each other.

The spring 44 is received by the middle housing 36, extending within the counterbore 36a so that an end of the helical portion 44a contacts the internal shoulder 36 eq and the leg 44b extends through the channel 36er and into the region 36m. The light pipe 22 is received by the middle housing 36, extending within the passage 36va of the protrusion 36v. The stepped end portion 22a and the protrusion 22b of the light pipe 22 engage an end of the protrusion 36v.

As noted above, the actuator 46 is received by the middle housing 36. More particularly, the tab 46b of the actuator 46 extends within and is supported by the notch 36ee in the wall 36eb of the center portion 36e of the middle housing 36, and the tab 46c extends within and is supported by the notch 36da in the wall 36d of the middle housing 36. The protrusion 46d of the actuator 46 extends downward between the walls 36eb and 36ec of the middle housing 36, and between the opposing legs of the U-shaped portion 48c of the torsion spring 48. The protrusion 46e extends downward into the region 36m, and contacts the leg 44b of the spring 44, under conditions to be described.

The mounting strap 16 is received by the middle housing 36 so that the center portion 16a extends within the channel 36ea and is supported by the center portion 36e of the middle housing 36. The opening 16b in the mounting strap 16 is substantially aligned with the bore 36a that extends through the cylindrical protrusion 36ed of the center portion 36e. A portion of the planar portion 46a of the actuator 46 is positioned between the mounting strap 16 and the center portion 36e of the middle housing 36.

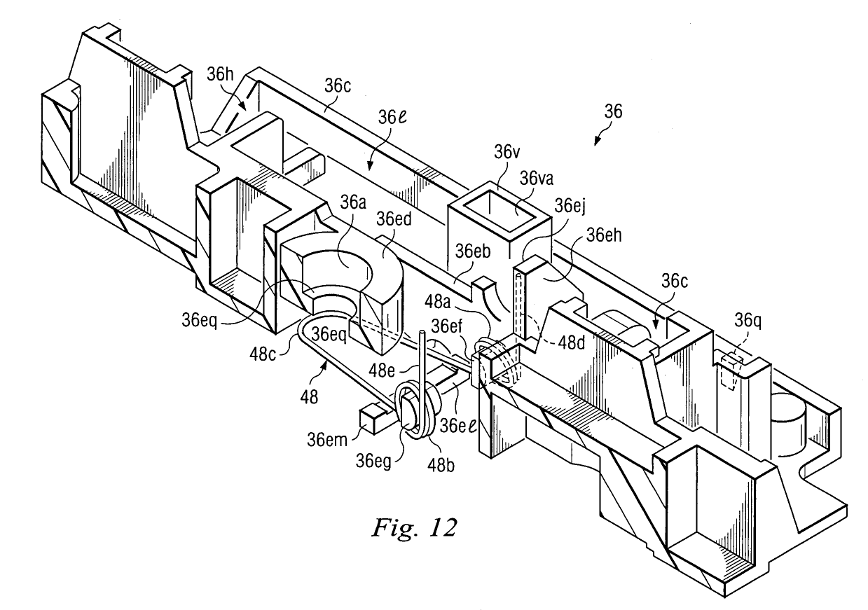

In an exemplary embodiment, as illustrated in FIG. 12 and as noted above, torsion spring 48 is coupled to the middle housing 36. More particularly, the torsion spring 48 is disposed between the walls 36eb and 36ec so that the protrusions 36ef and 36eg extend into the coil portions 48a and 48b, respectively, and so that the legs 48d and 48e contact the surfaces 36ej and 36ek, respectively. The U-shaped portion 48c extends downward between the walls 36eb and 36ec and the opposing legs of the U-shaped portion 48c contact the tabs 36el and 36em, respectively. As a result of the contact between the legs 48d and 48e, and the surfaces 36ej and 36ek, respectively, and between the U-shaped portion 48c and the tabs 36el and 36em, the torsion spring 48 applies reaction or biasing forces against the surfaces 36ej and 36ek, and the tabs 36el and 36em. Moreover, as a result of the extension of the protrusions 36ef and 36eg into the coil portions 48a and 38b, respectively, the opposing legs of the U-shaped portion 48c are compressed and the coil portions 48a and 48b apply biasing or reaction forces against the walls 36eb and 36ec, respectively. As a result of the above-described biasing or reaction forces applied by the torsion spring 48, the torsion spring 48 is coupled to the middle housing 36.

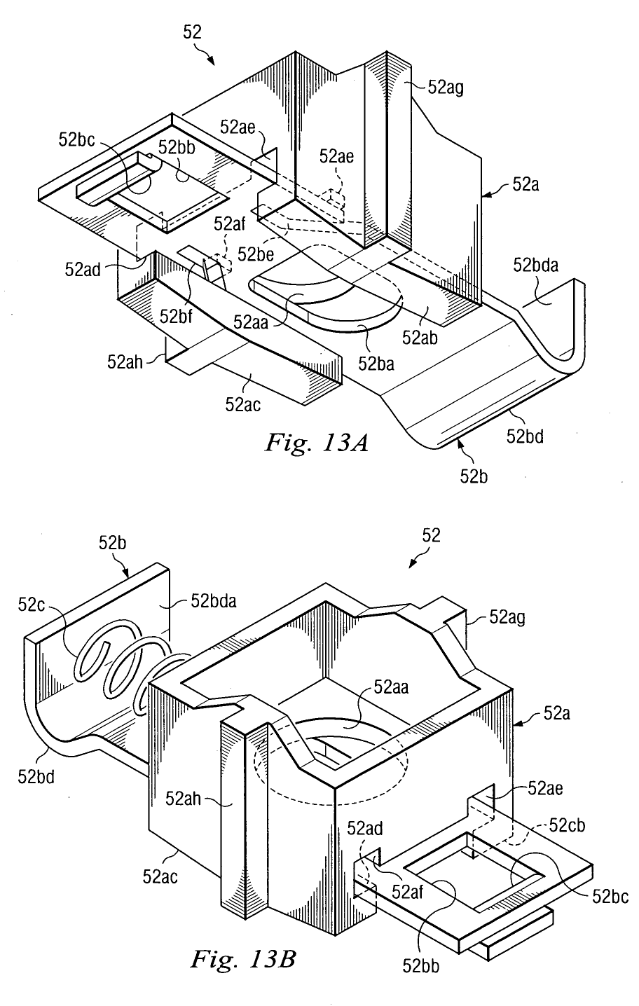

In an exemplary embodiment, as illustrated in FIGS. 13A and 13B, the latch assembly 52 includes a latch block 52a having an opening 52aa formed therethrough, and opposing generally L-shaped tabs 52ab and 52ac extending therefrom. A channel 52ad is defined by the tabs 52ab and 52ac. Parallel-spaced channels 52ae and 52af are formed in the latch block 52a and are adjacent the channel 52ad. The latch block 52a further includes opposing, vertically-extending protrusions 52ag and 52ah.

A generally planar latch 52b is coupled to the latch block 52a, extending through the channel 52ad, and includes a center opening 52ba formed therethrough, an opening 52bb formed therethrough, a curved surface 52bc partially defining the opening 52bb, and a curved distal end portion 52bd defining a surface 52bda. The latch 52b further includes parallel-spaced protrusions 52be and 52bf, which extend within the channels 52ae and 52af, respectively, of the latch block 52a.

A spring 52c is coupled to, and disposed between, the surface 52ai of the latch block 52a and the surface 52bda of the latch 52b. Due to the compression of the spring 52c, the spring 52c applies biasing or reaction forces against the latch block 52a and the surface 52bda, causing the protrusions 52be and 52bf of the latch 52b to engage respective surfaces of the latch block 52a defined by the channels 52ae and 52af, respectively. As a result, the latch 52b is coupled to the latch block 52a. The latch 52b is adapted to slide within the channel 52ad, relative to the latch block 52a, under conditions to be described.

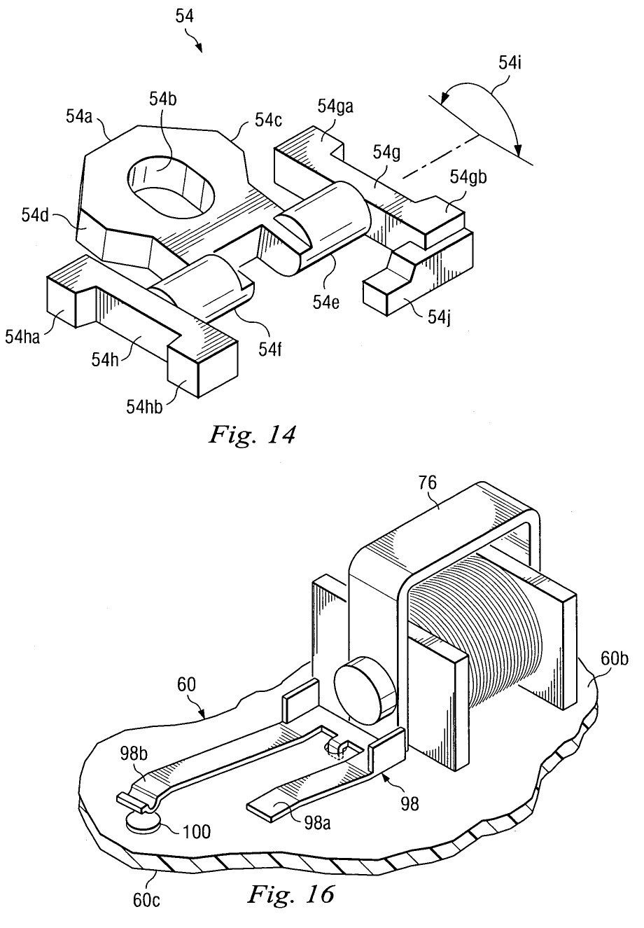

In an exemplary embodiment, as illustrated in FIG. 14, the cam 54 includes a center portion 54a having an opening 54b formed therethrough and opposing knobs 54c and 54d. Opposing pins 54e and 54f extend from the center portion 54a, and parallel-spaced legs 54g and 54h are coupled to the pins 54e and 54f, respectively. The respective longitudinal center axes of the pins 54e and 54f are axially aligned. The leg 54g includes opposing end knobs 54ga and 54gb, and the leg 54h includes opposing end knobs 54ha and 54hb. An angle 54i is defined between the legs 54g and 54h and the center portion 54a. A stepped protrusion 54j extends from the end knob 54gb of the leg 54g.

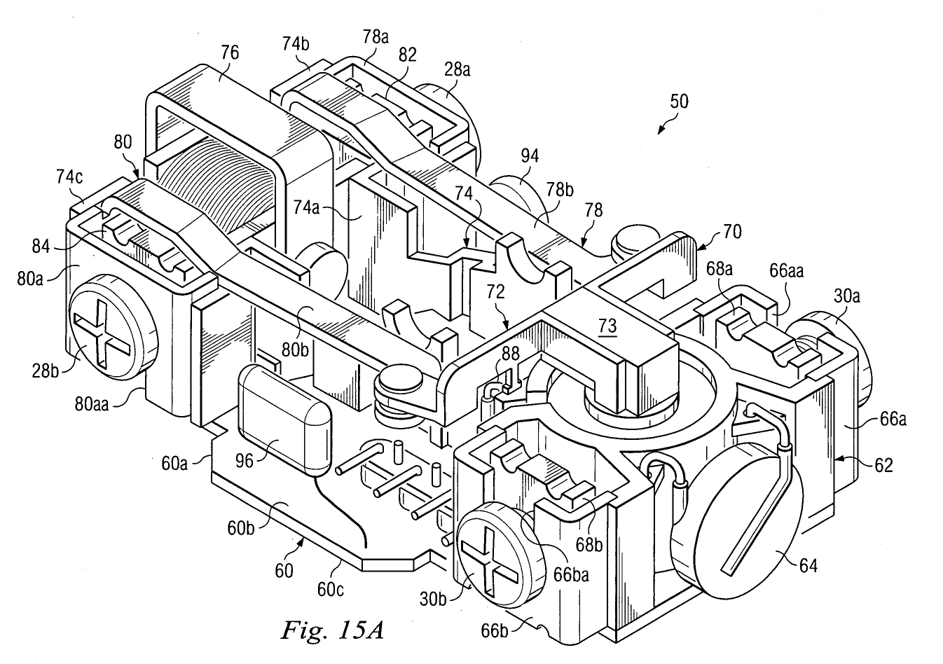

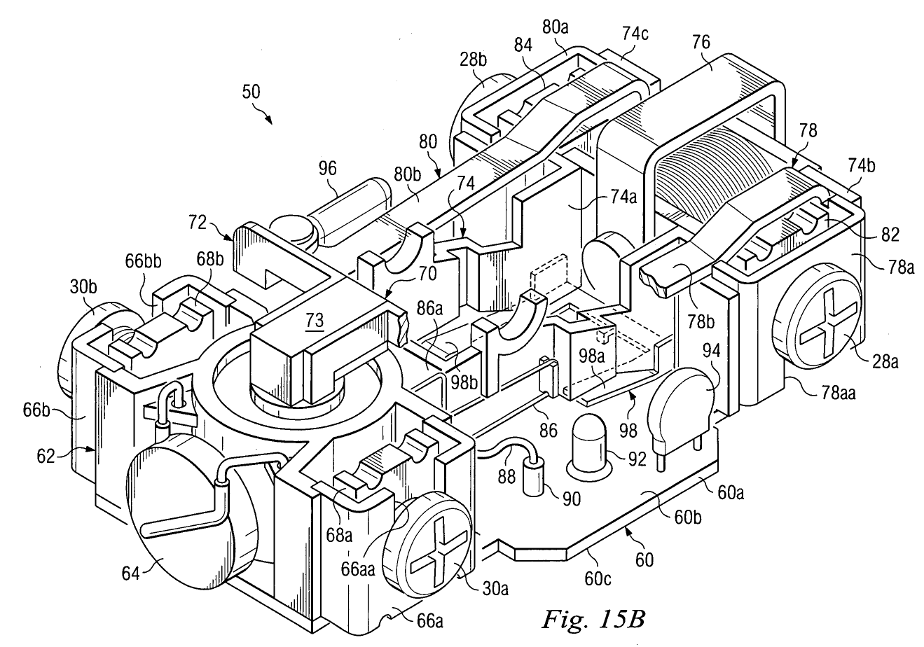

In an exemplary embodiment, as illustrated in FIGS. 15A and 15B, the PCB assembly 50 includes a printed circuit board 60 defining a perimeter 60a and surfaces 60b and 60c spaced in a parallel relation, and to which a transformer assembly 62 is coupled and is adjacent the surface 60b. A capacitor 64 engages the transformer assembly 62 and is coupled to the circuit board 60. Input line terminals 66a and 66b defining notches 66aa and 66ba, respectively, are coupled to the circuit board 60. The screws 30a and 30b extend through the notches 66aa and 66ba, respectively, and are captively threadably engaged with terminal plates 68a and 68b, respectively, which are disposed between the transformer assembly 62 and the input line terminals 66a and 66b, respectively.

Stationary contacts 70 and 72 are coupled to the circuit board 60 and engage the transformer assembly 62. An upside-down-L-shaped isolating member 73 is disposed between the stationary contacts 70 and 72 and engages the transformer assembly 62. A frame 74 is coupled to the circuit board 60 and includes a center portion 74a and opposing wing portions 74b and 74c extending from the center portion 74a. A solenoid assembly 76 is coupled to the circuit board 60 and is at least partially disposed between the wing portions 74b and 74c of the frame 74. A load-terminal portion 78a of a movable contact 78 is received by the wing portion 74b and defines a notch 78aa, through which the screw 28a extends. An arm 78b of the movable contact 78 extends from the load-terminal portion 78a and towards the stationary contact 70, and is adapted to engage the stationary contact 70 under conditions to be described. A load-terminal portion 80a of a movable contact 80 is received by the wing portion 74c and defines a notch 80aa, through which the screw 28b extends. An arm 80b of the movable contact 80 extends from the load-terminal portion 80a and towards the stationary contact 72, and is adapted to engage the stationary contact 72 under conditions to be described. The screws 28a and 28b are captively threadably engaged with terminal plates 82 and 84, respectively, which are received by the wing portions 74b and 74c, respectively.

In an exemplary embodiment, as illustrated in FIG. 16, a wire spring 86 is coupled to the center portion 74a of the frame 74 and is further coupled to the circuit board 60. A distal end portion 86a of the spring 86 is adapted to engage, and be electrically coupled to, the stationary contact 70 under conditions to be described; thus, a switch is formed by the spring 86 and the stationary contact 70. A cable 88 is electrically coupled to, and extends between, the stationary contact 72 and a diode 90, which, in turn, is coupled to the circuit board 60. A light source such as, for example, a light-emitting-diode (LED) 92, is coupled to the circuit board 60 and is at least proximate the surface 60b. A capacitor 94 is coupled to the circuit board 60 in the vicinity of the LED 92. A capacitor 96 is also coupled to the circuit board 60. Although not shown in FIGS. 15-17, a variety of other electronic devices and components are coupled to the surface 60c of the circuit board 60.

A spring bracket 98 is coupled to the circuit board 60, and is at least partially disposed between the solenoid assembly 76 and the surface 60b of the circuit board 60. An angularly-extending spring arm 98a of the spring bracket 98 extends generally upward from the surface 60b of the circuit board 60, and generally from the solenoid assembly 76 and towards the transformer assembly 62. An angularly-extending spring arm 98b of the spring bracket 98 also extends generally upward from the surface 60b of the circuit board 60, and generally from the solenoid assembly 76 and towards the transformer assembly 62. The spring arms 98a and 98b are spaced in a generally parallel relation and have substantially similar angles of extension, relative to the circuit board 60. A contact 100 is coupled to the circuit board 60, is disposed in the vicinity of the distal end of the spring arm 98b, and is adapted to engage the spring arm 98b under conditions to be described.

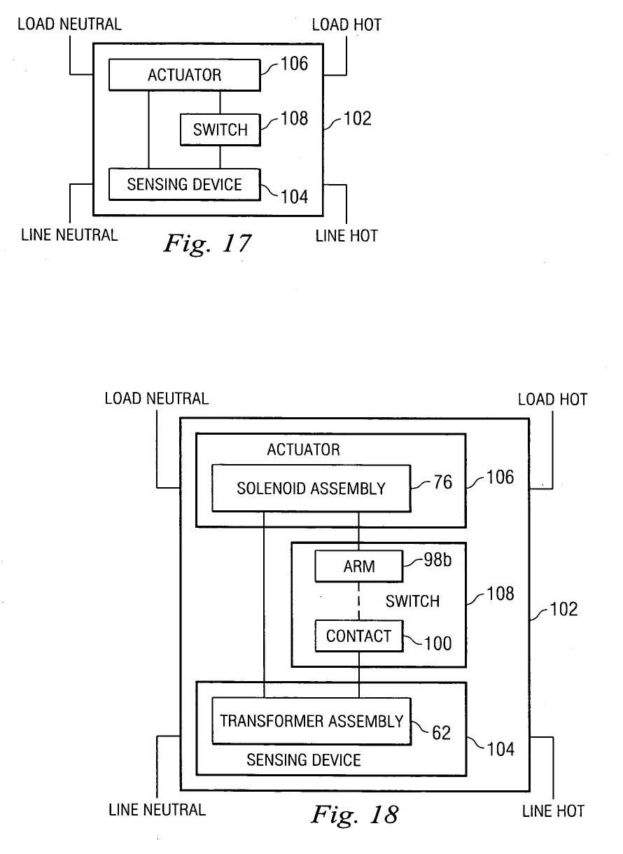

In an exemplary embodiment, as illustrated in FIG. 17 with continuing reference to FIGS. 15A, 15B and 16, the PCB assembly 50 includes a GFCI circuit 102, which, in turn, includes a sensing device 104. An actuator 106 is electrically coupled to the sensing device 104, and a switch 108 is electrically coupled to the actuator 106 and the sensing device 104. The GFCI circuit 102 is adapted to be electrically coupled to Line Hot and Line Neutral wiring, and to Load Hot and Load Neutral wiring.

In an exemplary embodiment, as illustrated in FIG. 18, the GFCI circuit 102 includes several of the above-described parts of the PCB assembly 50. More particularly, the sensing device 104 comprises the transformer assembly 62, the actuator 106 comprises the solenoid assembly 76, and the switch 108 comprises the arm 98b and the contact 100. As a result, in the GFCI circuit 102, the transformer assembly 62 is electrically coupled to the solenoid assembly 76, the arm 98b is electrically coupled to the solenoid assembly 76 and the contact 100 is electrically coupled to the transformer assembly 62.

The GFCI circuit 102 further includes the input line terminals 66a and 66b, the stationary contacts 70 and 72, the movable contacts 78 and 80 including the load-terminal portions 78a and 80a, respectively, the spring 86, the cable 88, the diode 90, the LED 92 and the capacitors 64, 94 and 96. The remainder of the GFCI circuit 102 includes conventional GFCI circuitry, devices and/or components, and therefore the remainder of the GFCI circuit 102 will not be described in detail. In several exemplary embodiments, the conventional GFCI circuitry, devices and/or components are coupled to the circuit board 60, including being mounted on the surfaces 60b and/or 60c of the circuit board 60, and/or within the circuit board 60.

In the GFCI circuit 102, the input terminals 66a and 66b are electrically coupled to the stationary contacts 70 and 72, respectively, which, in turn, are operably coupled to the transformer assembly 62. Moreover, the stationary contacts 70 and 72 are adapted to be electrically coupled to the movable contacts 78 and 80, respectively, under conditions to be described. The spring 86 is adapted to be electrically coupled to the stationary contact 70 under conditions to be described. The diode 90 is electrically coupled to the LED 92.

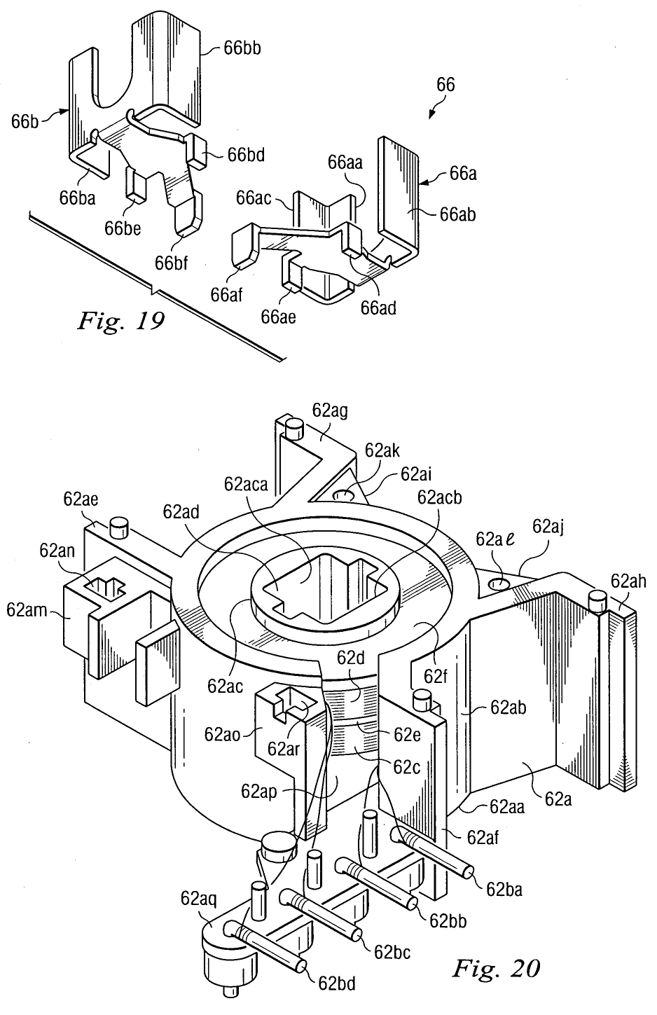

In an exemplary embodiment, as illustrated in FIG. 19, the input line terminal 66a further includes parallel-spaced walls 66ab and 66ac and tabs 66ad, 66ae and 66af. The input line terminal 66b further includes parallel-spaced walls 66bb and 66bc and tabs 66bd, 66be and 66bf. The input line terminals 66a and 66b are symmetric equivalents of each, about an imaginary plane that is generally perpendicular to the walls 66ab, 66ac, 66bb and 66bc and that is disposed midway between the input line terminals 66a and 66b.

In an exemplary embodiment, as illustrated in FIG. 20, the transformer assembly 62 includes a boat 62a including a disk-shaped base 62aa having a partially circumferentially-extending wall 62ab extending upward therefrom. A cylindrical protrusion 62ac extends upward from the base 62aa and is surrounded by the wall 62ab. A through-opening 62ad extends through the cylindrical protrusion 62ac and the base 62aa, defining parallel-spaced inside surfaces 62aca and 62acb of the cylindrical protrusion 62ac. Opposing support arms 62ae and 62af, and opposing support arms 62ag and 62ah, extend outwardly from the wall 62ab. Gussets 62ai and 62aj extend between the outside surface of the wall 62ab and the support arms 62ag and 62ah, respectively, and bores 62ak and 62al are formed through the gussets 62ai and 62aj, respectively.

A protrusion 62 am extends from the arm 62ae and the wall 62ab, and an opening 62an is formed in the protrusion 62 am. A protrusion 62ao extends from the outside surface of the wall 62ab, and a partially circumferentially-extending gap 62ap is defined between the protrusion 62ao and the support arm 62af. A platform 62aq extends from the protrusion 62ao and the support arm 62af, and across the gap 62ap. An opening 62ar is formed in the protrusion 62ao. Contact pins 62ba, 62bb, 62bc and 62bd are coupled to the platform 62aq of the boat 62a.

A transformer coil 62c is received by the boat 62a, circumferentially extending about the cylindrical protrusion 62ac and radially extending between the cylindrical protrusion 62ac and the inside surface of the wall 62ab. The transformer coil 62c is electrically coupled to the pins 62ba and 62bb, which are a part of the circuit 102. Similarly, a transformer coil 62d is received by the boat 62a and disposed above the transformer coil 62c, circumferentially extending about the cylindrical protrusion 62ac and radially extending between the cylindrical protrusion 62ac and the inside surface of the wall 62ab. The transformer coil 62d is electrically coupled to the pins 62bc and 62bd, which are a part of the circuit 102. An insulating washer 62e is disposed between the transformer coils 62c and 62d, and an insulating washer 62f is disposed on top of the transformer coil 62d.

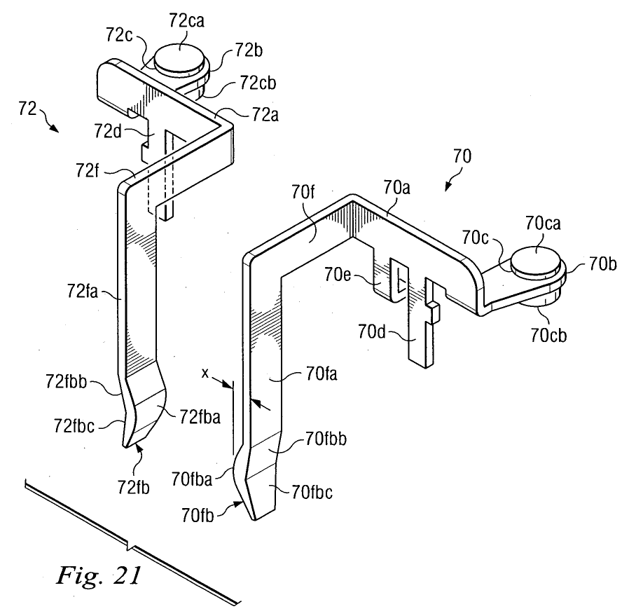

In an exemplary embodiment, as illustrated in FIG. 21, the stationary contact 70 includes a horizontally-extending portion 70a and a tab 70b extending from an end of the portion 70a. A contact 70c defining contact surfaces 70ca and 70cb is coupled to the distal end of the tab 70b. A protrusion 70d extends downward from the portion 70a, and an L-shaped tab 70e also extends downward from the portion 70a. An upside-down L-shaped contact arm 70f extends from the portion 70a and includes a vertically-extending portion 70fa. A kinked portion 70fb extends from the portion 70fa, and includes a generally curved portion 70fba and angularly-extending portions 70fbb and 70fbc, which meet at a vertex location that generally corresponds to the middle of the curve of the curved portion 70fba. At least a portion of the curved portion 70fba is offset from the vertically-extending portion 70fa by a distance x. The curved portion 70fba and the angularly-extending portion 70fbc taper towards each other, generally forming a stab at the distal end of the contact arm 70f.

In several exemplary embodiments, instead of, or in addition to the portions 70fba, 70fbb and 70fbc, the kinked portion 70fb of the contact arm 70 may include one or more other portions having a wide variety of shapes and sizes, with at least a portion of at least one of the one or more portions being offset from at least a portion of the vertically-extending portion 70fa, in the offset direction of the curved portion 70fba, and/or in a direction opposing the offset direction of the curved portion 70fba. In an exemplary embodiment, in addition to, or instead of the curved portion 70fba, the kinked portion 70fb may include, for example, a pair of angularly-extending portions that form a peak, one or more twisted and/or cork-screw portions, one or more dimples, one or more bulges, and/or any combination thereof.

The stationary contact 72 is the symmetric equivalent to the stationary contact 70, about an imaginary plane that is parallel to the contact arm 70f and disposed midway between the stationary contacts 70 and 72, and therefore the stationary contact 72 will not be described in detail, except that the stationary contact 72 does not include a feature equivalent to the tab 70e of the stationary contact 70. Reference numerals used to refer to features of the stationary contact 72 will correspond to the reference numerals for the stationary contact 70, except that the numeric prefix for the reference numerals used to describe the stationary contact 70, that is, 70, will be replaced with the numeric prefix of the stationary contact 72, that is, 72.

In several exemplary embodiments, instead of, or in addition to the portions 72fba, 72fbb and 72fbc, the kinked portion 72fb of the contact arm 72 may include one or more other portions having a wide variety of shapes and sizes, with at least a portion of at least one of the one or more portions being offset from at least a portion of the vertically-extending portion 72fa, in the offset direction of the curved portion 72fba, and/or in a direction opposing the offset direction of the curved portion 72fba. In an exemplary embodiment, in addition to, or instead of the curved portion 72fba, the kinked portion 72fb may include, for example, a pair of angularly-extending portions that form a peak, one or more twisted and/or cork-screw portions, one or more dimples, one or more bulges, and/or any combination thereof.

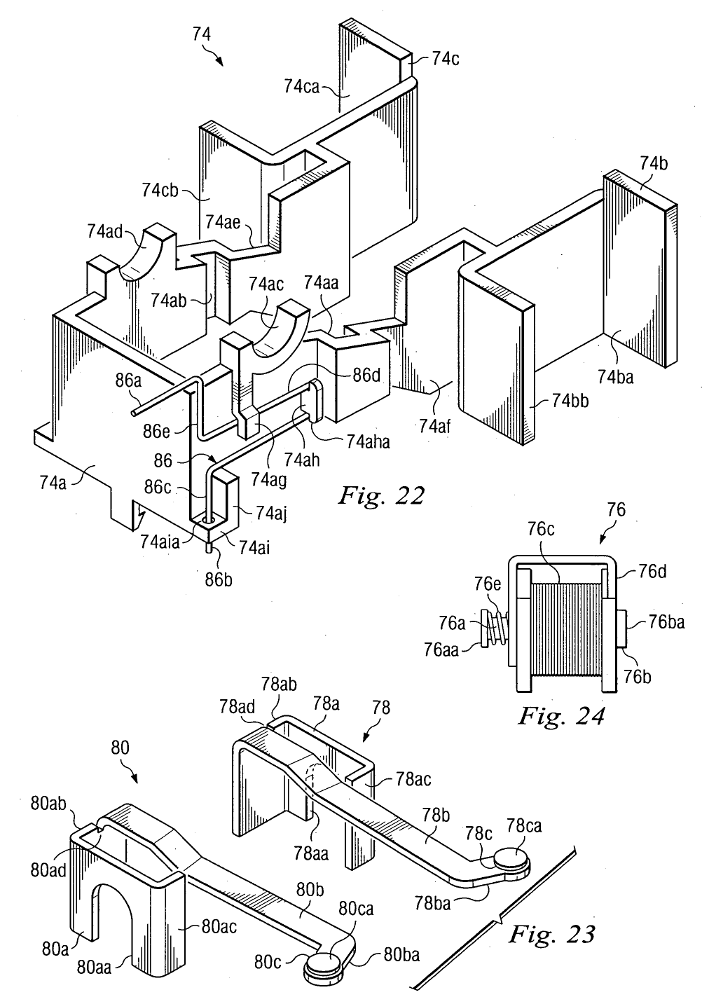

In an exemplary embodiment, as illustrated in FIG. 22, the center portion 74a of the frame 74 defines spaced channels 74aa and 74ab, and includes generally coaxial notches 74ac and 74ad. The center portion 74a further includes parallel-spaced walls 74ae and 74af. A hook-shaped protrusion 74ag, a tab 74ah having an enlarged end portion 74aha, and a tab 74ai extend from the wall 74af. A bore 74aia extends through the tab 74ai. A tab 74aj extends upward from the tab 74ai and along the wall 74af. The wing portion 74b includes parallel-spaced walls 74ba and 74bb, and the wing portion 74c includes parallel-spaced walls 74ca and 74cb. The frame 74 is coupled to the circuit board 60 in a conventional manner such as, for example, by using one-more conventional snap-fit protrusions extending from the center portion 74a, the wing portion 74b and/or the wing portion 74c.

As noted above, the spring 86 is coupled to the center portion 74a of the frame 74 and is further coupled to the circuit board 60. More particularly, an end portion 86b of the spring 86 is soldered to the circuit board 60, which is not shown in FIG. 22, and a vertically-extending portion 86c of the spring 86 extends upward through the bore 74aia and along the tab 74aj. A generally backwards C-shaped portion 86d of the spring 86 extends around the protrusion 74ah and between the hook-shaped protrusion 74ag and the wall 74af of the frame 74. An upside-down L-shaped portion 86e, which includes the distal end portion 86a, extends upwardly and then towards the stationary contact 70. Under conditions to be described, the distal end portion 86a of the spring 86 is adapted to contact, and be electrically coupled to, the tab 70e of the stationary contact 70, thus closing the switch formed by the spring 86 and the stationary contact 70. The hook-shaped protrusion 74ag and the enlarged end portion 74aha of the protrusion 74ah trap the spring 86 against the wall 74af. Moreover, the tab 74aj and the hook-shaped protrusion 74ag urge the opposing legs of the backwards C-shaped portion 86d towards each other, thereby causing the opposing legs of the backwards C-shaped portion 86d to apply biasing or reaction forces against the tab 74aj and the hook-shaped protrusion 74ag, respectively. As a result, the spring 86 is further trapped against the wall 74af.

In an exemplary embodiment, as illustrated in FIG. 23, the load-terminal portion 78a of the movable contact 78 includes parallel-spaced walls 78ab and 78ac, and a notch 78ad formed in the wall 78ab. The arm 78b extends from the wall 78ab and includes a dog-leg-shaped distal end portion 78ba to which a contact 78c defining a contact surface 78ca is coupled.

The movable contact 80 is the symmetric equivalent to the movable contact 78, about an imaginary plane that is perpendicular to the walls 78aa and 78ab and disposed midway between the movable contacts 78 and 80. The load-terminal portion 80a of the movable contact 80 includes parallel-spaced walls 80ab and 80ac, and a notch 80ad formed in the wall 80ab. The arm 80b extends from the wall 80ab and includes a dog-leg-shaped distal end portion 80ba to which a contact 80c defining a contact surface 80ca is coupled.

In an exemplary embodiment, as illustrated in FIG. 24, the solenoid assembly 76 includes a rod 76a and a plunger 76b coupled to an end portion of the rod 76a. The plunger 76b includes an enlarged-diameter end portion 76ba. A coil 76c at least partially surrounds the rod 76a. An end surface 76d is defined by the solenoid assembly 76. The rod 76a extends through a spring 76e, which applies a biasing or reaction force against an enlarged-diameter portion 76aa of the rod 76a, thereby causing the enlarged-diameter end portion 76ba of the plunger 76b to be normally biased against the end surface 76d of the solenoid assembly. The solenoid assembly 76 is adapted to be energized, thereby causing the enlarged-diameter end portion 76ba of the plunger 76b to move away from the end surface 76d and the spring 76e to be compressed, under conditions to be described. The solenoid assembly 76 is coupled to the circuit board 60 in a conventional manner such as, for example, by using one or more conventional snap-fit protrusions. Moreover, the coil 76c of the solenoid assembly is electrically coupled to the circuit 102, and is further coupled to the circuit board 60, in a conventional manner such as, for example, by using leads that extend into the circuit board 60 and are soldered thereto.

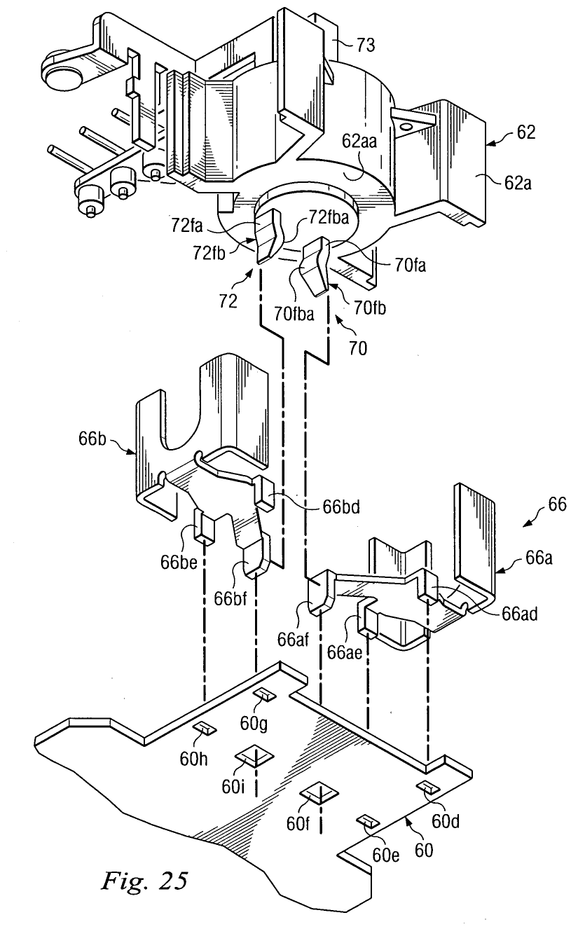

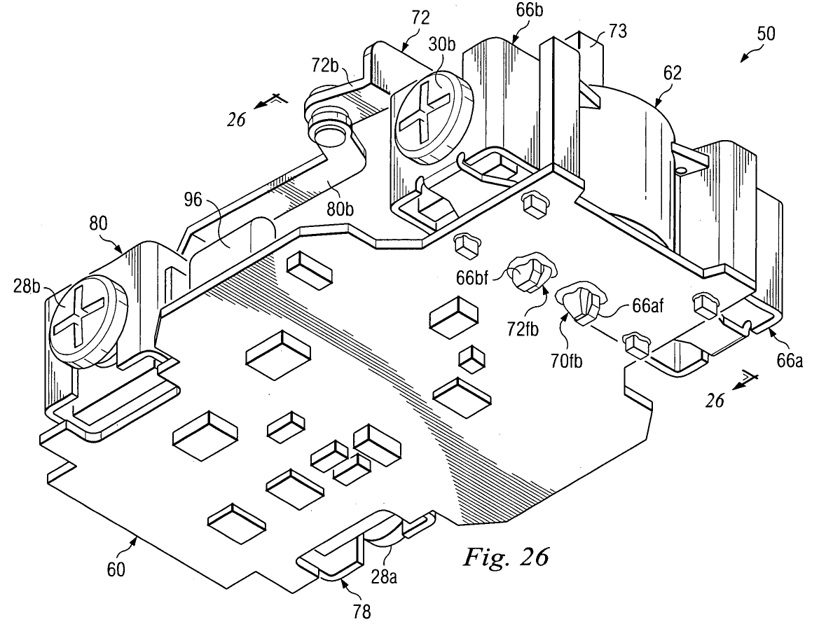

To couple the transformer assembly 62 to the circuit board 60, in an exemplary embodiment and as illustrated in FIGS. 25, 26 and 27, the tabs 66ad, 66ae and 66af of the input line terminal 66a are inserted into openings 60d, 60e and 60f, respectively, of the circuit board 60, and the tabs 66bd, 66be and 60bf are inserted into openings 60g, 60h and 60i, respectively, of the circuit board 60.

Before, during or after the insertion of the tabs 66ad, 66ae, 66af, 66bd, 66be and 66bf into the openings 60d, 60e, 60f, 60g, 60h and 60i, respectively, the stationary contacts 70 and 72 are coupled to the transformer assembly 62 by extending the contact arms 70f and 72f through the opening 62ad, extending the tabs 70d and 72d into the openings 62an and 62ar, respectively, and extending the isolating member 73 into the opening 62ad so that the isolating member 73 is disposed between the contact arms 70f and 72f. The portion 70fa of the contact arm 70f is disposed between the surface 62aca and the isolating member 73, and the portion 72fa of the contact arm 72f is disposed between the surface 62acb and the isolating member 73.

Before, during or after the insertion of the tabs 66ad, 66ae, 66af, 66bd, 66be and 66bf into the openings 60d, 60e, 60f, 60g, 60h and 60i, respectively, one or both of the circuit board 60 and the transformer assembly 62, having the contact arms 70f and 72f extending through the opening 62ad as described above, are moved so that the contact arms 70f and 72f of the stationary contacts 70 and 72, respectively, are inserted into the openings 60f and 60i, respectively.

As the contact arms 70f and 72f are inserted into the openings 60f and 60i, respectively, the curved portions 70fba and 72fba of the kinked portions 70fb and 72fb, respectively, contact edges of the circuit board 60 defined by the openings 60f and 60i, respectively, and the kinked portions 70fb and 72fb are forced through the openings 60f and 60i, respectively, and between the circuit board 60 and the tabs 66af and 66bf, respectively. As the kinked portions 70fb and 72fb are forced through the openings 60f and 60i, respectively, the contact between the curved portions 70fba and 72fba and the circuit board 60 causes at least the kinked portions 70fb and 72fb to flex and deflect away from each other. Once the kinked portions 70fb and 72fb pass through the openings 60f and 60i, respectively, the kinked portions 70fb and 72fb flex back and return to their normal positions, relative to one another. The base 62aa is adjacent the surface 60b of the circuit board 60, the vertically-extending portions 70fa and 72fa extend within the openings 60f and 60i, respectively, and the kinked portions 70fb and 72fb engage the surface 60c of the circuit board 60, with at least respective portions of the curved portions 70fba and 72fba engaging the surface 60c, with the surface 60c including at least respective edges of the surface 60c that are defined by the openings 60f and 60i. As a result, the transformer assembly 62, and the stationary contacts 70 and 72, are coupled to the circuit board 60. In an exemplary embodiment, the kinked portions 70fb and 72fb may at least partially extend within the openings 60f and 60i, respectively. In an exemplary embodiment, the kinked portions 70fb and 72fb may at least partially extend within the openings 60f and 60i, respectively, and may not engage the surface 60c of the circuit board 60, including any edges of the surface 60c defined by the openings 60f and 60i, and the transformer assembly 62 may be coupled to the circuit board 60 by the interference fit between the kinked portions 70fb and 72fb, the vertically-extending surfaces of the circuit board 60 defined by the openings 60f and 60i, respectively, and the tabs 66af and 66bf, respectively.

In an exemplary embodiment, after the transformer assembly 62 is coupled to the circuit board 60, the contact arms 70f and 72f are soldered to the tabs 66af and 66bf, respectively, and to the circuit board 60, thereby electrically coupling the contact arms 70f and 72f to the tabs 66af and 66bf, and to the circuit board 60. The above-described coupling of the transformer assembly 62 to the circuit board 60 holds the transformer assembly 62 in place, relative to the circuit board 60, thereby facilitating the subsequent soldering of the contact arms 70f and 72f to the tabs 66af and 66bf, respectively, and the circuit board 60. The engagement of the kinked portions 70fb and 72fb with the surface 60c of the circuit board 60 facilitates in preventing the transformer assembly 62 from floating upward and away from the surface 60b of the circuit board 60, and thus holds the transformer assembly 62 in place to facilitate the soldering of the contact arms 70f and 72f to the tabs 66af and 66bf, and to the circuit board 60. As a result, the risk of having to resolder the contact arms 70f and 72f is appreciably reduced, thus reducing rework time and/or yielding reduced manufacturing costs.

The tabs 66ad, 66ae, 66af, 66bd, 66be and 66bf are also soldered to the circuit board 60. Before, during or after the coupling of the transformer assembly 62 to the circuit board 60, the leads of the capacitor 64 are inserted through the bores 62ak and 62al of the transformer assembly 62 and into the circuit board 60, and are soldered thereto. Moreover, the cable 88, which extends from the diode 90, is electrically coupled to the protrusion 72d of the stationary contact 72.

In an exemplary embodiment, the contact arms 70f and 72f may extend through openings in the circuit board 60 other than the openings 60f and 60i, respectively, and the size of each contact arm 70f and 72f and/or each kinked portion 70fb and 72fb may be increased, and/or the size of each opening 60f and 60i may be decreased.

In several exemplary embodiments, one or more other components of the transformer assembly 62 may extend into and/or through other openings in the circuit board 60 such as, for example, the contact pins 62ba, 62bb, 62bc and 62bd.

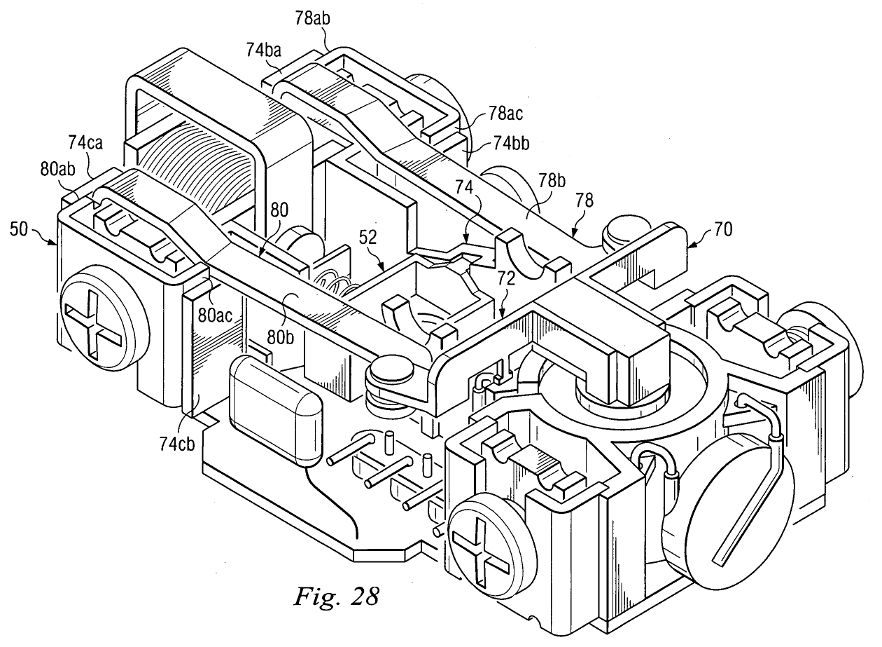

When the PCB assembly 50 in an assembled condition, in an exemplary embodiment and as illustrated in FIG. 28 with continuing reference to FIGS. 15A through 27, the movable contacts 78 and 80 are coupled to the frame 74, as noted above. More particularly, the walls 78ab and 78ac of the line terminal portion 78a of the movable contact 78 extend between and contact the walls 74ba and 74bb, respectively, of the wing portion 74b of the frame 74, thereby coupling the movable contact 78 to the frame 74. Similarly, the walls 80ab and 80ac of the line terminal portion 80a of the movable contact 80 extend between and contact the walls 74ca and 74cb, respectively, of the wing portion 74c of the frame 74, thereby coupling the movable contact 80 to the frame 74. In an exemplary embodiment, conventional snap-fit protrusions extend from the respective inside surfaces of the walls 74ba and 74ca and into the respective notches 78ad and 80ad, thereby further coupling the movable contacts 78 and 80 to the frame 74.

The arms 78b and 80b of the movable contacts 78 and 80, respectively, are positioned so that the distal end portions 78ba and 80ba are positioned below the tabs 70b and 72b, respectively, of the stationary contacts 70 and 72, respectively, and the contact surfaces 78ca and 80ca contact the contact surfaces 70cb and 72cb, respectively. Due to the position of the tabs 70b and 72b, the arms 78b and 80b are flexed downward, causing the arms 78b and 80b to normally apply biasing or reaction forces against the tabs 70b and 72b, respectively. As a result, suitable electrical contact between the contact surfaces 78ca and 70cb, and between the contact surfaces 80ca and 72cb, is facilitated for reasons to be described.

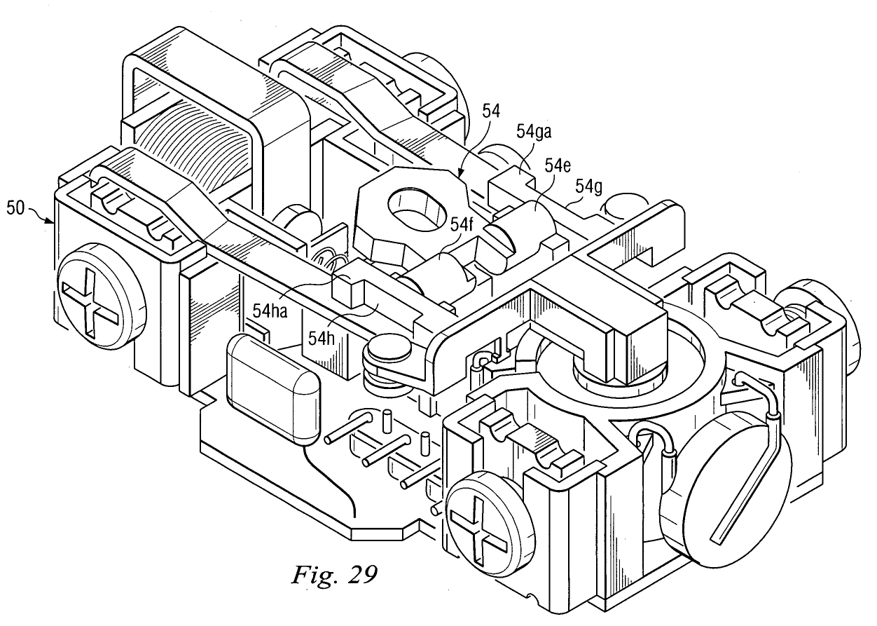

In an exemplary embodiment, when the latch assembly 52, the cam 54 and the PCB assembly 50 are in an assembled condition as illustrated in FIGS. 28 and 29 with continuing reference to FIGS. 15A through 27, the latch assembly 52 is disposed between the walls 74ae and 74af of the frame 74 of the PCB assembly 50, which itself is in its assembled condition described above. As a result, the protrusions 52ag and 52ah of the latch assembly 52 extend within the channels 74aa and 74ab, respectively, of the frame 74, thereby preventing the latch assembly 52 from generally moving towards or away from the plunger 76b of the solenoid assembly 76. The curved distal end portion 52bd of the latch 52b is proximate the plunger 76b. The L-shaped tabs 52ab and 52ac of the latch block 52a contact, and are supported by, the spring arms 98a and 98b, respectively, of the spring bracket 98. Since the L-shaped tabs 52ab and 52ac are the only components of the latch assembly 52 contacting the spring bracket 98, no electrical contact or coupling is made between the latch assembly 52 and the spring bracket 98.

The cam 54 is received by the PCB assembly 50, as noted above. More particularly, the pins 54e and 54f of the cam 54 are cradled in the notches 74ac and 74ad, respectively, of the frame 54. The distal end of the stepped protrusion 54j of the cam 54 contacts or is proximate the end portion 86a of the spring 86. The end knobs 54ga and 54ha of the cam 54 contact or are proximate the arms 78b and 80b, respectively, of the movable contacts 78 and 80, respectively.

Under conditions to be described, the legs 54g and 54h of the cam 54 are adapted to extend in a parallel relation to the arms 78b and 80b, respectively, of the movable contacts 78 and 80, respectively, so that the end knobs 54ga and 54ha are proximate, but do not contact, the arms 78b and 80b, respectively, and so that the distal end of the stepped protrusion 54j contacts the end portion 86a of the spring 86. Moreover, under conditions to be described, the legs 54g and 54h are also adapted to extend angularly so that the end knobs 54ga and 54ha contact the arms 78b and 80b, respectively, and so that the distal end of the stepped protrusion 54j remains proximate, but does not contact, the end portion 86a of the spring 86.

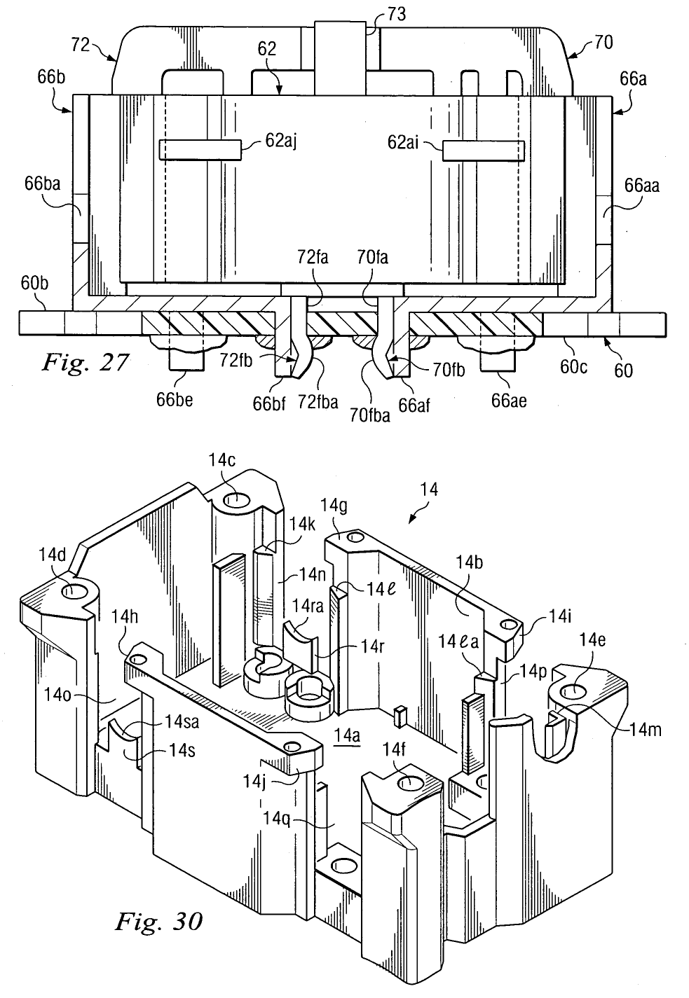

In an exemplary embodiment, as illustrated in FIG. 30, the bottom housing 14 defines a region 14a having a perimeter 14b that substantially corresponds to the perimeter 60a of the circuit board 60 of the PCB assembly 50. The bottom housing 14 includes corner bores 14c, 14d, 14e and 14f, and tabs 14g, 14h, 14i and 14j, and further defines coplanar support surfaces 14k, 14l, 14la and 14m, and opposing coplanar support surfaces that are symmetric thereto, which are not shown in FIG. 27. Opposing openings 14n and 14o, and opposing openings 14p and 14q, are further defined by the bottom housing 14. Protrusions 14r and 14s having notches 14ra and 14sa, respectively, extend within the openings 14n and 14o, respectively.

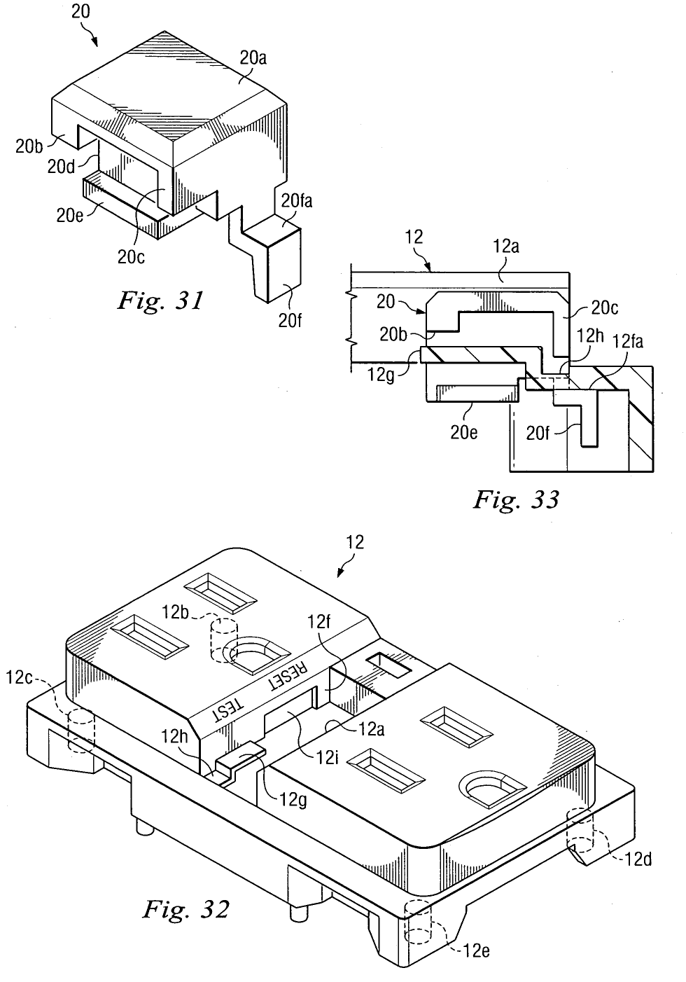

In an exemplary embodiment, as illustrated in FIG. 31, the test button 20 includes a substantially square-shaped protrusion 20a and walls 20b and 20c extending downwardly therefrom. A block 20d also extends downward from the protrusion 20a, and a protrusion 20e extends outward from the block 20d. A stepped tab 20f extends downward from the block 20d and defines a surface 20fa.

In an exemplary embodiment, as illustrated in FIG. 32, the top housing 12 includes corner threaded blind bores 12b, 12c, 12d and 12e. The opening 12a defines a surface 12f and a surface spaced in a parallel relation therefrom, which is not shown in FIG. 29. A protrusion 12g extends from the surface 12f and within the opening 12a, and a recess 12h is formed in the protrusion 12g. A recess 12i is formed in the surface 12f and a recess opposing the recess 12i is formed in the surface defined by the opening 12a and spaced in a parallel relation from the surface 12f.

In an exemplary embodiment, as noted above and as illustrated in FIG. 33, the test button 20 extends within the opening 12a of the top housing 12. More particularly, the test button 20 is positioned within the opening 12a so that the protrusion 12g of the top housing 12 extends between the wall 20b and the protrusion 20e of the test button 20, and the wall 20c of the test button 20 extends into the recess 12h of the top housing 12. As a result, the test button 20 is captured within the opening 12a of the top housing 12, and is permitted to move up and down over a limited range of vertical movement, as viewed in FIG. 33.

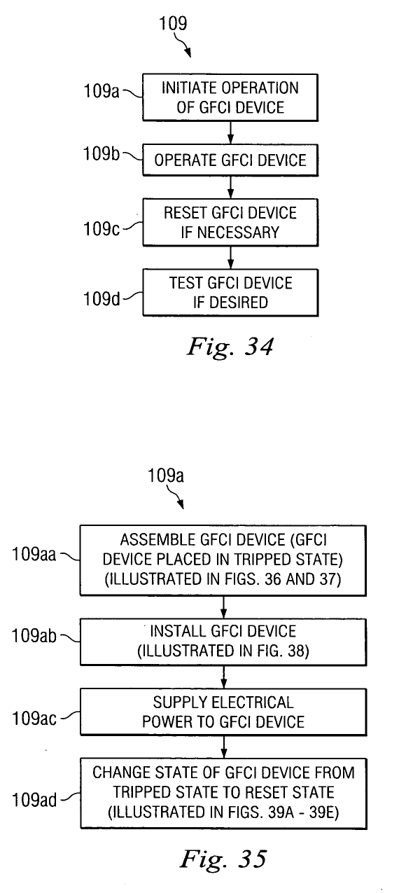

In an exemplary embodiment, as illustrated in FIG. 34, a method 109 of operating the device 10 includes initiating operation of the device 10 in step 109a, and operating the device 10 in step 109b. The method 109 further includes resetting the device 10 in step 109c, if necessary, and testing the device 10 in step 109d, if desired. The steps 109a, 109b, 109c and 109d are described in further detail below.

In an exemplary embodiment, as illustrated in FIG. 35, to initiate operation of the device 10 in the step 109a of the method 109, the device is assembled in step 109aa, after which the device 10 is installed in step 109ab, after which electrical power is supplied to the device 10 in step 109ac, and after which the state of the device 10 is changed from its tripped state to its reset state in step 109ad, with the tripped state and the reset state being the two operational states of the device 10. The steps 109aa, 109ab, 119ac and 109ad, and the tripped and reset states of the device 10, are described in further detail below.

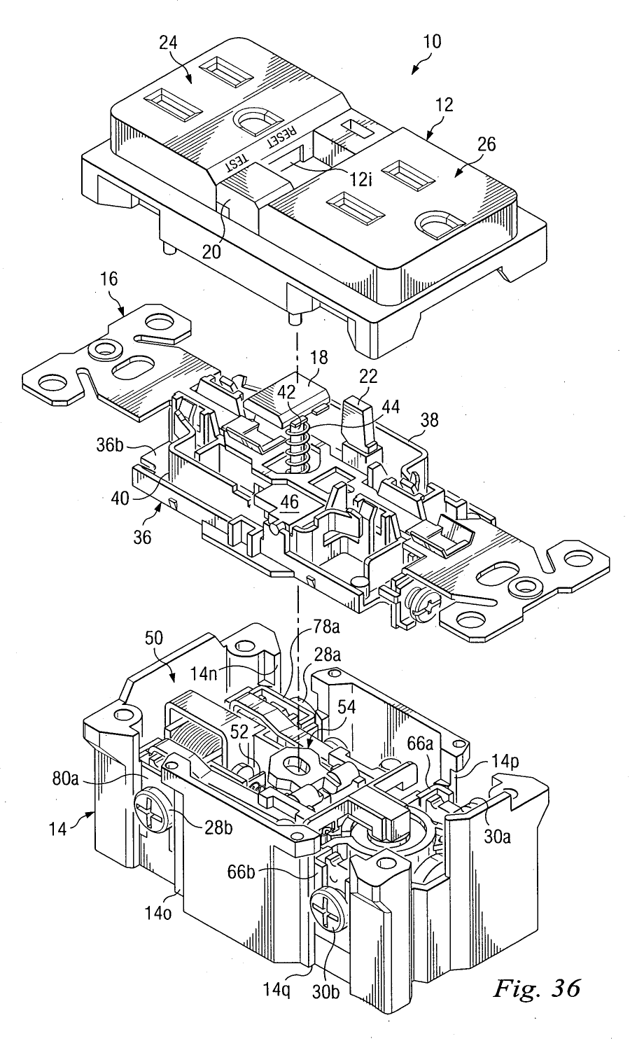

In an exemplary embodiment, when the device 10 is an assembled condition after the step 109aa, as illustrated in FIG. 36 with continuing reference to FIGS. 1-35, the PCB assembly 50 is received by the bottom housing 14, as noted above. More particularly, the circuit board 60 is received into the region 14a, with the substantial correspondence between the perimeter 60a of the circuit board 60 and the perimeter 14b of the bottom housing 14 facilitating the reception of the circuit board 60. The load-terminal portion 78a of the movable contact 78 is aligned with the opening 14n and the screw 28a is cradled in, or proximate, the notch 14ra of the protrusion 14r. Similarly, the load-terminal portion 80a of the movable contact 80 is aligned with the opening 14o and the screw 28b is cradled in, or proximate, the notch 14sa of the protrusion 14s. The input line terminals 66a and 66b are aligned with the openings 14p and 14q, respectively, so that the screws 30a and 30b extend within the openings 14p and 14q, respectively.

The middle housing 36 is coupled to the bottom housing 14, as noted above. More particularly, the tray portion 36b of the middle housing 36 contacts, and is supported by, the support surfaces 14k, 14l, 14la, and 14m, and the corresponding surfaces symmetric thereto, of the bottom housing 14. Moreover, the snap-fit protrusions 36p, 36q, 36r and 36s of the middle housing 36 form snap-fit connections with the tabs 14g, 14i, 14h and 14j, respectively, of the bottom housing 14. The protrusions 36t and 36u extend into the openings 14p and 14q, respectively, and are proximate the screws 30a and 30b, respectively. The upper portions of the pins 54e and 54f of the cam 54 are received into the notches 36eo and 36ep, respectively, of the middle housing 36, while still being cradled in the notches 74ac and 74ad, respectively, of the frame 54. The mounting strap 16, the spring 44, the actuator 46, the torsion spring 48 and the receptacle contacts 38 and 40 are engaged with the middle housing 36, as described above.

As a result of the coupling of the middle housing 36 to the bottom housing 14, the U-shaped portion 48c of the torsion spring 48 contacts the center portion 54a of the cam 54, extending around the opening 54b. As a result, the torsion spring 48 applies a biasing or reaction force against the center portion 54a of the cam 54.

As another result of the coupling of the middle housing 36 to the bottom housing 14, the distal end of the light pipe 22, which opposes the stepped end portion 22a, is proximate the LED 92 of the PCB assembly 50.

The reset button 18 extends within the opening 12a of the top housing 12, as noted above. More particularly, the reset button 18 extends within the opening 12a so that the tabs 18a and 18b of the reset button extend in the recess in the top housing 12 opposing the recess 12i, and the tabs of the reset button 18 opposing the tabs 18a and 18b extend in the recess 12i. As a result, the rest button 18 is prevented from extending upward past the top housing 12. The reset shaft 42 extends downward through the spring 44, the counterbore 36a of the middle housing 36, the opening 54b of the cam 54, the opening 52aa in the latch block 52a of the latch assembly 52 and the opening 52ba in the latch 52b of the latch assembly 52.

Under conditions to be described, the flange 42c of the reset shaft 42 is adapted to be positioned above the latch 52b of the latch assembly 52 so that the surface 42cb of the flange 42c contacts the latch 52b. Moreover, under conditions to be described, the flange 42c of the reset shaft 42 is adapted to be positioned below the latch 52b of the latch assembly 52 so that the surface 42ca of the flange 42c contacts the latch 52b.

The bottom housing 14 is coupled to the top housing 12, as noted above. More particularly, the fasteners 34a, 34b, 34c and 34d extend through the corner bores 14c, 14d, 14e and 14f, respectively, of the bottom housing 14 and into, and are threadably engaged with, the corner threaded blind bores 12b, 12c, 12d and 12e, respectively, of the top housing 12. As a result, the pair of contacts 38a of the receptacle contact 38, and the pair of contacts 40a of the receptacle contact 40, are generally aligned with the corresponding openings in the receptacle outlet 24. Also, the pair of contacts 38b of the receptacle contact 38, and the pair of contacts 40b of the receptacle contact 40, are generally aligned with the corresponding openings in the receptacle outlet 26. Moreover, the helical portion 44a of the spring 44 is at least partially compressed between the internal shoulder 36 eq of the counterbore 36a of the middle housing 36 and the reset button 18.

In an exemplary embodiment, as noted above, the device 10 is initially placed in its tripped state as a result of the assembly of the device 10 in the step 109aa.

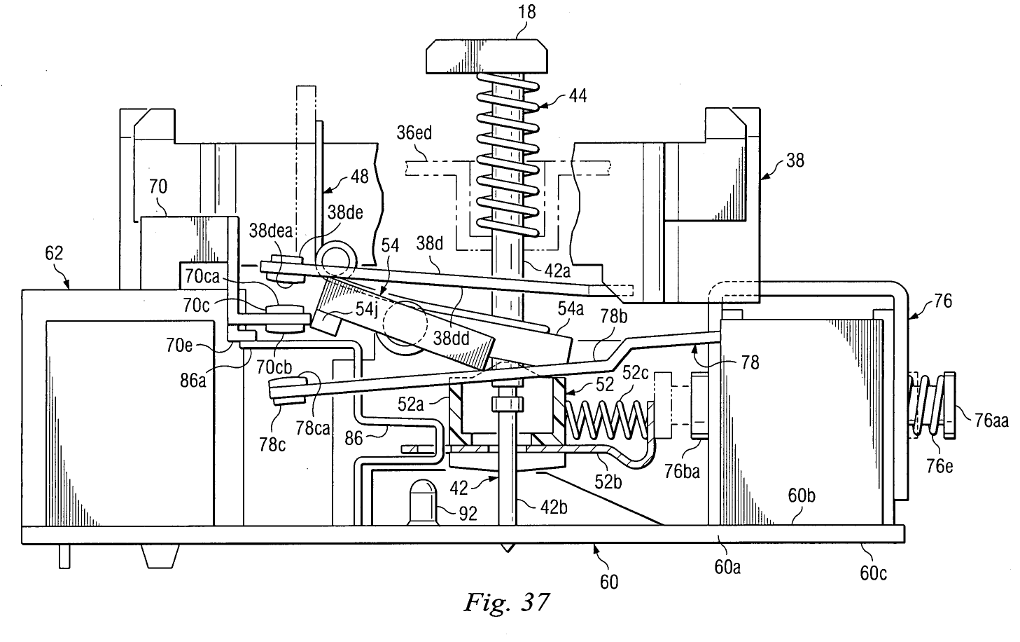

When the device 10 is in its tripped state, in an exemplary embodiment and as illustrated in FIG. 37 with continuing reference to FIGS. 1-36, the flange 42c of the shaft 42 is positioned above the latch 52b of the latch assembly 52. As a result, the torsion spring 48 applies a biasing or reaction force against the center portion 54a of the cam 54, forcing the cam 54 to rotate in a clockwise direction as viewed in FIG. 37, with the pins 54e and 54f of the cam 54 rotating in place, about an imaginary axis defined by the axially-aligned respective longitudinal center axes of the pins 54e and 54f. During this rotation, the pins 54e and 54f remain received within the notches 36eo and 36ep, respectively, of the middle housing 36, and within the notches 74ac and 74ad, respectively, of the frame 54. The torsion 48 spring forces the cam 54 to rotate until the center portion 54a of the cam 54 contacts the walls 74ae and 74af of the frame 74, at which point the cam 54 ceases to rotate.

As a result of the forced rotation of the cam 54 by the torsion spring 48, the end knobs 54ga and 54ha of the legs 54g and 54h, respectively, of the cam 54 apply respective forces against the arms 78b and 80b, respectively, of the movable contacts 78 and 80, respectively, thereby pushing the arms 78b and 80b downward as viewed in FIG. 37. As a result, the contact surface 78ca of the contact 78c of the movable contact 78 is separated from the contact surface 70cb of the contact 70c of the stationary contact 70, and the contact surface 80ca of the contact 80c of the movable contact 80 is separated from the contact surface 72cb of the contact 72c of the stationary contact 72. As a result of this separation, there is no electrical coupling between the contact surfaces 78ca and 70cb, and between the contact surfaces 80ca and 72cb, and thus the movable contacts 78 and 80 are electrically isolated from the stationary contacts 70 and 72, respectively.

The above-described separation of the movable contact 78 from the stationary contact 70 is independent of the above-described separation of the movable contact 80 from the stationary contact 72.

As another result of the forced rotation of the cam 54 by the torsion spring 48, the end knobs 54gb and 54hb of the legs 54g and 54h, respectively, of the cam 54 at least partially extend into the openings 36n and 36o, respectively, of the middle housing 36, and apply forces against the slanted portions 38dd and 40dd, respectively, of the cantilever arms 38d and 40d, respectively, of the receptacle contacts 38 and 40, respectively, thereby pushing the slanted portions 38dd and 40dd upward as viewed in FIG. 37. As a result, the contact surface 38dea of the contact 38de of the arm 38d is separated from the contact surface 70ca of the contact 70c of the stationary contact 70, and the contact surface 40dea of the contact 40de of the arm 40d is separated from the contact surface 72ca of the contact 72c of the stationary contact 72. As a result of this separation, there is no electrical coupling between the contact surfaces 38dea and 70ca, and between the contact surface 40dea and 72ca, and thus the receptacle contacts 38 and 40 are electrically isolated from the stationary contacts 70 and 72, respectively.

The above-described separation of the receptacle contact 38 from the stationary contact 70 is independent of the above-described separation of the receptacle contact 40 from the stationary contact 72.

As described above, the rotation of the cam 54 results in the independent separation, or translation or deflection, of the contact surfaces 78ca and 80ca away from the contact surfaces 70cb and 72cb, respectively, and the independent separation, or translation or deflection, of the contact surfaces 38dea and 40dea away from the contact surfaces 70ca and 72ca, respectively.

The mechanical advantage provided by the cam 54 reduces the amount of force required to be applied on the cam 54 by the torsion spring 48 in order to actuate the arms 38d, 40d, 78b and 80b. Moreover, the above-described transformation of rotational motion to translational motion by the cam 54 permits the arms 38d, 40d, 78b and 80b to be actuated using a relatively small volumetric space within the device 10. That is, the torsion spring 48 and the cam 54 take up a relatively small volumetric space within the device 10, thus permitting a more compact arrangement of components within the device 10, and potentially reducing the overall size of the device 10.

The coplanar portions of the cantilever arm 38d—the turn portion 38da, the longitudinally-extending portion 38db and the U-shaped portion 38dc—increase the overall length of the cantilever arm 38d, with the overall length of the cantilever arm 38d referring to the total of the lengths of extension of the circumferential extension of the turn portion 38da, the longitudinal-length extension of the longitudinally-extending portion 38db, the circumferential extension of the U-shaped portion 38dcm, and the angular-length extension of the slanted portion 38dd.

The magnitude of the force required to deflect the slanted portion 38dd of the arm 38d so that the contact surface 38dea is suitably separated from the contact surface 70ca and the receptacle contact 38 is electrically isolated, or decoupled, from the stationary contact 70, is inversely proportional to the overall length of the cantilever arm 38d. That is, the greater the overall length of the cantilever arm 38d, the less the amount of force required to suitably separate the contact surface 38dea from the contact surface 70ca. Therefore, since the coplanar portions 38da, 38db and 38dc increase the overall length of the arm 38d, the amount of force required to suitably deflect the arm 38d is decreased by the portions 38da, 38db and 38dc. Since less force is required to deflect the arm 38d, the sizes of the cam 54 and the torsion spring 48 may be minimized, thus permitting a more compact arrangement of components within the device 10, and potentially reducing the overall size of the device 10.

Using the coplanar portions 38da, 38db and 38dc of the arm 38d, the above-described increase in the overall length of the arm 38d, and the accompanying decrease in required force, are achieved while maintaining as substantially constant the length of the arm 38d in the longitudinal direction, that is, while not appreciably increasing the length of extension of the arm 38d in a direction that runs parallel to the wall 38c of the receptacle contact 38. As a result, the sizes of the receptacle contact 38 and the middle housing 36 may be minimized, thus permitting a more compact arrangement of components within the device 10, and potentially reducing the overall size of the device 10. Moreover, because the overall length of the arm 38d is increased, relatively thick metal is able to be used to form the receptacle contact 38, including the arm 38d, and the arm 38d is able to be integral with the remainder of the receptacle contact 38, resulting in a cost reduction.

Similarly, the coplanar portions of the cantilever arm 40d—the turn portion 40da, the longitudinally-extending portion 40db and the U-shaped portion 40dc-increase the overall length of the cantilever arm 40d, with the overall length of the cantilever arm 40d referring to the total of the lengths of extension of the circumferential extension of the turn portion 40da, the longitudinal-length extension of the longitudinally-extending portion 40db, the circumferential extension of the U-shaped portion 40dcm, and the angular-length extension of the slanted portion 40dd.

The magnitude of force required to deflect the slanted portion 40dd of the arm 40d so that the contact surface 40dea is suitably separated from the contact surface 72ca and the receptacle contact 40 is electrically isolated, or decoupled, from the stationary contact 72, is inversely proportional to the overall length of the cantilever arm 40d. That is, the greater the overall length of the cantilever arm 40d, the less the amount of force required to suitably separate the contact surface 40dea from the contact surface 72ca. Therefore, since the coplanar portions 40da, 40db and 40dc increase the overall length of the arm 40d, the amount of force required to suitably deflect the arm 40d is decreased by the portions 40da, 40db and 40dc. Since less force is required to deflect the arm 40d, the sizes of the cam 54 and the torsion spring 48 may be minimized, thus permitting a more compact arrangement of components within the device 10, and potentially reducing the overall size of the device 10.

Using the coplanar portions 40da, 40db and 40dc of the arm 40d, the above-described increase in the overall length of the arm 40d, and the accompanying decrease in required force, are achieved while maintaining as substantially constant the length of the arm 40d in the longitudinal direction, that is, while not appreciably increasing the length of extension of the arm 40d in a direction that runs parallel to the wall 40c of the receptacle contact 40. As a result, the sizes of the receptacle contact 40 and the middle housing 36 may be minimized, thus permitting a more compact arrangement of components within the device 10, and potentially reducing the overall size of the device 10. Moreover, because the overall length of the arm 40d is increased, relatively thick metal is able to be used to form the receptacle contact 40, including the arm 40d, and the arm 40d is able to be integral with the remainder of the receptacle contact 40, resulting in a cost reduction.

As another result of the forced rotation of the cam 54 by the torsion spring 48, the stepped protrusion 54j of the cam 54 is separated from the end portion 86a of the spring 86, thereby permitting the end portion 86a of the spring 86 to return to its normally biased position against the L-shaped tab 70e of the stationary contact 70, contacting and applying a biasing or reaction force against the L-shaped tab 70e. As result, the spring 86 is electrically coupled to the stationary contact 70 and thus the switch formed by the spring 86 and the stationary contact 70 is closed. The spring bias of the spring 86, which causes the upward movement of the end portion 86a of the spring 86, improves the reliability of the switch formed by the spring 86 and the stationary contact 70, and provides a low-cost switch design.

When the device 10 is in its tripped state, in an exemplary embodiment and as illustrated in FIG. 37, the input line terminals 66a and 66b are electrically coupled to the stationary contacts 70 and 72, respectively. However, the stationary contacts 70 and 72 are electrically decoupled from the movable contacts 78 and 80, respectively, because of the above-described separation between the contact surfaces 78ca and 80ca and the contact surfaces 70cb and 72cb. Moreover, the stationary contacts 70 and 72 are electrically decoupled from the receptacle contacts 38 and 40, respectively, because of the above-described separation between the contact surfaces 38dea and 40dea and the contact surfaces 70ca and 72ca, respectively.

In an exemplary embodiment, after the device 10 is assembled and thus placed in its tripped state in the step 109aa, the device 10 is installed in the step 109ab.

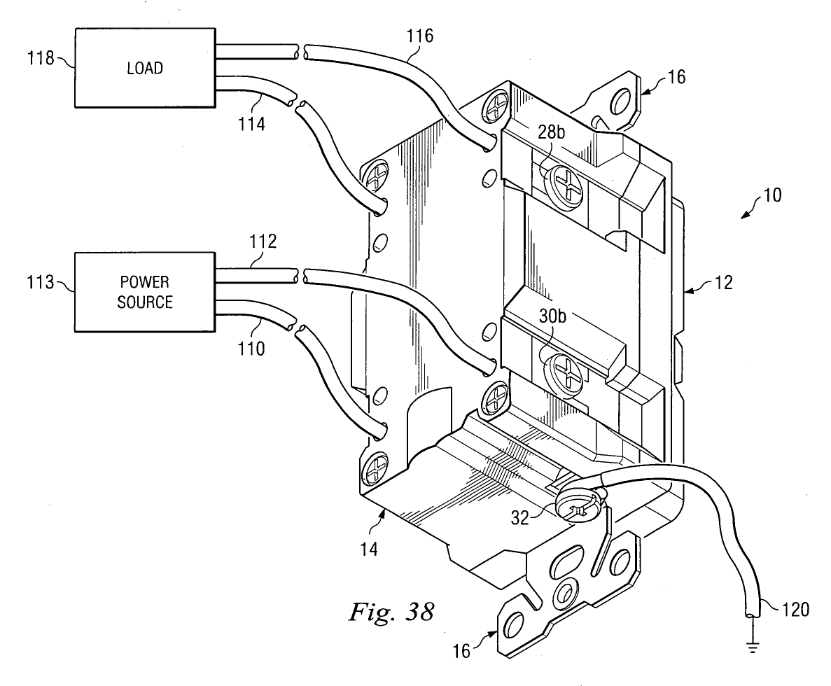

To install the device 10, in an exemplary embodiment and as illustrated in FIG. 38, a hot wire 110 is electrically coupled to the input line terminal 66a, and a neutral wire 112 is electrically coupled to the input line terminal 66b, in a conventional manner using the screws 30a and 30b, respectively, and the terminal plates 68a and 68b, respectively. The wires 110 and 112 are electrically coupled to a source of electrical power 113. A hot wire 114 is electrically coupled to the load-terminal portion 78a of the movable contact 78, and a neutral wire 116 is electrically coupled to the load-terminal portion 80a of the movable contact 80, in conventional manner using the screws 28a and 28b, respectively, and the terminal plates 82 and 84, respectively. The wires 114 and 116 are electrically coupled to a load 118. A ground wire 120 is electrically coupled to the mounting strap 16, in a conventional manner using the screw 32 and the terminal plate 56, and provides a ground path. In several exemplary embodiments, in addition to, or instead of the foregoing, electrical couplings between the device 10 and the wires 110, 112, 114, 116 and 120 may be made in a wide variety of conventional manners.

In an exemplary embodiment, as illustrated in FIG. 38, after the device 10 is installed in the step 109ab, electrical power is supplied to the device 10 in the step 109ac. More particularly, after the above-described electrical couplings are made between the device 10 and the wires 110, 112, 114 and 116, electrical power such as, for example, AC electrical power, is supplied by the source 113 to the device 10 in the step 109ac. In an exemplary embodiment, AC line power is supplied by the source 113 to the device 10, and the circuit 102 is powered, via the wires 110 and 112. However, the wires 114 and 116 do not correspondingly supply electrical power to the load 118 because the device 10 is in its tripped state. That is, the contact surfaces 78ca and 80ca are separated from the contact surfaces 70cb and 72cb, respectively, and thus the stationary contacts 70 and 72 are electrically decoupled from the movable contacts 78 and 80, as described above and illustrated in FIG. 37. Moreover, the receptacle contacts 38 and 40 do not correspondingly supply electrical power to any two-prong or three-prong electrical plug that may be conventionally coupled to the pairs of contacts 38a and 40a, and/or the pairs of contacts 38b and 40b. That is, the contact surfaces 38dea and 40dea are separated from the contact surfaces 70ca and 72ca, respectively, and thus the stationary contacts 70 and 72 are electrically decoupled from the receptacle contacts 38 and 40, respectively, as described above and illustrated in FIG. 37.

As a result of electrical power being supplied to the circuit 102 via the wire 110 and 112 and the input line terminals 66a and 66b, the LED 92 emits light, which travels through the light pipe 22 and is visible through the opening 12b in the housing 12. More particularly, because the switch formed by the spring 86 and the stationary contact 70 is closed, that is, because the end portion 86a is contacting and applying a biasing force against the tab 70e, a sub-circuit of the circuit 102 is completed and the LED 92 emits light, with the sub-circuit including at least the stationary contact 70, the spring 86, conventional circuitry on and/or in the circuit board 60, the LED 92, the diode 90, the cable 88 and the stationary contact 72. The light emitted by the LED 92 provides visual confirmation that the device 10 is in its tripped state.

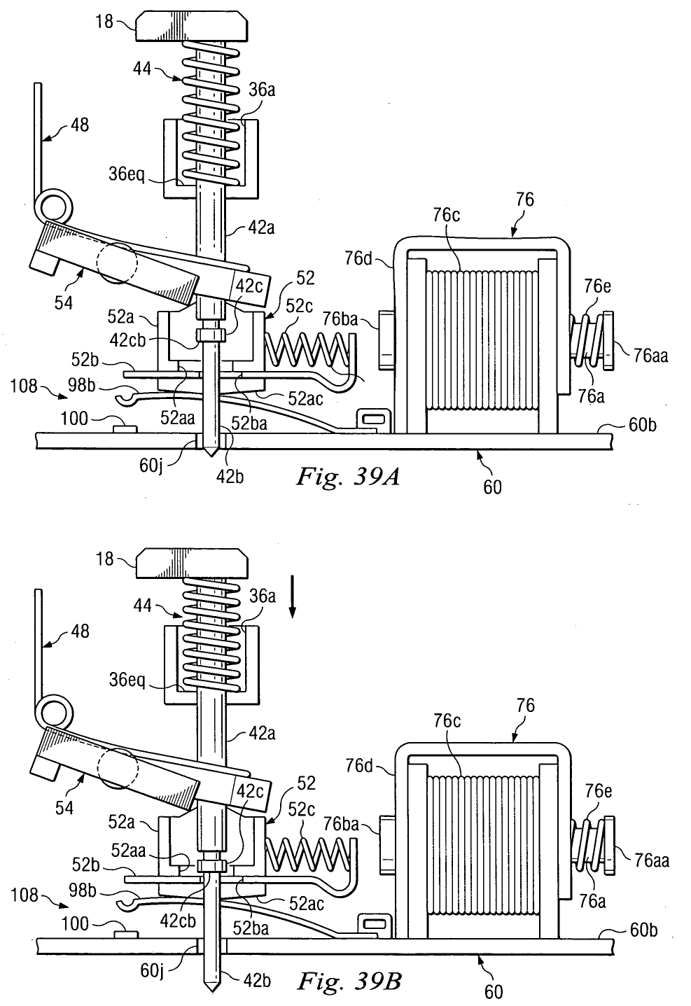

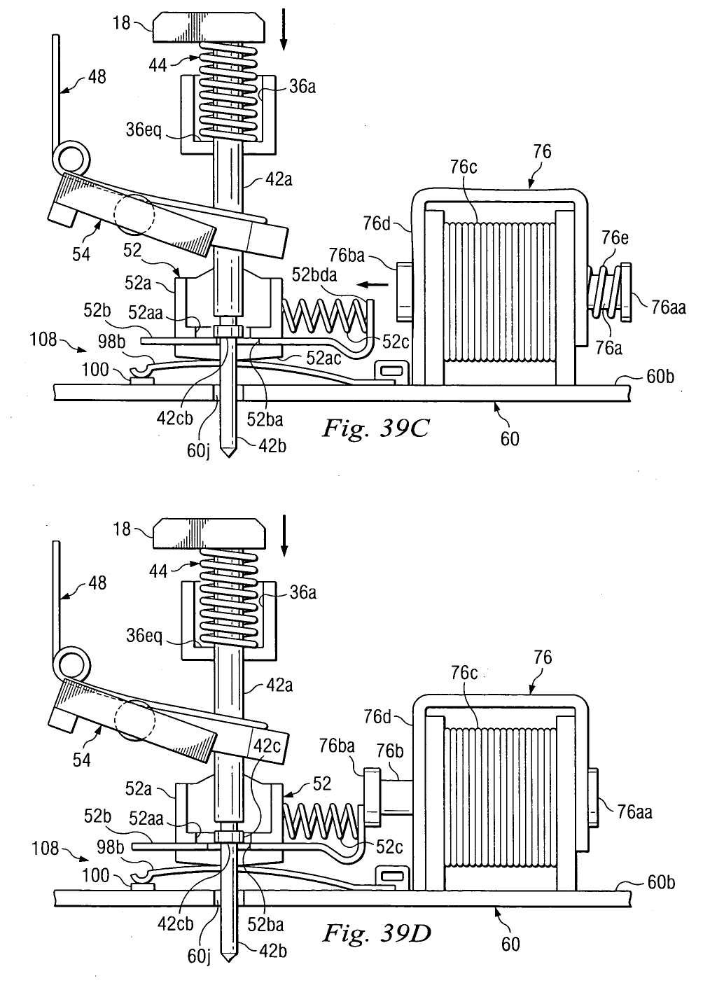

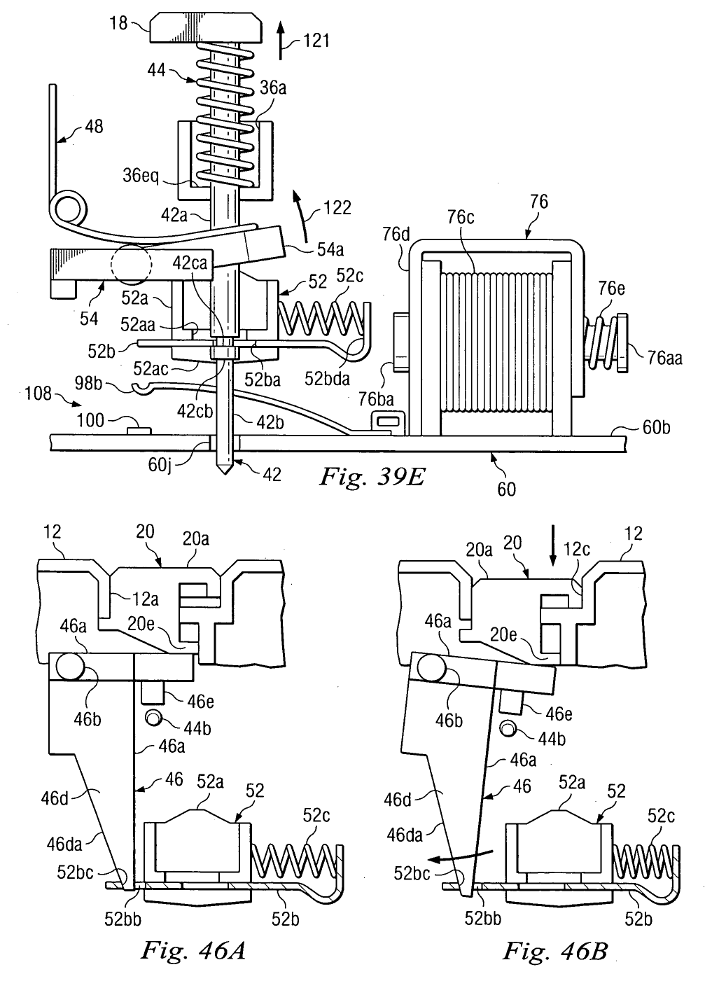

In an exemplary embodiment, after electrical power is supplied to the device 10 in the step 109ac, the state of the device 10 is changed from its tripped state to its reset state in the step 109ad, as illustrated in FIGS. 39A, 39B, 39C, 39D and 39E.

When the device 10 is in its tripped state as illustrated in FIG. 35A, the device 10 is in the same condition as described above with reference to FIG. 37, except that electrical power is now supplied to the device 10 so that the LED 92 emits light, as described above with reference to FIG. 38.

Moreover, when the device 10 is in its tripped state as further illustrated in FIG. 39A, the spring 44 is an extended condition between the internal shoulder 36 eq of the counterbore 36a of the middle housing 36, and the reset button 18, separating the reset button 18 from the counterbore 36a. The flange 42c of the reset shaft 42 is positioned so that the surface 42cb of the flange 42c is above the latch 52b of the latch assembly 52, with the portion of the reduced-diameter portion 42b of the reset shaft 42 below the flange 42c extending through the opening 52aa of the latch block 52a, through the opening 52ba of the latch 52b, and at least partially into an opening 60j in the circuit board 60. The flange 42c is positioned so that at least a portion of the surface 42cb is positioned over the latch 52b, and at least another portion of the surface 42cb is positioned over the opening 52ba of the latch 52b.

The tabs 52ab and 52ac of the latch block 52a of the latch assembly 52 contact the spring arms 98a and 98b, respectively, of the spring bracket 98. As a result, the spring arms 98a and 98b prevent the latch assembly 52 from moving towards the surface 60b of the circuit board 60. The switch 108 is open, that is, the distal end of the spring arm 98b is separated from the contact 100. The spring 76e applies a biasing or reaction force against the enlarged-diameter portion 76aa of the rod 76a, thereby causing the enlarged-diameter end portion 76ba of the plunger 76b to be biased against the end surface 76d of the solenoid assembly 76, and causing the portion 76ba to be separated from the distal end portion 52bd of the latch 52b of the latch assembly 52.

As illustrated in FIG. 39B, to change the state of the device 10 from its tripped state to its reset state, the reset button 18 is moved downward towards the counterbore 36a by, for example, having an operator push the reset button 18 downward, as indicated by the arrow in FIG. 39B. In response, the reset shaft 42 moves downward and the spring 44 begins to compress.

During the downward movement of the reset button 18, at least a portion of the surface 42cb of the flange 42fc approaches and eventually contacts the latch 52b of the latch assembly 52. Subsequent downward movement of the reset button 18 causes the spring 44 to compress further, and causes the surface 42cb to push the latch 52b downward and thus, since the latch 52b contacts the L-shaped tabs 52ab and 52ac, causes the tabs 52ab and 52ac to push the spring arms 98a and 98b, respectively, downward as viewed in FIG. 39B.

As illustrated in FIG. 39C, continued downward movement of the reset button 18, and thus the reset shaft 42, eventually causes the distal end of the spring arm 98b to compress and contact the contact 100, thus closing the switch 108. In response to the closing of the switch 108, the circuit 102 operates to cause a test current to flow to the transformer assembly 62, thereby simulating a ground fault by causing a difference, or an imbalance, between the electrical currents flowing in the contact arms 70f and 72f. Using the transformer coils 62c and 62d of the transformer assembly 62 of the sensing device 104, the circuit 102 senses the difference between the electrical currents in the contact arms 70f and 72f. In response to this sensing by the transformer coils 62c and 62d, the circuit 102 operates the actuator 106 by energizing the solenoid assembly 76 to cause the rod 76a and the plunger 76b to move quickly to the left.

As illustrated in FIG. 39D, during the movement of the rod 76a and the plunger 76b, the spring 76e is compressed and the enlarged-diameter end portion 76ba of the plunger 76b moves away from the end surface 76d, contacting and pushing against the end portion 52bd of the latch 52b. As a result, the spring 52c is compressed between the latch block 52a and the surface 52bda of the latch 52b, and the latch 52b slides to the left, along the tabs 52ab and 52ac, as viewed in FIG. 39D. As a result, the surface 42cb of the flange 42c of the reset shaft 42 is positioned over the opening 52ba of the latch 52b, thereby permitting the reset button 18 and the reset shaft 42 to continue their movement downwards, as indicated by the arrow in FIG. 39D. As another result, and because the surface 42cb of the flange 42c is positioned over the opening 52ba, the spring arm 98b begins to decompress and move upwards, as viewed in FIG. 39D, pushing the latch block 52a upwards, relative to the reset shaft 42, so that the flange 42c is positioned below the latch 52b.

As illustrated in FIG. 39E, continued movement of the spring arm 98b causes the switch 108 to open, that is, causes the distal end of the spring arm 98b to separate from the contact 100. As a result, the circuit 102 no longer operates to cause a test current to flow to the transformer assembly 62 and thus the above-described simulated ground fault ceases. In response, the circuit 102 no longer operates to energize the solenoid assembly 76 and the spring 76e forces the rod 76a and the plunger 76b to move to the right, as viewed in FIG. 39E, so that the end portion 76ba of the plunger 76b is again biased against the end surface 76d of the solenoid assembly 76. In response, the spring 52c of the latch assembly 52 applies a biasing force against the surface 52ba, causing the latch 52b to slide to the right, as viewed in FIG. 39E, so that the latch 52b is positioned between the enlarged-diameter portion 42a and the flange 42c of the reset shaft 42. The surface 42ca of the flange 42c is positioned below the latch 52b, with at least a portion of the surface 42ca being positioned below a surface of the latch 52b and at least another portion of the surface 42ca being positioned below the opening 52ba of the latch 52b.

The reset button 18 is released, causing the downward movement of the reset button 18 and the reset shaft 42 to cease. As a result, the spring 44 immediately decompresses and extends upward, thus pushing the reset button 18 upward, as indicated by an arrow 121 in FIG. 39E. The reset shaft 42 also moves upward so that the surface 42ca contacts the latch 52b, thereby causing the latch assembly 52 to also move upward.

As the latch assembly 52 moves upward, the latch block 52a approaches and contacts the center portion 54a of the cam 54, forcing the cam 54 to rotate in a counterclockwise direction, as viewed in FIG. 39E, and as indicated by an arrow 122, so that the initial biasing force applied by the torsion spring 48 on the cam 54 is overcome. During this rotation, the pins 54e and 54f of the cam 54 rotate in place, about an imaginary axis defined by the axially-aligned respective longitudinal center axes of the pins 54e and 54f. During this rotation, the pins 54e and 54f remain received within the notches 36eo and 36ep, respectively, of the middle housing 36, and within the notches 74ac and 74ad, respectively, of the frame 74. The reset button 18, the shaft 42 and the latch assembly 52 continue to move upwards, and the cam 54 continues to rotate until the reaction or biasing force applied by the torsion spring 48 increases to the point that the cam 54 is no longer able to rotate, thereby preventing any further upward movement of the latch block 52a, thereby preventing any further upward movement of the reset shaft 42 and the reset button 18. As a result, the device 10 is placed in its reset state.

In an exemplary embodiment, the device 10 is unable to be placed in its reset state in the step 109ad if the circuit 102 is nonfunctional, at least with respect to the operation of the solenoid assembly 76 in response to the sensing of the ground fault by the transformer coils 62c and 62d. In an exemplary embodiment, the device 10 is unable to be placed in its reset state in the step 109ad if electrical power is not, or becomes, unavailable to power the circuit 102. In an exemplary embodiment, electrical power may be unavailable as a result of, for example, the wires 110 and 112 being mistakenly electrically coupled to the terminal portions 78a and 80a, respectively, of the movable contacts 78 and 80. This protects against any incorrect electrical coupling between the device 10 and the wires 110, 112, 114 and 116, and prevents the device 10 from supplying electrical power to the load 118 without ground-fault-interrupt protection by the circuit 102 of the device 10.

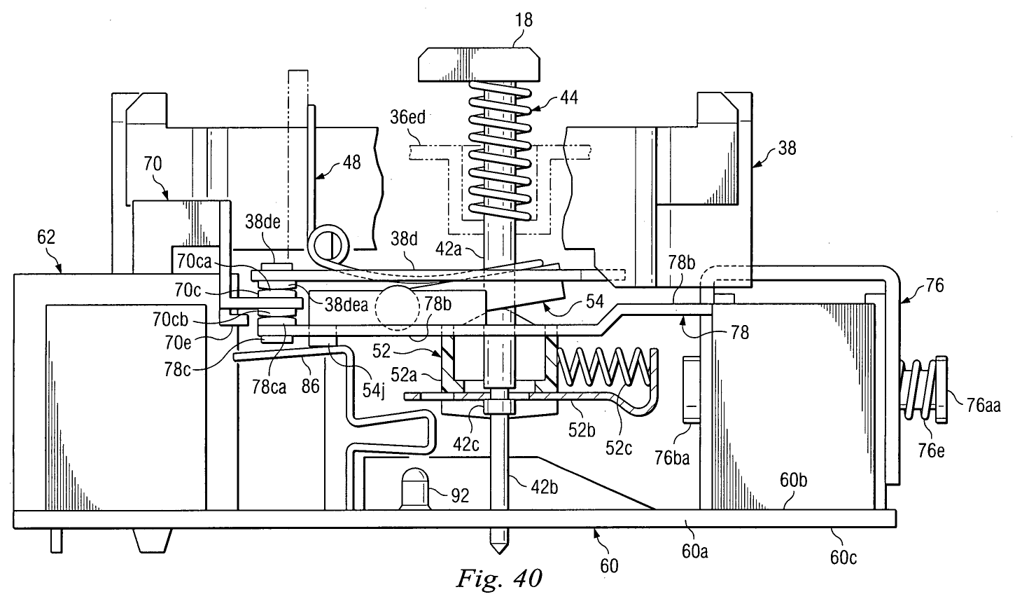

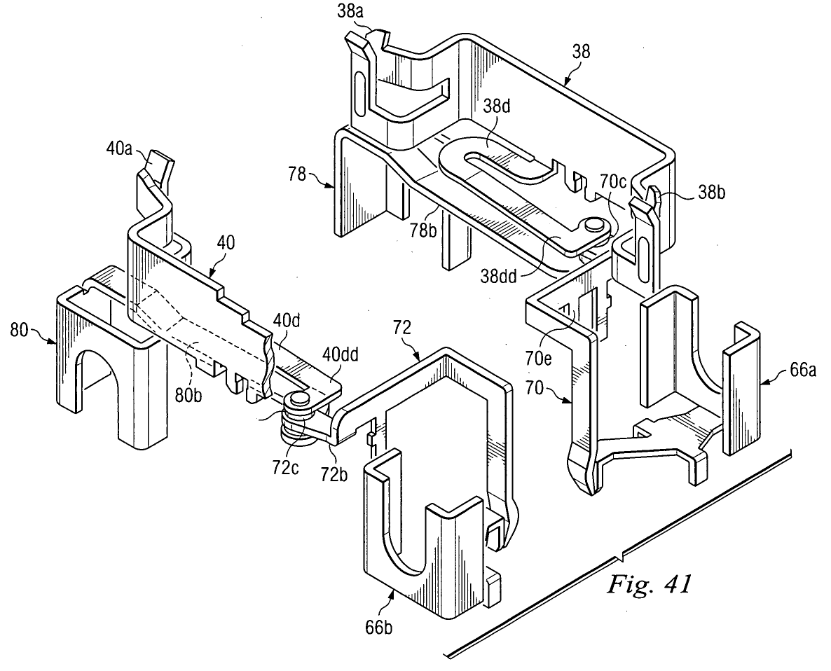

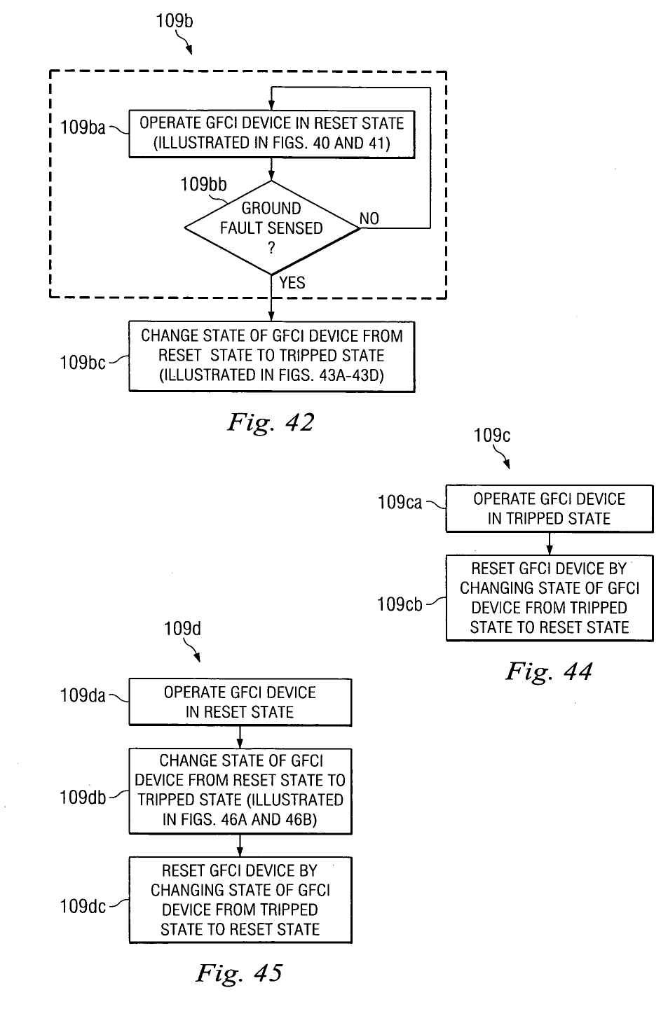

In an exemplary embodiment, as illustrated in FIGS. 40 and 41, when the device 10 is in its reset state and as a result of the forced rotation of the cam 54 by the latch block 52a, the legs 54g and 54h are generally horizontal so that the end knobs 54ga and 54ha of the legs 54g and 54h, respectively, of the cam 54 no longer apply respective forces against the arms 78b and 80b, respectively, of the movable contacts 78 and 80, respectively. As a result, the distal end portion 78ba of the arm 78b is permitted to return to its normally biased position, moving upward so that the contact surface 78ca of the contact 78c of the movable contact 78 contacts the contact surface 70cb of the contact 70c of the stationary contact 70. Also, the distal end portion 80ba of the arm 80b is permitted to return to its normally biased position, moving upward so that the contact surface 80ca of the contact 80c of the movable contact 80 contacts the contact surface 72cb of the contact 72c of the stationary contact 72. The angle 54i of the cam 54 facilitates the ability of the legs 54g and 54h to be generally horizontal when the device 10 is in its reset state.

The respective upward movements of the distal end portions 78ba and 80ba are due to the above-described relative arrangement between the tabs 70b and 72b and the distal end portions 78ba and 80ba, respectively, according to which the arms 78b and 80b are normally flexed downward and therefore are spring biased, normally applying biasing forces against the tabs 70b and 72b, respectively. As a result, the stationary contacts 70 and 72 are no longer electrically isolated from the movable contacts 78 and 80, respectively, and instead are electrically coupled to the movable contacts 78 and 80, respectively.

The spring bias and resulting movement of the arm 78b towards the stationary contact 70, and the subsequent electrical coupling between the movable contact 78 and the stationary contact 70, are independent of the spring bias and resulting movement of the arm 80b towards the stationary contact 72, and the subsequent electrical coupling between the movable contact 80 and the stationary contact 72. This independence improves the reliability of the device 10. Moreover, this independence makes the device 10 easier to build in that a more complex and demanding design, at least with respect to precision, is not necessary in order to ensure an acceptable electrical coupling between the movable contact 78 and the stationary contact 70, and between the movable contact 80 and the stationary contact 72.

As another result of the forced rotation of the cam 54 by the latch block 52a, the end knobs 54gb and 54hb of the legs 54g and 54h, respectively, of the cam 54 no longer apply respective forces against the slanted portions 38dd and 40dd, respectively, of the cantilever arms 38d and 40d, respectively, of the receptacle contacts 38 and 40, respectively.

As a result, the distal end portion of the slanted portion 38dd of the arm 38d is permitted to return to its normally biased position, moving downward so that the contact surface 38dea of the contact 38de of the arm 38d of the receptacle contact 38 contacts the surface 70ca of the contact 70c of the stationary contact 70. Also, the distal end portion of the slanted portion 40dd of the arm 40d is permitted to return to its normally biased position, moving downward so that the contact surface 40dea of the contact 40de of the arm 40d of the receptacle contact 40 contacts the surface 72ca of the contact 72c of the stationary contact 72.

The respective upward movements of the distal end portions of the slanted portions 38dd and 40dd are due to the above-described relative arrangement between the tabs 70b and 72b and the slanted portions 38dd and 40dd, respectively, according to which the slanted portions 38dd and 40dd are normally flexed upward and therefore are spring biased, normally applying biasing forces against the tabs 70b and 72b, respectively. As a result, the stationary contacts 70 and 72 are no longer electrically isolated from the receptacle contacts 38 and 40, respectively, and instead are electrically coupled to the receptacle contacts 38 and 40, respectively.

The spring bias and resulting movement of the slanted portion 38dd towards the stationary contact 70, and the subsequent electrical coupling between the receptacle contact 38 and the stationary contact 70, are independent of the spring bias and resulting movement of the slanted portion 40dd towards the stationary contact 72, and the subsequent electrical coupling between the receptacle contact 40 and the stationary contact 72. This independence improves the reliability of the device 10. Moreover, this independence makes the device 10 easier to build in that a more complex and demanding design, at least with respect to precision, is not necessary in order to ensure acceptable electrical coupling between the receptacle contact 38 and the stationary contact 70, and between the receptacle contact 40 and the stationary contact 72.

As another result of the force rotation of the cam 54 by the latch block 52a, the stepped protrusion 54j of the cam 54 contacts and pushes the end portion 86a of the spring 86 downward so that the end portion 86a is separated from the L-shaped tab 70e of the stationary contact 70. As a result, the spring 86 is electrically decoupled from the stationary contact 70 and thus the switch formed by the spring 86 and the stationary contact 70 is open, thereby causing the LED 92 to cease emitting light. The absence of the emission of light from the LED 92 provides visual confirmation that the device 10 is in its reset state.

When the device 10 is in its reset state, in an exemplary embodiment and as illustrated in FIGS. 40 and 41, the input line terminals 66a and 66b are electrically coupled to the stationary contacts 70 and 72, respectively. Moreover, the stationary contacts 70 and 72 are electrically coupled to the movable contacts 78 and 80, respectively. The stationary contacts 70 and 72 are also electrically coupled to the receptacle contacts 38 and 40, respectively.

In an exemplary embodiment, after the state of the device 10 has been changed from its tripped state to its reset state in the step 109ad, thus completing the initiation of the operation of the device 10 in the step 109a of the method 109, the device 10 is then operated in the step 109b.

In an exemplary embodiment, as illustrated in FIG. 42 with continuing reference to FIGS. 40 and 41, to operate the device 10 in the step 109b of the method 109, the device 10 is operated in its reset state in step 109ba. During the step 109ba, the device 10 remains in the reset state as described above with reference to FIGS. 40 and 41. Electrical power continues to be supplied by the source 113 to the device 10 via the wires 110 and 112, and the circuit 102 is powered. Due to the above-described electrical couplings between the stationary contacts 70 and 72 and the movable contacts 78 and 80, respectively, electrical power is supplied to the load 118 via the wires 114 and 116. Moreover, due to the electrical couplings between the stationary contacts 70 and 72 and the receptacle contacts 38 and 40, respectively, the receptacle contacts 38 and 40 are permitted to supply electrical power to any two-prong or three-prong electrical plug that may be conventionally coupled to the pairs of contacts 38a and 40a, and/or the pairs of contacts 38b and 40b.

During the step 109ba, the device 10 is continually operating to determine whether a ground fault has occurred in step 109bb. If no ground fault is sensed in the step 109bb, the device 10 continues to operate in its reset state in the step 109ba, as described above. If a ground fault is sensed in the step 19bb, the state of the device 10 is changed from its reset state to its tripped state in step 109bc.

More particularly, as electrical power is supplied to the load 118, electrical current flows through the stationary contact 70, the movable contact 78 and the wire 110, and to the load 118. Electrical current also flows from the load 118 and through the wire 112, the movable contact 80 and the stationary contact 72.

Also, as electrical power is supplied to any two-prong or three-prong electrical plug that may be coupled to the pairs of contacts 38a and 40a, and/or the pairs of contacts 38b and 40b, electrical current flows through the stationary contact 70 and the receptacle contact 38 and to the pairs of contacts 38a and/or 38b. Electrical current also flows from the pairs of contacts 38b and/or 40b and through the receptacle contact 40 and the stationary contact 72.

In the step 109bb, a ground fault is not sensed if the electrical current flowing through the stationary contact 70 is approximately equal and opposite to the electrical current flowing through the stationary contact 72.

In the step 109bb, a ground fault is sensed if a difference, or an imbalance, between the respective electrical currents flowing in the stationary contacts 70 and 72 is detected, and the imbalance reaches a predetermined threshold. More particularly, using the transformer coils 62c and 62d of the transformer assembly 62 of the sensing device 104, the circuit 102 senses the difference or imbalance between the electrical currents in the contact arms 70f and 72f of the stationary contacts 70 and 72, respectively. If this difference or imbalance reaches the predetermined threshold, a ground fault is sensed in the step 109bb.

In the step 109bb, a ground fault may be sensed in response to a wide variety of conditions. For example, a short circuit may occur in the load 118 and the path may be to ground instead of to neutral via the wire 112. For another example, a short circuit may occur in a load electrically coupled to any plug coupled to the pairs of contacts 38a and 40a, or to the pairs of contacts 38b and 40b.

As noted above, the state of the device 10 is changed from its reset state to its tripped state in the step 109bc if the presence of a ground fault is sensed by the transformer coils 62c and 62d in the step 109bb.

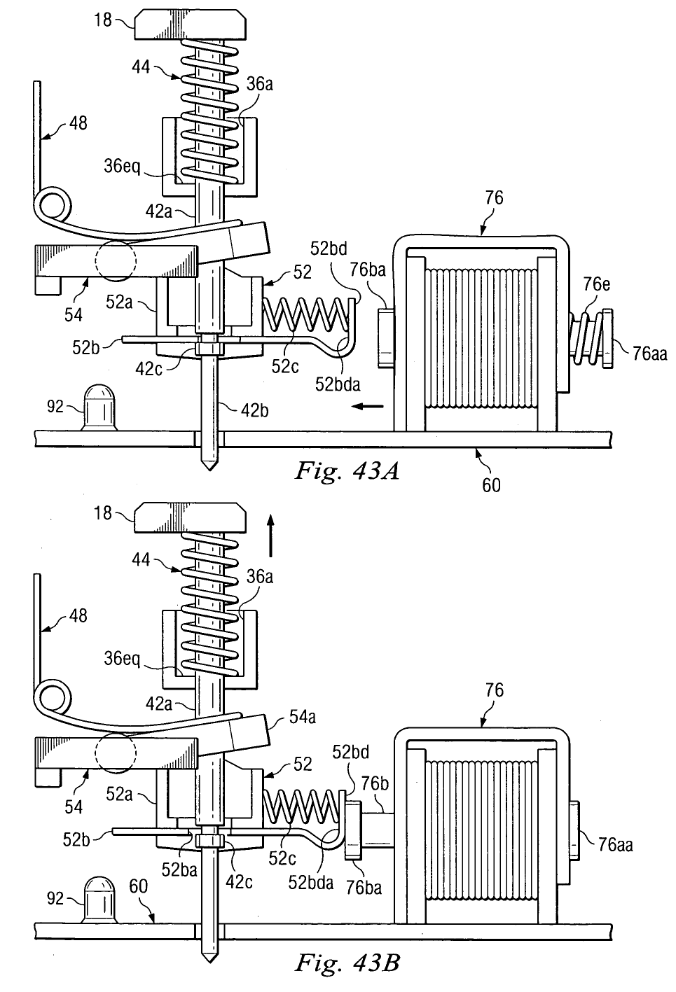

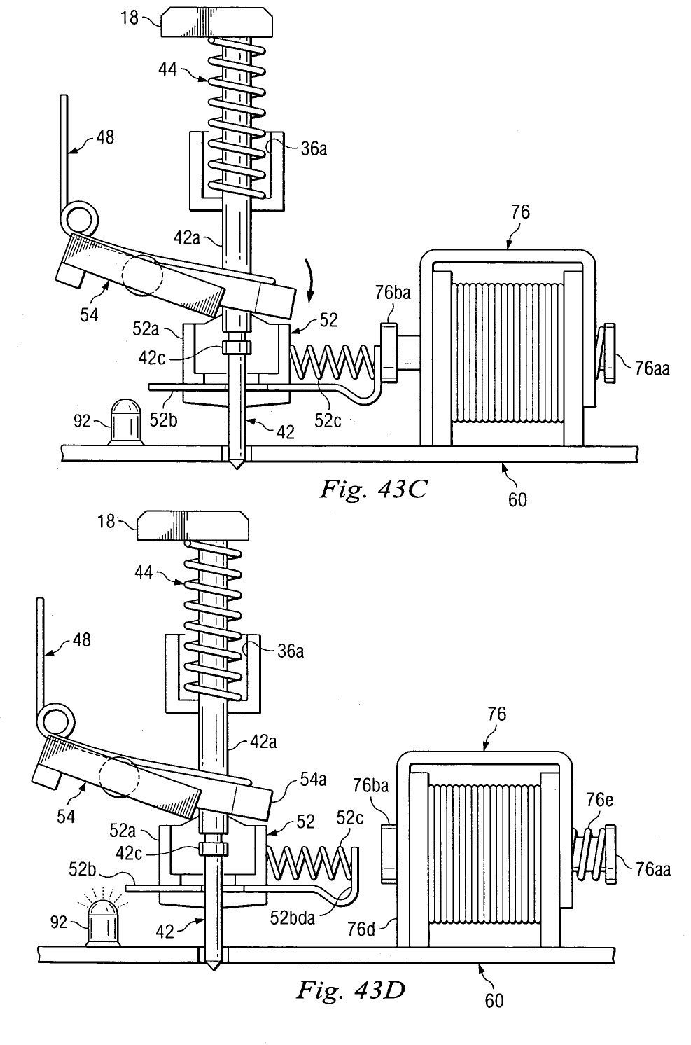

In an exemplary embodiment, as illustrated in FIGS. 43A, 43B, 43C and 43D, to change the state of the device 10 from its reset state to its tripped state in the step 109bc, the circuit 102 operates to energize the solenoid assembly 76, causing the rod 76a and the plunger 76b to move quickly to the left, as indicated by the arrow in FIG. 43A.

In an exemplary embodiment, as illustrated in FIG. 43B, during the movement of the rod 76a and the plunger 76b, the spring 76e is compressed and the enlarged-diameter end portion 76ba of the plunger 76b moves away from the end surface 76d, contacting and pushing against the end portion 52bd of the latch 52b. As a result, the spring 52c is compressed between the latch block 52a and the surface 52bda of the latch 52b, and the latch 52b slides to the left, along the tabs 52ab and 52ac, as viewed in FIG. 43B. As a result, the flange 42c of the reset shaft 42 is positioned below the opening 52ba of the latch 52b without any portion of the flange 42c being positioned below a surface defined by the latch 52b, thereby permitting the spring 44 to further decompress and extend upwards. As a result, the reset shaft 42 and the reset button 18 move upwards, as indicated by the arrow in FIG. 43B.

In an exemplary embodiment, as illustrated in FIG. 43C, as a result of the upward movement of the reset shaft 42, the flange 42c of the reset shaft 42 is positioned above the latch 52b. Due to the position of the flange 42c, the latch block 52a no longer appreciably resists the biasing force applied on the cam 54 by the torsion spring 48. Thus, the torsion spring 48 causes the cam 54 to rotate in a clockwise direction as viewed in FIG. 43C, and as indicated by the arrow in FIG. 43C. The torsion spring 48 forces the cam 54 to rotate until the center portion 54a of the cam 54 contacts the walls 74ae and 74af of the frame 74, at which point the cam 54 ceases to rotate.

As a result of the forced rotation of the cam 54 by the torsion spring 48, the end knobs 54ga and 54ha of the legs 54g and 54h, respectively, of the cam 54 apply respective forces against the arms 78b and 80b, respectively, of the movable contacts 78 and 80, respectively, thereby pushing the arms 78b and 80b downward as viewed in FIG. 37. As a result, the contact surface 78ca of the contact 78c of the movable contact 78 is separated from the contact surface 70cb of the contact 70c of the stationary contact 70, and the contact surface 80ca of the contact 80c of the movable contact 80 is separated from the contact surface 72cb of the contact 72c of the stationary contact 72. As a result of this separation, there is no electrical coupling between the contact surfaces 78ca and 70cb, and between the contact surfaces 80ca and 72cb, and thus the movable contacts 78 and 80 are electrically isolated from the stationary contacts 70 and 72, respectively.

As another result of the forced rotation of the cam 54 by the torsion spring 48, the end knobs 54gb and 54hb of the legs 54g and 54h, respectively, of the cam 54 at least partially extend into the openings 36n and 36o, respectively, of the middle housing 36, and apply forces against the slanted portions 38dd and 40dd, respectively, of the cantilever arms 38d and 40d, respectively, of the receptacle contacts 38 and 40, respectively, thereby pushing the slanted portions 38dd and 40dd upward as viewed in FIG. 37. As a result, the contact surface 38dea of the contact 38de of the arm 38d is separated from the contact surface 70ca of the contact 70c of the stationary contact 70, and the contact surface 40dea of the contact 40de of the arm 40d is separated from the contact surface 72ca of the contact 72c of the stationary contact 72. As a result of this separation, there is no electrical coupling between the contact surfaces 38dea and 70ca, and between the contact surface 40dea and 72ca, and thus the receptacle contacts 38 and 40 are electrically isolated from the stationary contacts 70 and 72, respectively.

As described above, as a result of the rotation of the cam 54, the stationary contacts 70 and 72 are each independently electrically decoupled from the movable contacts 78 and 80, respectively, because of the above-described separation between the contact surfaces 78ca and 80ca and the contact surfaces 70cb and 72cb. Moreover, the stationary contacts 70 and 72 are each independently electrically decoupled from the receptacle contacts 38 and 40, respectively, because of the above-described separation between the contact surfaces 38dea and 40dea and the contact surfaces 70ca and 72ca, respectively.

In an exemplary embodiment, as illustrated in FIG. 43D, and as a result of the movable contacts 78 and 80 being electrically decoupled from the stationary contacts 70 and 72, respectively, and the receptacle contacts 38 and 40 being electrically decoupled from the stationary contacts 70 and 72, respectively, electrical current no longer flows through the contact arms 70f and 72f of the stationary contacts 70 and 72, respectively. As a result, the transformer coils 62c and 62d of the transformer assembly 62 of the sensing device 104 no longer sense a ground fault and thus the solenoid assembly 76 is de-energized, causing the spring 76e to force the rod 76a and the plunger 76b to move to the right, as viewed in FIG. 43D, so that the end portion 76ba of the plunger 76b is again biased against the end surface 76d of the solenoid assembly 76. In response, the spring 52c of the latch assembly 52 applies a biasing force against the surface 52bda, causing the latch 52b to slide to the right, as viewed in FIG. 43D, so that the surface 42cb of the flange 42c is positioned above the latch 52b, with at least a portion of the surface 42cb being positioned above a surface of the latch 52b and at least another of the surface 42cb being positioned above the opening 52ba of the latch 52b.

Also, as another result of the forced rotation of the cam 54 by the torsion spring 48, the stepped protrusion 54j of the cam 54 is separated from the end portion 86a of the spring 86, thereby permitting the end portion 86a of the spring 86 to return to its normally biased position against the L-shaped tab 70e of the stationary contact 70, contacting and applying a biasing or reaction force against the L-shaped tab 70e. As a result, the spring 86 is electrically coupled to the stationary contact 70 and thus the switch formed by the spring 86 and the stationary contact 70 is closed, causing the LED 92 to emit light, as indicated in FIG. 39D. The emitted light travels through the light pipe 22 and is visible through the opening 12b in the housing 12. The light emitted by the LED 92 provides visual confirmation that the device 10 is in its tripped state. The spring bias of the spring 86, which causes the upward movement of the end portion 86a of the spring 86, improves the reliability of the switch formed by the spring 86 and the stationary contact 70, and provides a low-cost switch design.

When the device 10 is in its tripped state as illustrated in FIG. 43D, the device 10 is in the same condition as described above with reference to FIG. 39A, and is in the same condition as described above with reference to FIG. 37, except that the LED 92 emits light, as described above.

In an exemplary embodiment, and as noted above, if the state of the device 10 is changed from its reset state to its tripped state during the operation of the device 10 in the step 109b, then the device 10 is reset in the step 109c of the method 109.

In an exemplary embodiment, in the step 109c and as illustrated in FIG. 44, the device 10 first operates in its tripped state in step 109ca. More particularly, the LED 92 emits light, and electrical power is supplied by the source 113 to the device 10, and thus to the circuit 102, via the wires 110 and 112. However, the wires 114 and 116 do not correspondingly supply electrical power to the load 118 because the device 10 is in its tripped state. That is, the contact surfaces 78ca and 80ca are separated from the contact surfaces 70cb and 72cb, respectively, and thus the stationary contacts 70 and 72 are electrically decoupled from the movable contacts 78 and 80, as described above and illustrated in FIG. 37. Moreover, the receptacle contacts 38 and 40 do not correspondingly supply electrical power to any two-prong or three-prong electrical plug that may be coupled to the pairs of contacts 38a and 40a, and/or to the pairs of contacts 38b and 40b. That is, the contact surfaces 38dea and 40dea are separated from the contact surfaces 70ca and 72ca, respectively, and thus the stationary contacts 70 and 72 are electrically decoupled from the receptacle contacts 38 and 40, respectively, as described above and illustrated in FIG. 37.

In the step 109c, the device 10 is operated in its tripped state in the step 109ca and then, in step 109cb, the device 10 is reset by changing the state of the device 10 from its tripped state to its reset state. The changing of the state of the device 10 from its tripped state to its reset state in the step 109cb is substantially identical to the changing of the state of the device 10 from its tripped state to its reset state in the step 109ad, as described above and illustrated in FIGS. 39A, 39B, 39C, 39D and 39E, and therefore the step 109cb will not be described in detail.

In an exemplary embodiment, the device 10 is unable to be placed in its reset state in the step 109cb if the circuit 102 is nonfunctional, at least with respect to the operation of the solenoid assembly 76 in response to the sensing of the ground fault by the transformer coils 62c and 62d.

In an exemplary embodiment, the device 10 is unable to be placed in its reset state in the step 109cb if electrical power is not, or becomes, unavailable to power the circuit 102. In an exemplary embodiment, electrical power may be unavailable as a result of, for example, the wires 110 and 112 being mistakenly electrically coupled to the terminal portions 78a and 80a, respectively, of the movable contacts 78 and 80. This protects against any incorrect electrical coupling between the device 10 and the wires 110, 112, 114 and 116, and prevents the device 10 from supplying electrical power to the load 118 without ground-fault-interrupt protection by the circuit 102 of the device 10.

In an exemplary embodiment, and as noted above, the method 109 also includes optionally testing the device 10 in the step 109d.

In an exemplary embodiment, as illustrated in FIG. 45, optionally testing the device 10 in the step 109d includes operating the device 10 in its reset state in step 109da, changing the state of the device 10 from its reset state to its tripped state in step 109db, and resetting the device 10 in step 109dc.

In an exemplary embodiment, operating the device 10 in its reset state in the step 109da is substantially identical to operating the device 10 in its reset state in the step 109ba of the step 109b of the method 109, as described above and illustrated in FIGS. 36 and 37, and therefore the step 109da will not be described in detail.

In an exemplary embodiment, as illustrated in FIG. 46A, when the device 10 is in its reset state in the step 109ba, the protrusion 46d of the actuator 46 extends downward between the walls 36eb and 36ec of the middle housing 36, between the opposing legs of the U-shaped portion 48c of the torsion spring 48, and into the opening 52bb so that at least the distal end of the protrusion 46d is at least partially positioned in the opening 52bb, as described above. The protrusion 46e extends downward into the region 36m, and contacts the leg 44b of the spring 44. The protrusion 20e of the test button 20 is supported by the planar portion 46a of the actuator 46. As noted above, the test button 20 is captured within the opening 12a of the top housing 12, and is permitted to move up and down over a limited range of vertical movement.

In an exemplary embodiment, as illustrated in FIG. 46B, to change the state of the device 10 from its reset state to its tripped state in the step 109db, the top surface of the protrusion 20a of the test button 20 is pressed downward, as viewed in FIG. 46B. As a result, the protrusion 20e of the test button pushes at least a portion of the planar portion 46a downward, causing the actuator 46 to rotate in place in a clockwise direction as viewed in FIG. 46B, with the tabs 46b and 46c rotating in place in the notches 36ee and 36da, respectively, of the middle housing 36. As a result of the rotation of the actuator 46, the slanted surface 46da of the protrusion 46d applies a force against the surface 52bc, causing the latch 52b of the latch assembly 52 to slide to the left, as viewed in FIG. 46B. Therefore, instead of the transformer coils 62c and 62d sensing a ground fault to energize the solenoid assembly 76 to slide the latch 52b to the left, the latch 52b is slid to the left by the operation of the actuator 46, as viewed in FIG. 46B.

As a result of the latch 52b sliding to the left as viewed in FIG. 46B, the state of the device 10 is changed from its reset state to its tripped state in a manner substantially similar to the manner described above in connection with the step 109bc, and as illustrated in FIGS. 43A, 43B, 43C and 43D, and therefore will not be described in detail, except that the plunger 76b of the solenoid assembly 76 remains stationary throughout the step 109db, with the solenoid assembly 76 being neither energized nor de-energized during the step 109db. That is, instead of the solenoid assembly 76 being energized in order to slide the latch 52b to the left, as viewed in FIG. 46B, the actuator 46 rotates in order to slide the latch 52b to the left, as described above. And instead of the solenoid assembly 76 being de-energized in order for the spring 52c to cause the latch 52b to slide to the right, as viewed in FIG. 46B, the test button 20 is released, thereby permitting the arm 44b of the spring 44 to rotate the actuator 46 in place in a counterclockwise direction as viewed in FIG. 46B, which, in turn, causes the slanted surface 46da of the protrusion 46 to cease applying a force against the surface 52bc of the latch 52b, thereby permitting the spring 52c to cause the latch 52b to slide to the right.

In an exemplary embodiment, as noted above, after the state of the device 10 is changed from its reset state to its tripped state in the step 109db, the device 10 is reset in the step 109dc. To reset the device 10 in the step 109dc, the state of the device 10 is changed from its tripped state to its reset state. The changing of the state of the device 10 from its tripped state to its reset state in the step 109dc is substantially identical to the changing of the state of the device 10 from its tripped state to its reset state in the step 109ad, as described above and illustrated in FIGS. 39A, 39B, 39C, 39D and 39E. Therefore, the step 109dc will not be described in detail.

In an exemplary embodiment, the device 10 is unable to be placed in its reset state in the step 109dc if the circuit 102 is nonfunctional, at least with respect to the operation of the solenoid assembly 76 in response to the sensing of the ground fault by the transformer coils 62c and 62d. In an exemplary embodiment, the device 10 is unable to be placed in its reset state in the step 109dc if electrical power is not, or becomes, unavailable to power the circuit 102. In an exemplary embodiment, electrical power may be unavailable as a result of, for example, the wires 110 and 112 being mistakenly electrically coupled to the terminal portions 78a and 80a, respectively, of the movable contacts 78 and 80. This protects against any incorrect electrical coupling between the device 10 and the wires 110, 112, 114 and 116, and prevents the device 10 from supplying electrical power to the load 118 without ground-fault-interrupt protection by the circuit 102 of the device 10.

After resetting the device 10 in the step 109dc, the testing of the device 10 in the step 109d of the method 109 is completed. If the device 10 is successfully reset in the step 109dc, as described above, then the testing of the device 10 in the step 109d is successful.

A device has been described that includes a first stationary contact; a first movable arm adapted to be controllably electrically coupled to the first stationary contact; and a cam adapted to rotate in place and positioned, relative to the first movable arm, so that at least a portion of the first movable arm moves, relative to the first stationary contact, in response to the rotation of the cam. In an exemplary embodiment, the device comprises a second movable arm adapted to be controllably electrically coupled to the first stationary contact; wherein the cam is positioned, relative to the first and second movable arms, so that at least portions of the first and second movable arms move, relative to the first stationary contact, in response to the rotation of the cam. In an exemplary embodiment, the cam and the first and second movable arms are positioned so that the at least portions of the first and second movable arms move away from the first stationary contact in response to the rotation of the cam in a first direction. In an exemplary embodiment, the cam and the first and second movable arms are positioned so that the at least portions of the first and second arms move towards the first stationary contact in response to the rotation of the cam in a second direction. In an exemplary embodiment, the first and second movable arms are electrically decoupled from the first stationary contact in response to the rotation of the cam in a first direction. In an exemplary embodiment, the first and second movable arms are electrically coupled to the first stationary contact in response to the rotation of the cam in a second direction. In an exemplary embodiment, the cam and the first and second movable arms are positioned so that the at least portions of the first and second movable arms move away from the first stationary contact in opposite directions in response to the rotation of the cam in a first direction. In an exemplary embodiment, the cam and the first and second movable arms are positioned so that the at least portions of the first and second arms move towards the first stationary contact and towards each other in response to the rotation of the cam in a second direction. In an exemplary embodiment, the device comprises a second stationary contact; and third and fourth movable arms adapted to be controllably electrically coupled to the second stationary contact; wherein at least portions of the third and fourth movable arms move, relative to the second stationary contact, in response to the rotation of the cam. In an exemplary embodiment, the cam and the first, second, third and fourth movable arms are positioned so that the at least portions of the first and second movable arms move away from the first stationary contact in response to the rotation of the cam in a first direction; and the at least portions of the third and fourth movable arms move away from the second stationary contact in response to the rotation of the cam in the first direction. In an exemplary embodiment, the cam and the first, second, third and fourth movable arms are positioned so that the at least portions of the first and second arms move towards the first stationary contact in response to the rotation of the cam in a second direction; and the at least portions of the third and fourth arms move towards the second stationary contact in response to the rotation of the cam in the second direction. In an exemplary embodiment, the first and second movable arms are electrically decoupled from the first stationary contact in response to the rotation of the cam in a first direction; and wherein the third and fourth movable arms are electrically decoupled from the second stationary contact in response to the rotation of the cam in the first direction. In an exemplary embodiment, the first and second movable arms are electrically coupled to the first stationary contact in response to the rotation of the cam in a second direction; and wherein the third and fourth movable arms are electrically coupled to the second stationary contact in the response to the rotation of the cam in the second direction. In an exemplary embodiment, the cam and the first, second, third and fourth movable arms are positioned so that the at least portions of the first and second movable arms move away from the first stationary contact in opposite directions in response to the rotation of the cam in a first direction; and the at least portions of the third and fourth movable arms move away from the second stationary contact in opposite directions in response to the rotation of the cam in the first direction. In an exemplary embodiment, the cam and the first, second, third and fourth movable arms are positioned so that the at least portions of the first and second arms move towards the first stationary contact and towards each other in response to the rotation of the cam in a second direction; and the at least portions of the third and fourth arms move towards the second stationary contact and towards each other in response to the rotation of the cam in the second direction. In an exemplary embodiment, the device comprises a sensing device operably coupled to the first and second stationary contacts wherein the sensing device is adapted to sense an imbalance between respective electrical currents in the first and second stationary contacts. In an exemplary embodiment, an actuator operably coupled to the sensing device; wherein the actuator is adapted to actuate in response to the sensing of the imbalance by the sensing device; and wherein the cam rotates in place in response to the actuation of the actuator. In an exemplary embodiment, the sensing device comprises a transformer assembly and the actuator comprises a solenoid assembly. In an exemplary embodiment, the device is a ground fault circuit interrupter device and is adapted to supply electrical power to a load. In an exemplary embodiment, the device is adapted to supply electrical power to the load when the load is electrically coupled to the first and third movable arms; the first movable arm is electrically coupled to the first stationary contact; and the third movable arm is electrically coupled to the second stationary contact. In an exemplary embodiment, the cam comprises a center portion; and first and second legs coupled to the center portion and spaced in a parallel relation, one of the first and second legs being adapted to contact the first movable arm; wherein an angle is defined between the center portion and the first and second legs. In an exemplary embodiment, the first movable arm is spring biased towards the first stationary contact; and wherein a first configuration in which the one of the first and second legs contacts the first movable arm and is positioned so that the one of the first and second legs resists the spring bias of the first movable arm, and the at least a portion of the first movable arm is electrically decoupled from the first stationary contact; and a second configuration in which the one of the first and second legs is positioned so that the first movable arm is permitted to be electrically coupled to the first stationary contact in response to its own spring bias. In an exemplary embodiment, the cam further comprises axially-aligned first and second pins extending between the center portion and the first and second legs, respectively; wherein an axis is defined by the respective longitudinal center axes of the axially-aligned first and second pins; and wherein the cam is adapted to rotate in place about the axis. In an exemplary embodiment, a switch, the switch comprises the first stationary contact; and a spring, a distal end portion of which is spring biased towards the first stationary contact; wherein the switch comprises an open configuration in which the distal end portion is separated from the first stationary contact and a closed configuration in which the distal end portion contacts the first stationary contact. In an exemplary embodiment, the switch is placed in the open configuration in response to the rotation of the cam in a first direction; and wherein the switch is placed in the closed configuration in response to the rotation of the cam in a second direction. In an exemplary embodiment, the device further comprises a light-emitting diode electrically coupled to the switch, wherein the diode is adapted to emit light when the switch is in the closed configuration. In an exemplary embodiment, the cam further comprises a protrusion extending from one of the first and second legs; wherein the protrusion is adapted to contact and separate the distal end portion of the spring from the first stationary contact, thereby placing the switch in the open configuration, in response to the rotation of the cam in the first direction.

A method has been described that includes providing a first stationary contact and a first movable arm adapted to be controllably electrically coupled thereto; rotating a cam in a first direction; and electrically decoupling the first movable arm from the first stationary contact in response to rotating the cam in the first direction. In an exemplary embodiment, the method comprises rotating the cam in a second direction; and electrically coupling the first movable arm to the first stationary contact in response to rotating the cam in the second direction. In an exemplary embodiment, the method comprises sensing the presence of a ground fault; wherein rotating the cam in the first direction comprises rotating the cam in the first direction in response to sensing the presence of the ground fault. In an exemplary embodiment, rotating the cam in the second direction comprises rotating the cam in the second direction after rotating the cam in the first direction in response to sensing the presence of the ground fault. In an exemplary embodiment, the method comprises providing a second stationary contact and a second movable arm adapted to be controllably electrically coupled to the second stationary contact; electrically decoupling the second movable arm from the second stationary contact in response to rotating the cam in the first direction. In an exemplary embodiment, the method comprises rotating the cam in a second direction; electrically coupling the first movable arm to the first stationary contact in response to rotating the cam in the second direction; and electrically coupling the second movable arm to the second stationary contact in response to rotating the cam in the second direction. In an exemplary embodiment, the method comprises sensing the presence of a ground fault; wherein rotating the cam in the first direction comprises rotating the cam in the first direction in response to sensing the presence of the ground fault so that the first and second movable arms are electrically decoupled from the first and second stationary contacts, respectively. In an exemplary embodiment, rotating the cam in the second direction comprises rotating the cam in the second direction, after rotating the cam in the first direction in response to sensing the presence of the ground fault, so that the first and second movable arms are electrically coupled to the first and second stationary contacts, respectively. In an exemplary embodiment, the method comprises electrically coupling a load to the first and second movable arms; supplying electrical power to the load via the first and second movable arms; and stopping the supply of electrical power to the load via the first and second movable arms in response to rotating the cam in the first direction in response to sensing the presence of the ground fault. In an exemplary embodiment, the method comprises emitting light in response to sensing the ground fault, comprising closing a switch in response to rotating the cam in the first direction in response to sensing the ground fault.

A method of operating a device has been described that includes a cam, the method comprising electrically coupling a load to the device; supplying electrical power to the load via the device; sensing whether a ground fault is present or absent using the device; and if the ground fault is present, stopping the supply of electrical power to the load; wherein stopping the supply of electrical power to the load comprises rotating the cam in a first direction. In an exemplary embodiment, the method comprises resuming the supply of electrical power to the load after stopping the supply of electrical power to the load; wherein resuming the supply of electrical power to the load comprises rotating the cam in a second direction. In an exemplary embodiment, the method comprises emitting light in response to rotating the cam in the first direction. In an exemplary embodiment, the method comprises testing the device. In an exemplary embodiment, testing the device comprises rotating the cam in the first direction to stop the supply of electrical power to the load; and rotating the cam in a second direction to resume the supply of electrical power to the load. In an exemplary embodiment, testing the device further comprises emitting light in response to rotating the cam in the first direction to stop the supply of electrical power to the load; and stopping the emission of light in response to rotating the cam in the second direction to resume the supply of electrical power to the load.

A system has been described that includes means for providing a first stationary contact and a first movable arm adapted to be controllably electrically coupled thereto; means for rotating a cam in a first direction; and means for electrically decoupling the first movable arm from the first stationary contact in response to rotating the cam in the first direction. In an exemplary embodiment, the system comprises means for rotating the cam in a second direction; and means for electrically coupling the first movable arm to the first stationary contact in response to rotating the cam in the second direction. In an exemplary embodiment, the system comprises means for sensing the presence of a ground fault; wherein means for rotating the cam in the first direction comprises means for rotating the cam in the first direction in response to sensing the presence of the ground fault. In an exemplary embodiment, means for rotating the cam in the second direction comprises means for rotating the cam in the second direction after rotating the cam in the first direction in response to sensing the presence of the ground fault. In an exemplary embodiment, the system comprises means for providing a second stationary contact and a second movable arm adapted to be controllably electrically coupled to the second stationary contact; means for electrically decoupling the second movable arm from the second stationary contact in response to rotating the cam in the first direction. In an exemplary embodiment, the system comprises means for rotating the cam in a second direction; means for electrically coupling the first movable arm to the first stationary contact in response to rotating the cam in the second direction; and means for electrically coupling the second movable arm to the second stationary contact in response to rotating the cam in the second direction. In an exemplary embodiment, the system comprises means for sensing the presence of a ground fault; wherein means for rotating the cam in the first direction comprises means for rotating the cam in the first direction in response to sensing the presence of the ground fault so that the first and second movable arms are electrically decoupled from the first and second stationary contacts, respectively. In an exemplary embodiment, means for rotating the cam in the second direction comprises means for rotating the cam in the second direction, after rotating the cam in the first direction in response to sensing the presence of the ground fault, so that the first and second movable arms are electrically coupled to the first and second stationary contacts, respectively. In an exemplary embodiment, the system comprises means for electrically coupling a load to the first and second movable arms; means for supplying electrical power to the load via the first and second movable arms; and means for stopping the supply of electrical power to the load via the first and second movable arms in response to rotating the cam in the first direction in response to sensing the presence of the ground fault. In an exemplary embodiment, the system comprises means for emitting light in response to sensing the ground fault, comprising means for closing a switch in response to rotating the cam in the first direction in response to sensing the ground fault.

A system for operating a device comprising a cam has been described that includes means for electrically coupling a load to the device; means for supplying electrical power to the load via the device; means for sensing whether a ground fault is present or absent using the device; and means for if the ground fault is present, stopping the supply of electrical power to the load, comprising means for rotating the cam in a first direction. In an exemplary embodiment, the system comprises means for resuming the supply of electrical power to the load after stopping the supply of electrical power to the load, comprising means for rotating the cam in a second direction. In an exemplary embodiment, the system comprises means for emitting light in response to rotating the cam in the first direction. In an exemplary embodiment, the system comprises means for testing the device. In an exemplary embodiment, means for testing the device comprises means for rotating the cam in the first direction to stop the supply of electrical power to the load; and means for rotating the cam in a second direction to resume the supply of electrical power to the load. In an exemplary embodiment, means for testing the device further comprises means for emitting light in response to rotating the cam in the first direction to stop the supply of electrical power to the load; and means for stopping the emission of light in response to rotating the cam in the second direction to resume the supply of electrical power to the load.

A method of operating a device comprising a cam, first and second stationary contacts, and first and second movable arms adapted to be controllably electrically coupled to the first and second stationary contacts, respectively, has been described that includes electrically coupling the first movable arm to the first stationary contact; electrically coupling the second movable arm to the second stationary contact; electrically coupling a load to the first and second movable arms; supplying electrical power to the load via the first and second stationary contacts and the first and second movable arms; sensing whether a ground fault is present or absent using the device; and if the ground fault is present, stopping the supply of electrical power to the load; wherein stopping the supply of electrical power to the load comprises rotating the cam in a first direction; electrically decoupling the first movable arm from the first stationary contact in response to rotating the cam in the first direction; and electrically decoupling the second movable arm from the second stationary contact in response to rotating the cam in the first direction; wherein the method further comprises resuming the supply of electrical power to the load after stopping the supply of electrical power to the load; wherein resuming the supply of electrical power to the load comprises rotating the cam in a second direction; electrically coupling the first movable arm to the first stationary contact in response to rotating the cam in the second direction; and electrically coupling the second movable arm to the second stationary contact in response to rotating the cam in the second direction; and wherein the method further comprises if the ground fault is present, emitting light in response to rotating the cam in the first direction, comprising closing a switch in response rotating the cam in the first direction; and testing the device, comprising rotating the cam in the first direction to stop the supply of electrical power to the load; and rotating the cam in a second direction to resume the supply of electrical power to the load; emitting light in response to rotating the cam in the first direction to stop the supply of electrical power to the load; and stopping the emission of light in response to rotating the cam in the second direction to resume the supply of electrical power to the load.

A ground fault circuit interrupter device has been described that includes first and second stationary contacts; first and second movable arms adapted to be controllably electrically coupled to the first stationary contact; third and fourth movable arms adapted to be controllably electrically coupled to the second stationary contact; and a cam adapted to rotate in place and positioned, relative to the first and second movable arms, so that least portions of the first and second movable arms move, relative to the first stationary contact, in response to the rotation of the cam; wherein at least portions of the third and fourth movable arms move, relative to the second stationary contact, in response to the rotation of the cam; wherein the cam and the first, second, third and fourth movable arms are positioned so that the at least portions of the first and second movable arms move away from the first stationary contact in opposite directions in response to the rotation of the cam in a first direction; the at least portions of the third and fourth movable arms move away from the second stationary contact in opposite directions in response to the rotation of the cam in the first direction; the at least portions of the first and second arms move towards the first stationary contact and towards each other in response to the rotation of the cam in a second direction; and the at least portions of the third and fourth arms move towards the second stationary contact and towards each other in response to the rotation of the cam in the second direction; wherein the first and second movable arms are electrically decoupled from the first stationary contact in response to the rotation of the cam in a first direction; wherein the third and fourth movable arms are electrically decoupled from the second stationary contact in response to the rotation of the cam in the first direction; wherein the first and second movable arms are electrically coupled to the first stationary contact in response to the rotation of the cam in a second direction; wherein the third and fourth movable arms are electrically coupled to the second stationary contact in the response to the rotation of the cam in the second direction; wherein the device further comprises a sensing device operably coupled to the first and second stationary contacts, wherein the sensing device is adapted to sense an imbalance between respective electrical currents in the first and second stationary contacts; an actuator operably coupled to the sensing device, wherein the actuator is adapted to actuate in response to the sensing of the imbalance by the sensing device; wherein the cam rotates in place in response to the actuation of the actuator; wherein the sensing device comprises a transformer assembly and the actuator comprises a solenoid assembly; wherein the device is a ground fault circuit interrupter device and is adapted to supply electrical power to a load; wherein the device is adapted to supply electrical power to the load when the load is electrically coupled to the first and third movable arms; the first movable arm is electrically coupled to the first stationary contact; and the third movable arm is electrically coupled to the second stationary contact; wherein the cam comprises a center portion; and first and second legs coupled to the center portion and spaced in a parallel relation, one of the first and second legs being adapted to contact the first movable arm, wherein an angle is defined between the center portion and the first and second legs; wherein the first movable arm is spring biased towards the first stationary contact; wherein the device comprises a first configuration in which the one of the first and second legs contacts the first movable arm and is positioned so that the one of the first and second legs resists the spring bias of the first movable arm, and the at least a portion of the first movable arm is electrically decoupled from the first stationary contact; and a second configuration in which the one of the first and second legs is positioned so that the first movable arm is permitted to be electrically coupled to the first stationary contact in response to its own spring bias; wherein the cam further comprises axially-aligned first and second pins extending between the center portion and the first and second legs, respectively; wherein an axis is defined by the axially-aligned first and second pins; wherein the cam is adapted to rotate in place about the axis; wherein the device further comprises a switch, the switch comprising the first stationary contact; and a spring, a distal end portion of which is spring biased towards the first stationary contact; wherein the switch comprises an open configuration in which the distal end portion is separated from the first stationary contact and a closed configuration in which the distal end portion contacts the first stationary contact; wherein the switch is placed in the open configuration in response to the rotation of the cam in the first direction; and wherein the switch is placed in the closed configuration in response to the rotation of the cam in the second direction; wherein the device further comprises a light-emitting diode electrically coupled to the switch, wherein the diode is adapted to emit light when the switch is in the closed configuration; wherein the cam further comprises a protrusion extending from one of the first and second legs; and wherein the protrusion is adapted to contact and separate the distal end portion of the spring from the first stationary contact, thereby placing the switch in the open configuration, in response to the rotation of the cam in the first direction.

A system for operating a device comprising a cam, first and second stationary contacts, and first and second movable arms adapted to be controllably electrically coupled to the first and second stationary contacts, respectively, has been described that includes means for electrically coupling the first movable arm to the first stationary contact; means for electrically coupling the second movable arm to the second stationary contact; means for electrically coupling a load to the first and second movable arms; means for supplying electrical power to the load via the first and second stationary contacts and the first and second movable arms; means for sensing whether a ground fault is present or absent using the device; and means for if the ground fault is present, stopping the supply of electrical power to the load, comprising means for rotating the cam in a first direction; means for electrically decoupling the first movable arm from the first stationary contact in response to rotating the cam in the first direction; and means for electrically decoupling the second movable arm from the second stationary contact in response to rotating the cam in the first direction; wherein the system further comprises means for resuming the supply of electrical power to the load after stopping the supply of electrical power to the load, comprising means for rotating the cam in a second direction; means for electrically coupling the first movable arm to the first stationary contact in response to rotating the cam in the second direction; and means for electrically coupling the second movable arm to the second stationary contact in response to rotating the cam in the second direction; and wherein the system further comprises means for if the ground fault is present, emitting light in response to rotating the cam in the first direction, comprising means for closing a switch in response rotating the cam in the first direction; and means for testing the device, comprising means for rotating the cam in the first direction to stop the supply of electrical power to the load; means for rotating the cam in a second direction to resume the supply of electrical power to the load; means for emitting light in response to rotating the cam in the first direction to stop the supply of electrical power to the load; and means for stopping the emission of light in response to rotating the cam in the second direction to resume the supply of electrical power to the load.

A device has been described that includes a stationary contact; and an arm adapted to be controllably electrically coupled to the stationary contact, the arm comprising a first portion; and a second portion extending from the first portion and adapted to be controllably electrically coupled to the stationary contact to controllably electrically couple the arm to the stationary contact; wherein at least a portion of the first portion extends in a direction that is parallel to at least a directional component of the direction of extension of the second portion from the first portion. In an exemplary embodiment, a force is adapted to be applied against the second portion to electrically decouple the arm from the stationary contact; and wherein the first portion increases the overall length of the arm and is sized and positioned so that the magnitude of the force required to electrically decouple the arm from the stationary contact is reduced. In an exemplary embodiment, the first portion comprises a longitudinally-extending portion; and a U-shaped portion extending between the longitudinally extending portion and the second portion. In an exemplary embodiment, the second portion comprises an angularly-extending portion. In an exemplary embodiment, the first portion comprises a longitudinally-extending portion and a U-shaped portion extending therefrom; and wherein the second portion comprises an angularly-extending portion extending from the U-shaped portion. In an exemplary embodiment, the at least a portion of the first portion comprises the longitudinally-extending portion. In an exemplary embodiment, the longitudinally-extending portion and the U-shaped portion are coplanar. In an exemplary embodiment, the device comprises a housing defining a region within which the first portion extends and within which at least a portion of the second portion extends. In an exemplary embodiment, the device comprises first and second pairs of contacts, wherein each of the first and second pairs of contacts is a hot or neutral receptacle contact adapted to receive a prong of a plug; and at least one wall extending between the first and second pairs of contacts, the first portion extending from the at least one wall. In an exemplary embodiment, the arm, the first and second pairs of contacts, and the at least one wall are integral. In an exemplary embodiment, the device comprises a sensing device operably coupled to the stationary contact and adapted to sense a ground fault. In an exemplary embodiment, a force is adapted to be applied against the second portion to electrically decouple the arm from the stationary contact; wherein the device further comprises a cam adapted to rotate in place; and wherein, in response to the rotation of the cam in a first direction, the force is applied against the arm to electrically decouple the arm from the stationary contact. In an exemplary embodiment, the second portion is spring biased towards the stationary contact; and wherein the arm is electrically coupled to the stationary contact in response to its own spring bias and the rotation of the cam in a second direction. In an exemplary embodiment, the second portion is spring biased towards the stationary contact.

A receptacle contact adapted to be controllably electrically coupled to a stationary contact has been described that includes an arm comprising a first portion; and a second portion extending from the first portion and against which a force is adapted to be applied to electrically decouple the arm from the stationary contact; first and second pairs of contacts, wherein each of the first and second pairs of contacts is a hot or neutral receptacle contact adapted to receive a prong of a plug; and at least one wall extending between the first and second pairs of contacts, the first portion extending from the at least one wall; wherein the first and second pairs of contacts, the at least one wall, and the arm are integral. In an exemplary embodiment, at least a portion of the first portion extends in a direction that is parallel to at least a directional component of the direction of extension of the second portion from the first portion. In an exemplary embodiment, the first portion increases the overall length of the arm and is sized and positioned so that the magnitude of the force required to electrically decouple the arm from the stationary contact is reduced. In an exemplary embodiment, the first portion comprises a longitudinally-extending portion; and a U-shaped portion extending between the longitudinally extending portion and the second portion. In an exemplary embodiment, the second portion comprises an angularly-extending portion. In an exemplary embodiment, the first portion comprises a longitudinally-extending portion and a U-shaped portion extending therefrom; and wherein the second portion comprises an angularly-extending portion extending from the U-shaped portion. In an exemplary embodiment, the at least a portion of the first portion comprises the longitudinally-extending portion. In an exemplary embodiment, the longitudinally-extending portion and the U-shaped portion are coplanar. In an exemplary embodiment, the second portion is adapted to be spring biased towards the stationary contact.

A device has been described that includes a stationary contact; and a receptacle contact comprising an arm adapted to be controllably electrically coupled to the stationary contact, the arm comprising a first portion; and a second portion extending from the first portion and adapted to be controllably electrically coupled to the stationary contact to controllably electrically couple the arm to the stationary contact, wherein at least a portion of the first portion extends in a direction that is parallel to at least a directional component of the direction of extension of the second portion from the first portion; first and second pairs of contacts, wherein each of the first and second pairs of contacts is a hot or neutral receptacle contact adapted to receive a prong of a plug; and at least one wall extending between the first and second pairs of contacts, the first portion extending from the at least one wall; a housing defining a region within which the first portion extends and within which at least a portion of the second portion extends; a sensing device operably coupled to the stationary contact and adapted to sense a ground fault; and a cam adapted to rotate in place; wherein a force is adapted to be applied against the second portion to electrically decouple the arm from the stationary contact; wherein the first portion increases the overall length of the arm and is sized and positioned so that the magnitude of the force required to electrically decouple the arm from the stationary contact is reduced; wherein the first portion comprises a longitudinally-extending portion and a U-shaped portion extending therefrom; and wherein the second portion comprises an angularly-extending portion extending from the U-shaped portion; wherein the at least a portion of the first portion comprises the longitudinally-extending portion; wherein the longitudinally-extending portion and the U-shaped portion are coplanar; wherein the arm, the first and second pairs of contacts, and the at least one wall are integral; wherein, in response to the rotation of the cam in a first direction, the force is applied against the arm to electrically decouple the arm from the stationary contact; wherein the second portion is spring biased towards the stationary contact; and wherein the arm is electrically coupled to the stationary contact in response to its spring bias and the rotation of the cam in a second direction.

A method has been described that includes providing a device comprising a stationary contact and an arm adapted to be controllably electrically coupled to the stationary contact, at least a portion of the arm comprising a direction of extension comprising a longitudinal directional component that generally defines the majority of the longitudinal length of the arm, wherein a force is adapted to be applied against the at least a portion of the arm to electrically decouple the arm from the stationary contact; and reducing the magnitude of the force required to electrically decouple the arm from the stationary contact while maintaining as substantially constant the longitudinal length of the arm. In an exemplary embodiment, the method comprises electrically decoupling the arm from the stationary contact, comprising applying the force against the arm. In an exemplary embodiment, the method comprises electrically coupling the arm to the stationary contact. In an exemplary embodiment, the arm is spring biased towards the stationary contact; and wherein electrically coupling the arm to the stationary contact comprises permitting the arm to be electrically coupled to the stationary contact in response to the spring bias of the arm. In an exemplary embodiment, the method comprises providing first and second pairs of contacts, wherein each of the first and second pairs is a hot or neutral receptacle contact adapted to receive a prong of a plug. In an exemplary embodiment, the method comprises extending at least one wall between the first and second pairs of contacts; and extending the arm from the at least one wall. In an exemplary embodiment, the arm, the first and second pairs of contacts, and the at least one wall are integral. In an exemplary embodiment, the method comprises electrically coupling a load to the device; supplying electrical power to the load via the device; and sensing whether a ground fault is present or absent. In an exemplary embodiment, the method comprises if the ground fault is present, electrically decoupling the arm from the stationary contact. In an exemplary embodiment, the method comprises if the ground fault is present, stopping the supply of electrical power to the load.

A method has been described that includes providing a device comprising a stationary contact and an arm adapted to be controllably electrically coupled to the stationary contact, at least a portion of the arm comprising a direction of extension comprising a longitudinal directional component that generally defines the majority of the longitudinal length of the arm, wherein a force is adapted to be applied against the at least a portion of the arm to electrically decouple the arm from the stationary contact; providing first and second pairs of contacts, wherein each of the first and second pairs is a hot or neutral receptacle contact adapted to receive a prong of a plug; extending at least one wall between the first and second pairs of contacts; extending the arm from the at least one wall; reducing the magnitude of the force required to electrically decouple the arm from the stationary contact while maintaining as substantially constant the longitudinal length of the arm; electrically decoupling the arm from the stationary contact, comprising applying the force against the arm; electrically coupling the arm to the stationary contact; electrically coupling a load to the device; supplying electrical power to the load via the device; sensing whether a ground fault is present or absent; if the ground fault is present, electrically decoupling the arm from the stationary contact; and if the ground fault is present, stopping the supply of electrical power to the load; wherein the arm is spring biased towards the stationary contact; wherein electrically coupling the arm to the stationary contact comprises permitting the arm to be electrically coupled to the stationary contact in response to the spring bias of the arm; and wherein the arm, the first and second pairs of contacts, and the at least one wall are integral.

A system has been described that includes means for providing a device comprising a stationary contact and an arm adapted to be controllably electrically coupled to the stationary contact, at least a portion of the arm comprising a direction of extension comprising a longitudinal directional component that generally defines the majority of the longitudinal length of the arm, wherein a force is adapted to be applied against the at least a portion of the arm to electrically decouple the arm from the stationary contact; and means for reducing the magnitude of the force required to electrically decouple the arm from the stationary contact while maintaining as substantially constant the longitudinal length of the arm. In an exemplary embodiment, the system comprises means for electrically decoupling the arm from the stationary contact, comprising means for applying the force against the arm. In an exemplary embodiment, the system comprises means for electrically coupling the arm to the stationary contact. In an exemplary embodiment, the arm is spring biased towards the stationary contact; and wherein means for electrically coupling the arm to the stationary contact comprises means for permitting the arm to be electrically coupled to the stationary contact in response to the spring bias of the arm. In an exemplary embodiment, the system comprises means for providing first and second pairs of contacts, wherein each of the first and second pairs is a hot or neutral receptacle contact adapted to receive a prong of a plug. In an exemplary embodiment, the system comprises means for extending at least one wall between the first and second pairs of contacts; and means for extending the arm from the at least one wall. In an exemplary embodiment, the arm, the first and second pairs of contacts, and the at least one wall are integral. In an exemplary embodiment, the system comprises means for electrically coupling a load to the device; means for supplying electrical power to the load via the device; and means for sensing whether a ground fault is present or absent. In an exemplary embodiment, the system comprises means for if the ground fault is present, electrically decoupling the arm from the stationary contact. In an exemplary embodiment, the system comprises means for if the ground fault is present, stopping the supply of electrical power to the load.

A system has been described that includes means for providing a device comprising a stationary contact and an arm adapted to be controllably electrically coupled to the stationary contact, at least a portion of the arm comprising a direction of extension comprising a longitudinal directional component that generally defines the majority of the longitudinal length of the arm, wherein a force is adapted to be applied against the at least a portion of the arm to electrically decouple the arm from the stationary contact; means for providing first and second pairs of contacts, wherein each of the first and second pairs is a hot or neutral receptacle contact adapted to receive a prong of a plug; means for extending at least one wall between the first and second pairs of contacts; means for extending the arm from the at least one wall; means for reducing the magnitude of the force required to electrically decouple the arm from the stationary contact while maintaining as substantially constant the longitudinal length of the arm; means for electrically decoupling the arm from the stationary contact, comprising applying the force against the arm; means for electrically coupling the arm to the stationary contact; means for electrically coupling a load to the device; means for supplying electrical power to the load via the device; means for sensing whether a ground fault is present or absent; means for if the ground fault is present, electrically decoupling the arm from the stationary contact; and means for if the ground fault is present, stopping the supply of electrical power to the load; wherein the arm is spring biased towards the stationary contact; wherein means for electrically coupling the arm to the stationary contact comprises means for permitting the arm to be electrically coupled to the stationary contact in response to the spring bias of the arm; and wherein the arm, the first and second pairs of contacts, and the at least one wall are integral.

An apparatus has been described that includes a transformer assembly comprising a first opening; and a first contact arm extending through the first opening of the transformer assembly, the first contact arm comprising a first portion; and a second portion extending from the first portion, at least a portion of the second portion being offset from the first portion. In an exemplary embodiment, the transformer is adapted to be coupled to a circuit board comprising a second opening; and wherein the at least a portion of the second portion is adapted to be inserted through the second opening and engage the circuit board to couple the transformer assembly to the circuit board. In an exemplary embodiment, the apparatus comprises a circuit board to which the transformer assembly is coupled, the circuit board comprising a second opening within which the first portion extends; wherein the at least a portion of the second portion engages the circuit board to couple the transformer assembly to the circuit board; and wherein the engagement between the at least a portion of the second portion and the circuit board generally holds the transformer assembly in place, relative to the circuit board, to facilitate soldering the first contact arm to the circuit board. In an exemplary embodiment, the circuit board defines first and second surfaces; wherein the transformer assembly is adjacent the first surface of the circuit board; and wherein the at least a portion of the second portion engages the second surface of the circuit board to couple the transformer assembly to the circuit board. In an exemplary embodiment, the at least a portion of the second portion comprises a generally curved portion, at least a portion of the generally curved portion engaging the circuit board. In an exemplary embodiment, the apparatus comprises the first and second portions of the first contact arm are integrally formed. In an exemplary embodiment, a second contact arm extending through the first opening of the transformer assembly, the second contact arm comprising a first portion and a second portion extending from the first portion, at least a portion of the second portion of the second contact arm being offset from the first portion of the second contact arm; wherein the circuit board comprises a third opening within which the first portion of the second contact arm extends; and wherein the at least a portion of the second portion of the second contact arm engages the circuit board to further couple the transformer assembly to the circuit board. In an exemplary embodiment, the second portions are adapted to be forced through the second and third openings, respectively, to couple the transformer assembly to the circuit board; and wherein the second portions deflect away from each other during the forcing of the second portions through the second and third openings, respectively. In an exemplary embodiment, the transformer assembly comprises a boat comprising an at least partially circumferentially-extending wall and a cylindrical protrusion at least partially surrounded by the wall, wherein the first opening extends through the cylindrical protrusion; and a pair of transformer coils, each transformer coil circumferentially extending about the cylindrical protrusion and radially extending between the cylindrical protrusion and the inside surface of the wall; wherein the first opening defines parallel-spaced first and second inside surfaces of the cylindrical protrusion; and wherein the apparatus further comprises a isolating member extending within the first opening so that the first and second contact arms are disposed between the isolating member and the first and second inside surfaces, respectively, of the cylindrical protrusion. In an exemplary embodiment, the transformer assembly, the first contact arm and the circuit board are part of a ground fault circuit interrupter device; and wherein the transformer assembly is adapted to sense a ground fault.

A method has been described that includes providing a circuit board defining first and second surfaces spaced in a parallel relation, and a transformer assembly comprising an opening; extending a first contact arm through the opening of the transformer assembly; and coupling the transformer assembly to the circuit board, comprising coupling the first contact arm to the circuit board so that the transformer assembly is adjacent the first surface of the circuit board and the first contact arm engages the second surface of the circuit board. In an exemplary embodiment, the first contact arm comprises a first portion and a second portion extending therefrom, at least a portion of the second portion being offset from the first portion. In an exemplary embodiment, the method comprises extending a second contact arm through the opening of the transformer assembly; wherein coupling the transformer assembly to the circuit board further comprises coupling the second contact arm to the circuit board so that the second contact arm engages the second surface of the circuit board. In an exemplary embodiment, each of the first and second contact arms comprises a first portion and a second portion extending therefrom, at least a portion of the second portion being offset from the first portion; wherein coupling the transformer assembly to the circuit board further comprises forcing the first and second contact arms through respective openings in the circuit board; and wherein the second portions deflect away from each other during forcing the first and second contact arms through the respective openings in the circuit board. In an exemplary embodiment, coupling the first contact arm to the circuit board so that the transformer assembly is adjacent the first surface of the circuit board and the first contact arm engages the second surface of the circuit board comprises engaging the at least a portion of the second portion of the first contact arm with the circuit board; and wherein coupling the second contact arm to the circuit board so that the second contact arm engages the second surface of the circuit board comprises engaging the at least a portion of the second portion of the second contact arm with the circuit board. In an exemplary embodiment, the method comprises soldering the first and second contact arms to the circuit board after coupling the first and second contact arms to the circuit board; wherein the respective couplings between the first and second contact arms and the circuit board generally hold the transformer assembly in place to facilitate soldering the first and second contact arms to the circuit board. In an exemplary embodiment, the method comprises electrically isolating the first and second contact arms. In an exemplary embodiment, the method comprises sensing a ground fault using the transformer assembly; and energizing a solenoid in response to sensing the ground fault using the transformer assembly.

A system has been described that includes means for providing a circuit board defining first and second surfaces spaced in a parallel relation, and a transformer assembly comprising an opening; means for extending a first contact arm through the opening of the transformer assembly; and means for coupling the transformer assembly to the circuit board, comprising means for coupling the first contact arm to the circuit board so that the transformer assembly is adjacent the first surface of the circuit board and the first contact arm engages the second surface of the circuit board. In an exemplary embodiment, the first contact arm comprises a first portion and a second portion extending therefrom, at least a portion of the second portion being offset from the first portion. In an exemplary embodiment, the system comprises means for extending a second contact arm through the opening of the transformer assembly; wherein means for coupling the transformer assembly to the circuit board further comprises means for coupling the second contact arm to the circuit board so that the second contact arm engages the second surface of the circuit board. In an exemplary embodiment, each of the first and second contact arms comprises a first portion and a second portion extending therefrom, at least a portion of the second portion being offset from the first portion; wherein means for coupling the transformer assembly to the circuit board further comprises means for forcing the first and second contact arms through respective openings in the circuit board; and wherein the second portions deflect away from each other during forcing the first and second contact arms through the respective openings in the circuit board. In an exemplary embodiment, means for coupling the first contact arm to the circuit board so that the transformer assembly is adjacent the first surface of the circuit board and the first contact arm engages the second surface of the circuit board comprises means for engaging the at least a portion of the second portion of the first contact arm with the circuit board; and wherein means for coupling the second contact arm to the circuit board so that the second contact arm engages the second surface of the circuit board comprises means for engaging the at least a portion of the second portion of the second contact arm with the circuit board. In an exemplary embodiment, the system comprises means for soldering the first and second contact arms to the circuit board after coupling the first and second contact arms to the circuit board; wherein the respective couplings between the first and second contact arms and the circuit board generally hold the transformer assembly in place to facilitate soldering the first and second contact arms to the circuit board. In an exemplary embodiment, the system comprises means for electrically isolating the first and second contact arms. In an exemplary embodiment, the system comprises means for sensing a ground fault using the transformer assembly; and means for energizing a solenoid in response to sensing the ground fault using the transformer assembly.

A ground fault circuit interrupter device has been described that includes a transformer assembly comprising a first opening; and a first contact arm extending through the first opening of the transformer assembly, the first contact arm comprising a first portion; and a second portion extending from the first portion, at least a portion of the second portion being offset from the first portion; a circuit board to which the transformer assembly is coupled, the circuit board comprising a second opening within which the first portion extends; wherein the at least a portion of the second portion engages the circuit board to couple the transformer assembly to the circuit board; wherein the engagement between the at least a portion of the second portion and the circuit board generally holds the transformer assembly in place, relative to the circuit board, to facilitate soldering the first contact arm to the circuit board; wherein the circuit board defines first and second surfaces; wherein the transformer assembly is adjacent the first surface of the circuit board; wherein the at least a portion of the second portion engages the second surface of the circuit board to couple the transformer assembly to the circuit board; wherein the at least a portion of the second portion comprises a generally curved portion, at least a portion of the generally curved portion engaging the circuit board; wherein the first and second portions of the first contact arm are integrally formed; wherein the ground fault circuit interrupter device further comprises a second contact arm extending through the first opening of the transformer assembly, the second contact arm comprising a first portion and a second portion extending from the first portion, at least a portion of the second portion of the second contact arm being offset from the first portion of the second contact arm; wherein the circuit board comprises a third opening within which the first portion of the second contact arm extends; wherein the at least a portion of the second portion of the second contact arm engages the circuit board to further couple the transformer assembly to the circuit board; wherein the second portions are adapted to be forced through the second and third openings, respectively, to couple the transformer assembly to the circuit board; and wherein the second portions deflect away from each other during the forcing of the second portions through the second and third openings, respectively; wherein the transformer assembly comprises a boat comprising an at least partially circumferentially-extending wall and a cylindrical protrusion at least partially surrounded by the wall, wherein the first opening extends through the cylindrical protrusion; and a pair of transformer coils, each transformer coil circumferentially extending about the cylindrical protrusion and radially extending between the cylindrical protrusion and the inside surface of the wall; wherein the first opening defines parallel-spaced first and second inside surfaces of the cylindrical protrusion; wherein the ground fault circuit interrupter device further comprises a isolating member extending within the first opening so that the first and second contact arms are disposed between the isolating member and the first and second inside surfaces, respectively, of the cylindrical protrusion; and wherein the transformer assembly is adapted to sense a ground fault.

A method has been described that includes providing a circuit board defining first and second surfaces spaced in a parallel relation, and a transformer assembly comprising an opening; extending a first contact arm through the opening of the transformer assembly; coupling the transformer assembly to the circuit board, comprising coupling the first contact arm to the circuit board so that the transformer assembly is adjacent the first surface of the circuit board and the first contact arm engages the second surface of the circuit board; extending a second contact arm through the opening of the transformer assembly; wherein coupling the transformer assembly to the circuit board further comprises coupling the second contact arm to the circuit board so that the second contact arm engages the second surface of the circuit board; wherein each of the first and second contact arms comprises a first portion and a second portion extending therefrom, at least a portion of the second portion being offset from the first portion; wherein coupling the transformer assembly to the circuit board further comprises forcing the first and second contact arms through respective openings in the circuit board; wherein the second portions deflect away from each other during forcing the first and second contact arms through the respective openings in the circuit board; wherein coupling the first contact arm to the circuit board so that the transformer assembly is adjacent the first surface of the circuit board and the first contact arm engages the second surface of the circuit board comprises engaging the at least a portion of the second portion of the first contact arm with the circuit board; wherein coupling the second contact arm to the circuit board so that the second contact arm engages the second surface of the circuit board comprises engaging the at least a portion of the second portion of the second contact arm with the circuit board; and wherein the method further comprises soldering the first and second contact arms to the circuit board after coupling the first and second contact arms to the circuit board, wherein the respective couplings between the first and second contact arms and the circuit board generally hold the transformer assembly in place to facilitate soldering the first and second contact arms to the circuit board; electrically isolating the first and second contact arms; sensing a ground fault using the transformer assembly; and energizing a solenoid in response to sensing the ground fault using the transformer assembly.

A system has been described that includes means for providing a circuit board defining first and second surfaces spaced in a parallel relation, and a transformer assembly comprising an opening; means for extending a first contact arm through the opening of the transformer assembly; means for coupling the transformer assembly to the circuit board, comprising means for coupling the first contact arm to the circuit board so that the transformer assembly is adjacent the first surface of the circuit board and the first contact arm engages the second surface of the circuit board; means for extending a second contact arm through the opening of the transformer assembly; wherein means for coupling the transformer assembly to the circuit board further comprises means for coupling the second contact arm to the circuit board so that the second contact arm engages the second surface of the circuit board; wherein each of the first and second contact arms comprises a first portion and a second portion extending therefrom, at least a portion of the second portion being offset from the first portion; wherein means for coupling the transformer assembly to the circuit board further comprises means for forcing the first and second contact arms through respective openings in the circuit board; wherein the second portions deflect away from each other during forcing the first and second contact arms through the respective openings in the circuit board; wherein means for coupling the first contact arm to the circuit board so that the transformer assembly is adjacent the first surface of the circuit board and the first contact arm engages the second surface of the circuit board comprises means for engaging the at least a portion of the second portion of the first contact arm with the circuit board; wherein means for coupling the second contact arm to the circuit board so that the second contact arm engages the second surface of the circuit board comprises means for engaging the at least a portion of the second portion of the second contact arm with the circuit board; and wherein the system further comprises means for soldering the first and second contact arms to the circuit board after coupling the first and second contact arms to the circuit board, wherein the respective couplings between the first and second contact arms and the circuit board generally hold the transformer assembly in place to facilitate soldering the first and second contact arms to the circuit board; means for electrically isolating the first and second contact arms; means for sensing a ground fault using the transformer assembly; and means for energizing a solenoid in response to sensing the ground fault using the transformer assembly.

An apparatus has been described that includes a switch comprising a stationary contact; and a member comprising a distal end portion biased towards the stationary contact; and a cam adapted to rotate in place so that the distal end portion is electrically coupled to the stationary contact, and thus the switch is closed, in response to the rotation of the cam in a first direction; and the distal end portion is electrically decoupled from the stationary contact, and thus the switch is open, in response to the rotation of the cam in a second direction. In an exemplary embodiment, in response to the rotation of the cam in the first direction, the bias of the distal end portion is permitted to cause the distal end portion to be electrically coupled to the stationary contact. In an exemplary embodiment, in response to the rotation of the cam in the second direction, the bias of the distal end portion is resisted by the cam. In an exemplary embodiment, the member comprises a wire spring comprising one or more bends formed therein, the distal end portion being at least partially defined by at least one of the one or more bends. In an exemplary embodiment, the cam comprises a protrusion adapted to engage the distal end portion when the cam rotates in the second direction. In an exemplary embodiment, the cam further comprises a sensing device adapted to sense a ground fault; wherein the cam is adapted to rotate in the first direction in response to the sensing of the ground fault by the sensing device. In an exemplary embodiment, the cam further comprises an actuator operably coupled to the sensing device; wherein the actuator is adapted to actuate in response to the sensing of the ground fault by the sensing device; and wherein the cam is adapted to rotate in the first direction in response to the actuation of the actuator in response to the sensing of the ground fault by the sensing device. In an exemplary embodiment, the sensing device comprises a transformer assembly operably coupled to the stationary contact; and wherein the actuator comprises a solenoid assembly adapted to be energized in response to the sensing of the ground fault by the sensing device. In an exemplary embodiment, the apparatus further comprises a light source electrically coupled to the switch and adapted to emit light when the switch is closed. In an exemplary embodiment, wherein the light source comprises one or more light-emitting diodes. In an exemplary embodiment, the apparatus further comprises at least one movable arm adapted to be controllably electrically coupled to the stationary contact and arranged so that at least a portion of the at least one movable arm moves, relative to the stationary contact, in response to the rotation of the cam. In an exemplary embodiment, wherein the at least one arm is electrically decoupled from the stationary contact in response to the rotation of the cam in the first direction. In an exemplary embodiment, wherein the at least one arm is electrically coupled to the stationary contact in response to the rotation of the cam in the second direction. In an exemplary embodiment, wherein the at least one movable arm is adapted to be electrically coupled to a load and used to supply electrical power to the load when the at least one arm is electrically coupled to the stationary contact.

A method of operating a device comprising a switch and a cam has been described that includes electrically coupling a load to the device; supplying electrical power to the load via the device; sensing whether a ground fault is present or absent using the device; and if the ground fault is present, closing the switch; wherein closing the switch comprises rotating the cam in a first direction. In an exemplary embodiment, the method comprises electrically coupling a light source to the switch; and emitting light from the light source in response to closing the switch. In an exemplary embodiment, the light source comprises one or more light-emitting diodes. In an exemplary embodiment, the method comprises opening the switch after closing the switch, comprising rotating the cam in a second direction. In an exemplary embodiment, the supply of electrical power to the load is stopped in response to rotating the cam in the first direction. In an exemplary embodiment, the method comprises resuming the supply of electrical power to the load after the supply of electrical power to the load is stopped, comprising rotating the cam in a second direction. In an exemplary embodiment, the method comprises testing the device. In an exemplary embodiment, testing the device comprises rotating the cam in the first direction to close the switch. In an exemplary embodiment, testing the device further comprises rotating the cam in a second direction to open the switch. In an exemplary embodiment, testing the device further comprises electrically coupling a light source to the switch; emitting light from the light source in response to closing the switch; and stopping the emission of light from the light source in response to opening the switch. In an exemplary embodiment, the switch comprises a stationary contact and a member, the member comprising a distal end portion biased towards the stationary contact.

A method has been described that includes providing a switch comprising a stationary contact and a member comprising a distal end portion that is adapted to be controllably electrically coupled to the stationary contact; and closing the switch, comprising rotating a cam in a first direction; and electrically coupling the distal end portion to the stationary contact in response to rotating the cam in the first direction. In an exemplary embodiment, the method comprises opening the switch, comprising rotating the cam in a second direction; and electrically decoupling the distal end portion from the stationary contact in response to rotating the cam in the second direction. In an exemplary embodiment, the method comprises sensing the presence of a ground fault; wherein rotating the cam in the first direction comprises rotating the cam in the first direction in response to sensing the presence of the ground fault. In an exemplary embodiment, rotating the cam in the second direction comprises rotating the cam in the second direction after rotating the cam in the first direction in response to sensing the presence of the ground fault. In an exemplary embodiment, the method comprises electrically coupling a light source to the switch; and emitting light from the light source in response to closing the switch. In an exemplary embodiment, the light source comprises one or more light-emitting diodes.

A system for operating a device comprising a switch and a cam has been described that includes means for electrically coupling a load to the device; means for supplying electrical power to the load via the device; means for sensing whether a ground fault is present or absent using the device; and means for if the ground fault is present, closing the switch, comprising means for rotating the cam in a first direction. In an exemplary embodiment, the system comprises means for electrically coupling a light source to the switch; and means for emitting light from the light source in response to closing the switch. In an exemplary embodiment, the light source comprises one or more light-emitting diodes. In an exemplary embodiment, the system comprises means for opening the switch after closing the switch, comprising means for rotating the cam in a second direction. In an exemplary embodiment, the supply of electrical power to the load is stopped in response to rotating the cam in the first direction. In an exemplary embodiment, the system comprises means for resuming the supply of electrical power to the load after the supply of electrical power to the load is stopped, comprising means for rotating the cam in a second direction. In an exemplary embodiment, the system comprises means for testing the device. In an exemplary embodiment, means for testing the device comprises means for rotating the cam in the first direction to close the switch. In an exemplary embodiment, means for testing the device further comprises means for rotating the cam in a second direction to open the switch. In an exemplary embodiment, means for testing the device further comprises means for electrically coupling a light source to the switch; means for emitting light from the light source in response to closing the switch; and means for stopping the emission of light from the light source in response to opening the switch. In an exemplary embodiment, the switch comprises a stationary contact and a member, the member comprising a distal end portion biased towards the stationary contact.

A system has been described that includes means for providing a switch comprising a stationary contact and a member comprising a distal end portion that is adapted to be controllably electrically coupled to the stationary contact; and means for closing the switch, comprising means for rotating a cam in a first direction; and means for electrically coupling the distal end portion to the stationary contact in response to rotating the cam in the first direction. In an exemplary embodiment, the system comprises means for opening the switch, comprising means for rotating the cam in a second direction; and means for electrically decoupling the distal end portion from the stationary contact in response to rotating the cam in the second direction. In an exemplary embodiment, the system comprises means for sensing the presence of a ground fault; wherein means for rotating the cam in the first direction comprises means for rotating the cam in the first direction in response to sensing the presence of the ground fault. In an exemplary embodiment, means for rotating the cam in the second direction comprises means for rotating the cam in the second direction after rotating the cam in the first direction in response to sensing the presence of the ground fault. In an exemplary embodiment, the system comprises means for electrically coupling a light source to the switch; and means for emitting light from the light source in response to closing the switch. In an exemplary embodiment, the light source comprises one or more light-emitting diodes.

A method of operating a device comprising a cam and a switch, the switch comprising a stationary contact and a member comprising a distal end portion that is adapted to be controllably electrically coupled to the stationary contact has been described that includes electrically coupling a load to the device; supplying electrical power to the load via the device; sensing whether a ground fault is present or absent using the device; if the ground fault is present, closing the switch, comprising rotating the cam in a first direction, wherein the supply of electrical power to the load is stopped in response to rotating the cam in the first direction; and electrically coupling the distal end portion to the stationary contact in response to rotating the cam in the first direction; electrically coupling a light source to the switch, wherein the light source comprises one or more light-emitting diodes; emitting light from the light source in response to closing the switch; opening the switch after closing the switch, comprising rotating the cam in a second direction, wherein the supply of electrical power to the load is resumed in response to rotating the cam in the second direction; and electrically decoupling the distal end portion from the stationary contact in response to rotating the cam in the second direction; and testing the device, comprising rotating the cam in the first direction to close the switch; emitting light from the light source in response to closing the switch; rotating the cam in the second direction to open the switch; and stopping the emission of light from the light source in response to opening the switch.

A ground fault interrupter device has been described that includes a switch comprising a stationary contact; and a member comprising a distal end portion biased towards the stationary contact; and a cam adapted to rotate in place so that the distal end portion is electrically coupled to the stationary contact, and thus the switch is closed, in response to the rotation of the cam in a first direction; and the distal end portion is electrically decoupled from the stationary contact, and thus the switch is open, in response to the rotation of the cam in a second direction; wherein, in response to the rotation of the cam in the first direction, the bias of the distal end portion is permitted to cause the distal end portion to be electrically coupled to the stationary contact; wherein, in response to the rotation of the cam in the second direction, the bias of the distal end portion is resisted by the cam; wherein the member comprises a wire spring comprising one or more bends formed therein, the distal end portion being defined by at least one of the one or more bends; wherein the cam comprises a protrusion adapted to engage the distal end portion when the cam rotates in the second direction; wherein the device further comprises a sensing device adapted to sense a ground fault; wherein the cam is adapted to rotate in first direction in response to the sensing of the ground fault by the sensing device; wherein the device further comprises an actuator operably coupled to the sensing device; wherein the actuator is adapted to actuate in response to the sensing of the ground fault by the sensing device; wherein the cam is adapted to rotate in the first direction in response to the actuation of the actuator in response to the sensing of the ground fault by the sensing device; wherein the sensing device comprises a transformer assembly operably coupled to the stationary contact; wherein the actuator comprises a solenoid assembly adapted to be energized in response to the sensing of the ground fault by the sensing device; wherein the device further comprises a light source electrically coupled to the switch and adapted to emit light when the switch is closed; wherein the light source comprises one or more light-emitting diodes; wherein the device further comprises at least one movable arm adapted to be controllably electrically coupled to the stationary contact and arranged so that at least a portion of the at least one movable arm moves, relative to the stationary contact, in response to the rotation of the cam; wherein the at least one arm is electrically decoupled from the stationary contact in response to the rotation of the cam in the first direction; wherein the at least one arm is electrically coupled to the stationary contact in response to the rotation of the cam in the second direction; and wherein the at least one movable arm is adapted to be electrically coupled to a load and used to supply electrical power to the load when the at least one arm is electrically coupled to the stationary contact.

A system for operating a device comprising a cam and a switch, the switch comprising a stationary contact and a member comprising a distal end portion that is adapted to be controllably electrically coupled to the stationary contact has been described that includes means for electrically coupling a load to the device; means for supplying electrical power to the load via the device; means for sensing whether a ground fault is present or absent using the device; means for if the ground fault is present, closing the switch, comprising means for rotating the cam in a first direction, wherein the supply of electrical power to the load is stopped in response to rotating the cam in the first direction; and means for electrically coupling the distal end portion to the stationary contact in response to rotating the cam in the first direction; means for electrically coupling a light source to the switch, wherein the light source comprises one or more light-emitting diodes; means for emitting light from the light source in response to closing the switch; means for opening the switch after closing the switch, comprising means for rotating the cam in a second direction, wherein the supply of electrical power to the load is resumed in response to rotating the cam in the second direction; and means for electrically decoupling the distal end portion from the stationary contact in response to rotating the cam in the second direction; and means for testing the device, comprising means for rotating the cam in the first direction to close the switch; means for emitting light from the light source in response to closing the switch; means for rotating the cam in the second direction to open the switch; and means for stopping the emission of light from the light source in response to opening the switch.

A device has been described that includes a first stationary contact; a first movable arm adapted to be controllably electrically coupled to the first stationary contact; and at least one of the following: a cam adapted to rotate in place and positioned, relative to the first movable arm, so that at least a portion of the first movable arm moves, relative to the first stationary contact, in response to the rotation of the cam; a switch comprising the first stationary contact; a member comprising a distal end portion biased towards the first stationary contact; and the cam, wherein the cam is adapted to rotate in place so that the distal end portion is electrically coupled to the first stationary contact, and thus the switch is closed, in response to the rotation of the cam in a first direction; and the distal end portion is electrically decoupled from the first stationary contact, and thus the switch is open, in response to the rotation of the cam in a second direction; a receptacle contact comprising an arm adapted to be controllably electrically coupled to the first stationary contact, the arm comprising a first portion and a second portion extending from the first portion and adapted to be controllably electrically coupled to the first stationary contact to controllably electrically couple the arm to the first stationary contact, wherein at least a portion of the first portion extends in a direction that is parallel to at least a directional component of the direction of extension of the second portion from the first portion; and a transformer assembly comprising a first opening and a first contact arm extending through the first opening of the transformer assembly, the first contact arm being integral with the first stationary contact and comprising a first portion and a second portion extending from the first portion, at least a portion of the second portion being offset from the first portion. In an exemplary embodiment, the device comprises at least another of the following: the cam adapted to rotate in place and positioned, relative to the first movable arm, so that the at least a portion of the first movable arm moves, relative to the first stationary contact, in response to the rotation of the cam; the switch comprising the first stationary contact; the member comprising the distal end portion biased towards the first stationary contact; and the cam, wherein the cam is adapted to rotate in place so that the distal end portion is electrically coupled to the first stationary contact, and thus the switch is closed, in response to the rotation of the cam in the first direction; and the distal end portion is electrically decoupled from the first stationary contact, and thus the switch is open, in response to the rotation of the cam in the second direction; the receptacle contact comprising the arm adapted to be controllably electrically coupled to the first stationary contact, the arm comprising the first portion and the second portion extending from the first portion and adapted to be controllably electrically coupled to the first stationary contact to controllably electrically couple the arm to the first stationary contact, wherein the at least a portion of the first portion extends in a direction that is parallel to at least the directional component of the direction of extension of the second portion from the first portion; and the transformer assembly comprising the first opening and the first contact arm extending through the first opening of the transformer assembly, the first contact arm being integral with the first stationary contact and comprising the first portion and the second portion extending from the first portion, the at least a portion of the second portion being offset from the first portion. In an exemplary embodiment, the device comprises at least one other of the following: the cam adapted to rotate in place and positioned, relative to the first movable arm, so that the at least a portion of the first movable arm moves, relative to the first stationary contact, in response to the rotation of the cam; the switch comprising the first stationary contact; the member comprising the distal end portion biased towards the first stationary contact; and the cam, wherein the cam is adapted to rotate in place so that the distal end portion is electrically coupled to the first stationary contact, and thus the switch is closed, in response to the rotation of the cam in the first direction; and the distal end portion is electrically decoupled from the first stationary contact, and thus the switch is open, in response to the rotation of the cam in the second direction; the receptacle contact comprising the arm adapted to be controllably electrically coupled to the first stationary contact, the arm comprising the first portion and the second portion extending from the first portion and adapted to be controllably electrically coupled to the first stationary contact to controllably electrically couple the arm to the first stationary contact, wherein the at least a portion of the first portion extends in a direction that is parallel to at least the directional component of the direction of extension of the second portion from the first portion; and the transformer assembly comprising the first opening and the first contact arm extending through the first opening of the transformer assembly, the first contact arm being integral with the first stationary contact and comprising the first portion and the second portion extending from the first portion, the at least a portion of the second portion being offset from the first portion. In an exemplary embodiment, the device comprises all of the following: the cam adapted to rotate in place and positioned, relative to the first movable arm, so that the at least a portion of the first movable arm moves, relative to the first stationary contact, in response to the rotation of the cam; the switch comprising the first stationary contact; the member comprising the distal end portion biased towards the first stationary contact; and the cam, wherein the cam is adapted to rotate in place so that the distal end portion is electrically coupled to the first stationary contact, and thus the switch is closed, in response to the rotation of the cam in the first direction; and the distal end portion is electrically decoupled from the first stationary contact, and thus the switch is open, in response to the rotation of the cam in the second direction; the receptacle contact comprising the arm adapted to be controllably electrically coupled to the first stationary contact, the arm comprising the first portion and the second portion extending from the first portion and adapted to be controllably electrically coupled to the first stationary contact to controllably electrically couple the arm to the first stationary contact, wherein the at least a portion of the first portion extends in a direction that is parallel to at least the directional component of the direction of extension of the second portion from the first portion; and the transformer assembly comprising the first opening and the first contact arm extending through the first opening of the transformer assembly, the first contact arm being integral with the first stationary contact and comprising the first portion and the second portion extending from the first portion, the at least a portion of the second portion being offset from the first portion. In an exemplary embodiment, the device comprises a second stationary contact; a second movable arm, wherein the first and second movable arms are arranged so that the first and second movable arms normally apply biasing forces against the first and second stationary contacts, respectively, and are thereby normally electrically coupled to the first and second stationary contacts, respectively; and third and fourth movable arms arranged so that the third and fourth movable arms normally apply biasing forces against the first and second stationary contacts, respectively, and are thereby normally electrically coupled to the first and second stationary contacts, respectively; wherein the application of the biasing force by each one of the first, second, third and fourth movable arms is independent of the application of the biasing force by each of the other first, second, third and fourth movable arms. In an exemplary embodiment, the device is a ground fault circuit interrupter device adapted to sense a ground fault. In an exemplary embodiment, the device is a ground fault circuit interrupter device adapted to sense a ground fault; and wherein the first movable arm is adapted to be electrically decoupled from the first stationary contact in response to the sensing of the ground fault by the device.

A device has been described that includes first and second stationary contacts; first and second movable arms arranged so that the first and second movable arms normally apply biasing forces against the first and second stationary contacts, respectively, and are thereby normally electrically coupled to the first and second stationary contacts, respectively; and third and fourth movable arms arranged so that the third and fourth movable arms normally apply biasing forces against the first and second stationary contacts, respectively, and are thereby normally electrically coupled to the first and second stationary contacts, respectively; wherein the application of the biasing force by each one of the first, second, third and fourth movable arms is independent of the application of the biasing force by each of the other first, second, third and fourth movable arms. In an exemplary embodiment, the device comprises a sensing device operably coupled to the first and second stationary contacts; wherein the sensing device is adapted to sense a ground fault. In an exemplary embodiment, the device comprises first and second pairs of contacts electrically coupled to the first movable arm; and third and fourth pairs of contacts electrically coupled to the second movable arm. In an exemplary embodiment, the device is adapted to be electrically coupled to a load; and wherein electrical power is adapted to be supplied to the load via the third and fourth movable arms. In an exemplary embodiment, the device comprises a cam engaged with the first, second, third and fourth movable arms and adapted to rotate in place in a first direction to overcome the respective biasing forces applied by the first, second, third and fourth movable arms. In an exemplary embodiment, the device is adapted to sense a ground fault; and wherein the cam is adapted to rotate in the first direction so that the first and second movable arms are electrically decoupled from the first and second stationary contacts, respectively, and the third and fourth movable arms are electrically decoupled from the first and second stationary contacts, respectively, in response to the sensing of the ground fault by the device. In an exemplary embodiment, the device comprises a switch comprising the stationary contact; and a member comprising a distal end portion biased towards the stationary contact; wherein the cam is adapted to rotate in place so that the distal end portion is electrically coupled to the stationary contact, and thus the switch is closed, in response to the rotation of the cam in the first direction; and the distal end portion is electrically decoupled from the stationary contact, and thus the switch is open, in response to the rotation of the cam in a second direction. In an exemplary embodiment, the device comprises a receptacle contact comprising an arm adapted to be controllably electrically coupled to the first stationary contact, the arm comprising a first portion and a second portion extending from the first portion and adapted to be controllably electrically coupled to the first stationary contact to controllably electrically couple the arm to the first stationary contact, wherein at least a portion of the first portion extends in a direction that is parallel to at least a directional component of the direction of extension of the second portion from the first portion. In an exemplary embodiment, the device comprises a transformer assembly comprising a first opening and a first contact arm extending through the first opening of the transformer assembly, the first contact arm being integral with the first stationary contact and comprising a first portion and a second portion extending from the first portion, at least a portion of the second portion being offset from the first portion.

A ground fault circuit interrupter device has been described that includes first and second stationary contacts; first and second movable arms arranged so that the first and second movable arms normally apply biasing forces against the first and second stationary contacts, respectively, and are thereby normally electrically coupled to the first and second stationary contacts, respectively; third and fourth movable arms arranged so that the third and fourth movable arms normally apply biasing forces against the first and second stationary contacts, respectively, and are thereby normally electrically coupled to the first and second stationary contacts, respectively, wherein the application of the biasing force by each one of the first, second, third and fourth movable arms is independent of the application of the biasing force by each of the other first, second, third and fourth movable arms; a cam engaged with the first, second, third and fourth movable arms and adapted to rotate in place in a first direction to overcome the respective biasing forces applied by the first, second, third and fourth movable arms; a switch comprising the stationary contact; and a member comprising a distal end portion biased towards the stationary contact; wherein the cam is adapted to rotate in place so that the distal end portion is electrically coupled to the stationary contact, and thus the switch is closed, in response to the rotation of the cam in the first direction; and the distal end portion is electrically decoupled from the stationary contact, and thus the switch is open, in response to the rotation of the cam in a second direction; a receptacle contact comprising an arm adapted to be controllably electrically coupled to the stationary contact, the arm comprising a first portion and a second portion extending from the first portion and adapted to be controllably electrically coupled to the stationary contact to controllably electrically couple the arm to the stationary contact, wherein at least a portion of the first portion extends in a direction that is parallel to at least a directional component of the direction of extension of the second portion from the first portion; and a transformer assembly comprising a first opening and a first contact arm extending through the first opening of the transformer assembly, the first contact arm being integral with the stationary contact and comprising a first portion and a second portion extending from the first portion, at least a portion of the second portion being offset from the first portion; wherein the device is adapted to sense a ground fault; and wherein the cam is adapted to rotate in the first direction so that the first and second movable arms are electrically decoupled from the first and second stationary contacts, respectively, and the third and fourth movable arms are electrically decoupled from the first and second stationary contacts, respectively, in response to the sensing of the ground fault by the device.

A method of operating a device comprising a cam, a switch and a circuit board defining first and second surfaces spaced in a parallel relation has been described that includes electrically coupling a load to the device; supplying electrical power to the load via the device; sensing whether a ground fault is present or absent using the device; and at least one of the following: if the ground fault is present, stopping the supply of electrical power to the load, wherein stopping the supply of electrical power to the load comprises rotating the cam in a first direction; if the ground fault is present, closing the switch, wherein closing the switch comprises rotating the cam in the first direction; and coupling a transformer assembly comprising an opening to the circuit board, comprising extending a first contact arm through the opening of the transformer assembly; and coupling the first contact arm to the circuit board so that the transformer assembly is adjacent the first surface of the circuit board and the first contact arm engages the second surface of the circuit board. In an exemplary embodiment, the device further comprises a stationary contact and an arm adapted to be controllably electrically coupled to the stationary contact, at least a portion of the arm comprising a direction of extension comprising a longitudinal directional component that generally defines the majority of the longitudinal length of the arm, wherein a force is adapted to be applied against the at least a portion of the arm to electrically decouple the arm from the stationary contact; and wherein the method further comprises reducing the magnitude of the force required to electrically decouple the arm from the stationary contact while maintaining as substantially constant the longitudinal length of the arm. In an exemplary embodiment, the method comprises at least another of the following: if the ground fault is present, stopping the supply of electrical power to the load, wherein stopping the supply of electrical power to the load comprises rotating the cam in the first direction; if the ground fault is present, closing the switch, wherein closing the switch comprises rotating the cam in the first direction; and coupling the transformer assembly comprising the opening to the circuit board, comprising extending the first contact arm through the opening of the transformer assembly; and coupling the first contact arm to the circuit board so that the transformer assembly is adjacent the first surface of the circuit board and the first contact arm engages the second surface of the circuit board. In an exemplary embodiment, the method comprises all of the following: if the ground fault is present, stopping the supply of electrical power to the load, wherein stopping the supply of electrical power to the load comprises rotating the cam in the first direction; if the ground fault is present, closing the switch, wherein closing the switch comprises rotating the cam in the first direction; and coupling the transformer assembly comprising the opening to the circuit board, comprising extending the first contact arm through the opening of the transformer assembly; and coupling the first contact arm to the circuit board so that the transformer assembly is adjacent the first surface of the circuit board and the first contact arm engages the second surface of the circuit board. In an exemplary embodiment, the method comprises resuming the supply of electrical power to the load after stopping the supply of electrical power to the load; wherein resuming the supply of electrical power to the load comprises rotating the cam in a second direction. In an exemplary embodiment, the method comprises emitting light in response to rotating the cam in the first direction. In an exemplary embodiment, the method comprises testing the device. In an exemplary embodiment, testing the device comprises rotating the cam in the first direction to stop the supply of electrical power to the load; and rotating the cam in a second direction to resume the supply of electrical power to the load. In an exemplary embodiment, testing the device further comprises emitting light in response to rotating the cam in the first direction to stop the supply of electrical power to the load; and stopping the emission of light in response to rotating the cam in the second direction to resume the supply of electrical power to the load.

A method of operating a device comprising a cam, a switch and a circuit board defining first and second surfaces spaced in a parallel relation has been described that includes electrically coupling a load to the device; supplying electrical power to the load via the device; sensing whether a ground fault is present or absent using the device; if the ground fault is present, stopping the supply of electrical power to the load, wherein stopping the supply of electrical power to the load comprises rotating the cam in a first direction; if the ground fault is present, closing the switch, wherein closing the switch comprises rotating the cam in the first direction; coupling a transformer assembly comprising an opening to the circuit board, comprising extending a first contact arm through the opening of the transformer assembly; and coupling the first contact arm to the circuit board so that the transformer assembly is adjacent the first surface of the circuit board and the first contact arm engages the second surface of the circuit board; wherein the device further comprises a stationary contact and an arm adapted to be controllably electrically coupled to the stationary contact, at least a portion of the arm comprising a direction of extension comprising a longitudinal directional component that generally defines the majority of the longitudinal length of the arm, wherein a force is adapted to be applied against the at least a portion of the arm to electrically decouple the arm from the stationary contact; and wherein the method further comprises reducing the magnitude of the force required to electrically decouple the arm from the stationary contact while maintaining as substantially constant the longitudinal length of the arm; resuming the supply of electrical power to the load after stopping the supply of electrical power to the load, wherein resuming the supply of electrical power to the load comprises rotating the cam in a second direction; emitting light in response to rotating the cam in the first direction; and testing the device, comprising rotating the cam in the first direction to stop the supply of electrical power to the load; rotating the cam in the second direction to resume the supply of electrical power to the load; emitting light in response to rotating the cam in the first direction to stop the supply of electrical power to the load; and stopping the emission of light in response to rotating the cam in the second direction to resume the supply of electrical power to the load.

A system for operating a device comprising a cam, a switch and a circuit board defining first and second surfaces spaced in a parallel relation has been described that includes means for electrically coupling a load to the device; means for supplying electrical power to the load via the device; means for sensing whether a ground fault is present or absent using the device; and at least one of the following: means for if the ground fault is present, stopping the supply of electrical power to the load, comprising means for rotating the cam in a first direction; means for if the ground fault is present, closing the switch, comprising means for rotating the cam in the first direction; and means for coupling a transformer assembly comprising an opening to the circuit board, comprising means for extending a first contact arm through the opening of the transformer assembly; and means for coupling the first contact arm to the circuit board so that the transformer assembly is adjacent the first surface of the circuit board and the first contact arm engages the second surface of the circuit board. In an exemplary embodiment, the device further comprises a stationary contact and an arm adapted to be controllably electrically coupled to the stationary contact, at least a portion of the arm comprising a direction of extension comprising a longitudinal directional component that generally defines the majority of the longitudinal length of the arm, wherein a force is adapted to be applied against the at least a portion of the arm to electrically decouple the arm from the stationary contact; and wherein the system further comprises means for reducing the magnitude of the force required to electrically decouple the arm from the stationary contact while maintaining as substantially constant the longitudinal length of the arm. In an exemplary embodiment, the system comprises at least another of the following: means for if the ground fault is present, stopping the supply of electrical power to the load, comprising means for rotating the cam in the first direction; means for if the ground fault is present, closing the switch, comprising means for rotating the cam in the first direction; and means for coupling the transformer assembly comprising the opening to the circuit board, comprising means for extending the first contact arm through the opening of the transformer assembly; and means for coupling the first contact arm to the circuit board so that the transformer assembly is adjacent the first surface of the circuit board and the first contact arm engages the second surface of the circuit board. In an exemplary embodiment, the system comprises all of the following: means for if the ground fault is present, stopping the supply of electrical power to the load, comprising means for rotating the cam in the first direction; if the ground fault is present, closing the switch, comprising means for rotating the cam in the first direction; and means for coupling the transformer assembly comprising the opening to the circuit board, comprising means for extending the first contact arm through the opening of the transformer assembly; and means for coupling the first contact arm to the circuit board so that the transformer assembly is adjacent the first surface of the circuit board and the first contact arm engages the second surface of the circuit board. In an exemplary embodiment, the system comprises means for resuming the supply of electrical power to the load after stopping the supply of electrical power to the load; wherein means for resuming the supply of electrical power to the load comprises means for rotating the cam in a second direction. In an exemplary embodiment, the system comprises means for emitting light in response to rotating the cam in the first direction. In an exemplary embodiment, the system comprises means for testing the device. In an exemplary embodiment, means for testing the device comprises means for rotating the cam in the first direction to stop the supply of electrical power to the load; and means for rotating the cam in a second direction to resume the supply of electrical power to the load. In an exemplary embodiment, means for testing the device further comprises means for emitting light in response to rotating the cam in the first direction to stop the supply of electrical power to the load; and means for stopping the emission of light in response to rotating the cam in the second direction to resume the supply of electrical power to the load.

A system for operating a device comprising a cam, a switch and a circuit board defining first and second surfaces spaced in a parallel relation has been described that includes means for electrically coupling a load to the device; means for supplying electrical power to the load via the device; means for sensing whether a ground fault is present or absent using the device; and means for if the ground fault is present, stopping the supply of electrical power to the load, comprising means for rotating the cam in a first direction; means for if the ground fault is present, closing the switch, comprising means for rotating the cam in the first direction; means for coupling a transformer assembly comprising an opening to the circuit board, comprising means for extending a first contact arm through the opening of the transformer assembly; and means for coupling the first contact arm to the circuit board so that the transformer assembly is adjacent the first surface of the circuit board and the first contact arm engages the second surface of the circuit board; wherein the device further comprises a stationary contact and an arm adapted to be controllably electrically coupled to the stationary contact, at least a portion of the arm comprising a direction of extension comprising a longitudinal directional component that generally defines the majority of the longitudinal length of the arm, wherein a force is adapted to be applied against the at least a portion of the arm to electrically decouple the arm from the stationary contact; and wherein the system further comprises means for reducing the magnitude of the force required to electrically decouple the arm from the stationary contact while maintaining as substantially constant the longitudinal length of the arm; means for resuming the supply of electrical power to the load after stopping the supply of electrical power to the load, wherein means for resuming the supply of electrical power to the load comprises means for rotating the cam in the second direction; means for emitting light in response to rotating the cam in the first direction; and means for testing the device, comprising means for rotating the cam in the first direction to stop the supply of electrical power to the load; means for rotating the cam in a second direction to resume the supply of electrical power to the load; means for emitting light in response to rotating the cam in the first direction to stop the supply of electrical power to the load; and means for stopping the emission of light in response to rotating the cam in the second direction to resume the supply of electrical power to the load.

It is understood that variations may be made in the foregoing without departing from the scope of the disclosure. In several exemplary embodiments, the device 10 and/or one or more components thereof such as, for example, the circuit 102, may be modified for use with, and/or may be incorporated into, other types of circuits that require, for example, quickly and efficiently stopping the flow of one or more electrical currents, quickly and efficiently stopping the supply of electrical power to one or more loads, and/or quickly and efficiently causing one or more electrical couplings to be decoupled. Examples of such other types of circuits include, but are not limited to, arc fault detection circuits and/or circuit-breaker circuits.

In several exemplary embodiments, instead of, or in addition to providing receptacle outlets that supply electrical power, the device 10 and/or one or more components thereof such as, for example, the circuit 102, may be modified for use in, and/or may be incorporated into, other types of GFCI devices such as, for example, a wide variety of residual current devices, a wide variety of residual current circuit breakers, a wide variety of electrical plugs, a wide variety of arc fault circuit interrupters, a wide variety of sockets, and/or any combination thereof.

In several exemplary embodiments, in addition to, or instead of the transformer assembly 62, the sensing device 104 may include one or more other types of sensors. In several exemplary embodiments, in addition to, or instead of the solenoid assembly 76, the actuator 106 may include one or more other types of transducer devices.

In several exemplary embodiments, in addition to, or instead of the foregoing, the cam 54 may include a wide variety of profiles and/or shapes. In several exemplary embodiments, in addition to, or instead of the cam 54, a wide variety of other force actuation means may be used to independently electrically decouple each of the arms 78 and 80 from the stationary contacts 70 and 72, respectively, and to independently electrically decouple each of the arms 38d and 40d from the stationary contacts 70 and 72, respectively.

In several exemplary embodiments, in addition to, or instead of the foregoing, the stationary contacts 70 and/or 72 may include a wide variety of shapes. In several exemplary embodiments, in addition to, or instead of the foregoing, the wire spring 86 may include a wide variety of wire forms and/or bends, and/or may be in the form of a flat spring or other type of spring-biased member or bracket.

In several exemplary embodiments, instead of, or in addition to sensing the presence of a ground fault, the sensing device 104 may sense or detect one or more other types of faults or errors such as, for example, one or more other types of electrical faults or errors. In several exemplary embodiments, the method 109 may be carried out in accordance with the foregoing except that, in addition to, or instead of sensing a ground fault, the sensing device 104 may sense or detect one or more other types of faults or errors such as, for example, one or more other types of electrical faults or errors. In several exemplary embodiments, instead of, or in addition to the sensing of a ground fault, the device 10 may be placed in its above-described tripped state in response to the sensing or detection of one or more other types of faults or errors such as, for example, one or more other types of electrical faults or errors.

Any spatial references such as, for example, “upper,” “lower,” “above,” “below,” “between,” “vertical,” “horizontal,” “angular,” “upward,” “downward,” “side-to-side,” “left-to-right,” “right-to-left,” “top-to-bottom,” “bottom-to-top,” “left,” “right,” etc., are for the purpose of illustration only and do not limit the specific orientation or location of the structure described above.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. A device comprising:
a first stationary contact;
a first movable arm adapted to be controllably electrically coupled to the first stationary contact; and
at least one of the following:
a cam adapted to rotate in place and positioned, relative to the first movable arm, so that at least a portion of the first movable arm moves, relative to the first stationary contact, in response to the rotation of the cam;
a switch comprising:
the first stationary contact;
a member comprising a distal end portion biased towards the first stationary contact; and
the cam, wherein the cam is adapted to rotate in place so that:
the distal end portion is electrically coupled to the first stationary contact, and thus the switch is closed, in response to the rotation of the cam in a first direction; and
the distal end portion is electrically decoupled from the first stationary contact, and thus the switch is open, in response to the rotation of the cam in a second direction;
a receptacle contact comprising an arm adapted to be controllably electrically coupled to the first stationary contact, the arm comprising a first portion and a second portion extending from the first portion and adapted to be controllably electrically coupled to the first stationary contact to controllably electrically couple the arm to the first stationary contact, wherein at least a portion of the first portion extends in a direction that is parallel to at least a directional component of the direction of extension of the second portion from the first portion; and
a transformer assembly comprising a first opening and a first contact arm extending through the first opening of the transformer assembly, the first contact arm being integral with the first stationary contact and comprising a first portion and a second portion extending from the first portion, at least a portion of the second portion being offset from the first portion.

2. A device comprising:
first and second stationary contacts;
first and second movable arms arranged so that the first and second movable arms normally apply biasing forces against the first and second stationary contacts, respectively, and are thereby normally electrically coupled to the first and second stationary contacts, respectively; and
third and fourth movable arms arranged so that the third and fourth movable arms normally apply biasing forces against the first and second stationary contacts, respectively, and are thereby normally electrically coupled to the first and second stationary contacts, respectively;
wherein the application of the biasing force by each one of the first, second, third and fourth movable arms is independent of the application of the biasing force by each of the other first, second, third and fourth movable arms.

3. A ground fault circuit interrupter device, comprising:
first and second stationary contacts;
first and second movable arms arranged so that the first and second movable arms normally apply biasing forces against the first and second stationary contacts, respectively, and are thereby normally electrically coupled to the first and second stationary contacts, respectively;
third and fourth movable arms arranged so that the third and fourth movable arms normally apply biasing forces against the first and second stationary contacts, respectively, and are thereby normally electrically coupled to the first and second stationary contacts, respectively, wherein the application of the biasing force by each one of the first, second, third and fourth movable arms is independent of the application of the biasing force by each of the other first, second, third and fourth movable arms;
a cam engaged with the first, second, third and fourth movable arms and adapted to rotate in place in a first direction to overcome the respective biasing forces applied by the first, second, third and fourth movable arms;
a switch comprising:
the stationary contact; and
a member comprising a distal end portion biased towards the stationary contact;
wherein the cam is adapted to rotate in place so that:
the distal end portion is electrically coupled to the stationary contact, and thus the switch is closed, in response to the rotation of the cam in the first direction; and
the distal end portion is electrically decoupled from the stationary contact, and thus the switch is open, in response to the rotation of the cam in a second direction;
a receptacle contact comprising an arm adapted to be controllably electrically coupled to the stationary contact, the arm comprising a first portion and a second portion extending from the first portion and adapted to be controllably electrically coupled to the stationary contact to controllably electrically couple the arm to the stationary contact, wherein at least a portion of the first portion extends in a direction that is parallel to at least a directional component of the direction of extension of the second portion from the first portion; and
a transformer assembly comprising a first opening and a first contact arm extending through the first opening of the transformer assembly, the first contact arm being integral with the stationary contact and comprising a first portion and a second portion extending from the first portion, at least a portion of the second portion being offset from the first portion;
wherein the device is adapted to sense a ground fault; and
wherein the cam is adapted to rotate in the first direction so that the first and second movable arms are electrically decoupled from the first and second stationary contacts, respectively, and the third and fourth movable arms are electrically decoupled from the first and second stationary contacts, respectively, in response to the sensing of the ground fault by the device.

4. A method of operating a device comprising a cam, a switch and a circuit board defining first and second surfaces spaced in a parallel relation, the method comprising:
electrically coupling a load to the device;
supplying electrical power to the load via the device;
sensing whether a ground fault is present or absent using the device; and
at least one of the following:
if the ground fault is present, stopping the supply of electrical power to the load, wherein stopping the supply of electrical power to the load comprises rotating the cam in a first direction;
if the ground fault is present, closing the switch, wherein closing the switch comprises rotating the cam in the first direction; and
coupling a transformer assembly comprising an opening to the circuit board, comprising:
extending a first contact arm through the opening of the transformer assembly; and
coupling the first contact arm to the circuit board so that the transformer assembly is adjacent the first surface of the circuit board and the first contact arm engages the second surface of the circuit board.

5. A method of operating a device comprising a cam, a switch and a circuit board defining first and second surfaces spaced in a parallel relation, the method comprising:
electrically coupling a load to the device;
supplying electrical power to the load via the device;
sensing whether a ground fault is present or absent using the device;
if the ground fault is present, stopping the supply of electrical power to the load, wherein stopping the supply of electrical power to the load comprises rotating the cam in a first direction;
if the ground fault is present, closing the switch, wherein closing the switch comprises rotating the cam in the first direction;
coupling a transformer assembly comprising an opening to the circuit board, comprising:
extending a first contact arm through the opening of the transformer assembly; and
coupling the first contact arm to the circuit board so that the transformer assembly is adjacent the first surface of the circuit board and the first contact arm engages the second surface of the circuit board;
wherein the device further comprises a stationary contact and an arm adapted to be controllably electrically coupled to the stationary contact, at least a portion of the arm comprising a direction of extension comprising a longitudinal directional component that generally defines the majority of the longitudinal length of the arm, wherein a force is adapted to be applied against the at least a portion of the arm to electrically decouple the arm from the stationary contact; and
wherein the method further comprises:
reducing the magnitude of the force required to electrically decouple the arm from the stationary contact while maintaining as substantially constant the longitudinal length of the arm;
resuming the supply of electrical power to the load after stopping the supply of electrical power to the load, wherein resuming the supply of electrical power to the load comprises rotating the cam in a second direction;
emitting light in response to rotating the cam in the first direction; and
testing the device, comprising:
rotating the cam in the first direction to stop the supply of electrical power to the load;
rotating the cam in the second direction to resume the supply of electrical power to the load;
emitting light in response to rotating the cam in the first direction to stop the supply of electrical power to the load; and
stopping the emission of light in response to rotating the cam in the second direction to resume the supply of electrical power to the load.

6. A system for operating a device comprising a cam, a switch and a circuit board defining first and second surfaces spaced in a parallel relation, the system comprising:
means for electrically coupling a load to the device;
means for supplying electrical power to the load via the device;
means for sensing whether a ground fault is present or absent using the device; and
at least one of the following:
means for if the ground fault is present, stopping the supply of electrical power to the load, comprising means for rotating the cam in a first direction;
means for if the ground fault is present, closing the switch, comprising means for rotating the cam in the first direction; and
means for coupling a transformer assembly comprising an opening to the circuit board, comprising:
means for extending a first contact arm through the opening of the transformer assembly; and
means for coupling the first contact arm to the circuit board so that the transformer assembly is adjacent the first surface of the circuit board and the first contact arm engages the second surface of the circuit board.

7. A system for operating a device comprising a cam, a switch and a circuit board defining first and second surfaces spaced in a parallel relation, the system comprising:
means for electrically coupling a load to the device;
means for supplying electrical power to the load via the device;
means for sensing whether a ground fault is present or absent using the device;
means for if the ground fault is present, stopping the supply of electrical power to the load, comprising means for rotating the cam in a first direction;
means for if the ground fault is present, closing the switch, comprising means for rotating the cam in the first direction;
means for coupling a transformer assembly comprising an opening to the circuit board, comprising:
means for extending a first contact arm through the opening of the transformer assembly; and
means for coupling the first contact arm to the circuit board so that the transformer assembly is adjacent the first surface of the circuit board and the first contact arm engages the second surface of the circuit board;
wherein the device further comprises a stationary contact and an arm adapted to be controllably electrically coupled to the stationary contact, at least a portion of the arm comprising a direction of extension comprising a longitudinal directional component that generally defines the majority of the longitudinal length of the arm, wherein a force is adapted to be applied against the at least a portion of the arm to electrically decouple the arm from the stationary contact; and
wherein the system further comprises:
means for reducing the magnitude of the force required to electrically decouple the arm from the stationary contact while maintaining as substantially constant the longitudinal length of the arm;
means for resuming the supply of electrical power to the load after stopping the supply of electrical power to the load, wherein means for resuming the supply of electrical power to the load comprises means for rotating the cam in the second direction;
means for emitting light in response to rotating the cam in the first direction; and
means for testing the device, comprising:
means for rotating the cam in the first direction to stop the supply of electrical power to the load;
means for rotating the cam in a second direction to resume the supply of electrical power to the load;
means for emitting light in response to rotating the cam in the first direction to stop the supply of electrical power to the load; and
means for stopping the emission of light in response to rotating the cam in the second direction to resume the supply of electrical power to the load.
